(19) United States
(12) Patent Application Publication
(10) Pub. No.: US 2026/0017451 A1
(43) Pub. Date: Jan. 15, 2026

(54) Secure and Scalable Sharing of Digital Engineering Documents

(71) Applicant: Istari Digital, Inc., Charleston, SC (US)

(72) Inventors: William Roper, JR., Charleston, SC (US); Christopher Lee Benson, Arlington, VA (US); Sriram Krishnan, Cambridge, MA (US); Baha aldeen E. A. Abunojaim, Roslindale, MA (US); Bayan Abedal-Muttaleb Afif Hashem, Amman (JO); Ross Billings, Reisterstown, MD (US)

(21) Appl. No.: 19/330,100

(22) Filed: Sep. 16, 2025

Related U.S. Application Data
(63) Continuation of application No. PCT/US24/27912, filed on May 5, 2024.
(60) Provisional application No. 63/516,624, filed on Jul. 31, 2023.

(51) Int. Cl. G06F 40/186; G06F 40/134; G06F 40/197; G06F 40/205; G06F 40/40

(52) U.S. Cl. CPC G06F 40/186; G06F 40/134; G06F 40/197; G06F 40/205; G06F 40/40

(57) ABSTRACT

Methods and systems for generating live digital documents are provided. The method includes receiving a static document file including human-readable data. Then, parsing the static document file into a plurality of subunits. Then, generating a sharable document splice of the static document file. The sharable document splice includes access to a subset of the plurality of subunits, and the access is provided through an Application Programming Interface (API) or Software Development Kit (SDK) endpoint for each subunit in the subset. Then, executing a digital thread script to generate the live digital document from the sharable document splice and an input digital model representation, using API or SDK endpoints in the sharable document splice. The live digital document is configured through the digital thread script to reflect changes in the input digital model representation. Finally, adding execution metadata for the execution of the digital thread script to the live digital document.

### REFERENCE TO RELATED APPLICATIONS

If an Application Data Sheet (“ADS”) or PCT Request Form (“Request”) has been filed on the filing date of this application, it is incorporated by reference herein. Any applications claimed on the ADS or Request for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

Furthermore, this application is related to the U.S. patent applications listed below, which are incorporated by reference in their entireties herein, as if fully set forth herein:
PCT patent application No. PCT/US24/19297 (Docket No. IST-01.002PCT), filed on Mar. 10, 2024, entitled “Software-Code-Defined Digital Threads in Digital Engineering Systems with Artificial Intelligence (AI) Assistance,” describes AI-assisted digital threads for digital engineering platforms.
PCT patent application No. PCT/US24/18278 (Docket No. IST-02.001PCT), filed on Mar. 3, 2024, entitled “Secure and Scalable Model Splicing of Digital Engineering Models for Software-Code-Defined Digital Threads,” describes model splicing for digital engineering platforms.
PCT patent application No. PCT/US24/14030 (Docket No. IST-01.001PCT), filed on Feb. 1, 2024, entitled “Artificial Intelligence (AI) Assisted Digital Documentation for Digital Engineering,” describes AI-assisted documentation for digital engineering platforms.
U.S. provisional patent application No. 63/442,659 (Docket No. IST-01.001P), filed on Feb. 1, 2023, entitled “AI-Assisted Digital Documentation for Digital Engineering with Supporting Systems and Methods,” describes AI-assistance tools for digital engineering (DE), including modeling and simulation applications, and the certification of digitally engineered products.
U.S. provisional patent application No. 63/451,545 (Docket No. IST-01.002P), filed on Mar. 10, 2023, entitled “Digital Threads in Digital Engineering Systems, and Supporting AI-Assisted Digital Thread Generation,” describes model splicer and digital threading technology.
U.S. provisional patent application No. 63/451,577 (Docket No. IST-02.001P1), filed on Mar. 11, 2023, entitled “Model Splicer and Microservice Architecture for Digital Engineering,” describes model splicer technology.
U.S. provisional patent application No. 63/462,988 (Docket No. IST-02.001P2), filed on Apr. 29, 2023, also entitled “Model Splicer and Microservice Architecture for Digital Engineering,” describes model splicer technology.
U.S. provisional patent application No. 63/511,583 (Docket No. IST-02.002P), filed on Jun. 30, 2023, entitled “AI-Assisted Model Splicer Generation for Digital Engineering,” describes model splicer technology with AI-assistance.
U.S. provisional patent application No. 63/516,624 (Docket No. IST-02.003P), filed on Jul. 31, 2023, entitled “Document and Model Splicing for Digital Engineering,” describes document splicer technology.
U.S. provisional patent application No. 63/520,643 (Docket No. IST-02.004P), filed on Aug. 20, 2023, entitled “Artificial Intelligence (AI)-Assisted Automation of Testing in a Software Environment,” describes software testing with AI-assistance.
U.S. provisional patent application No. 63/590,420 (Docket No. IST-02.005P), filed on Oct. 14, 2023, entitled “Commenting and Collaboration Capability within Digital Engineering Platform,” describes collaborative capabilities.
U.S. provisional patent application No. 63/586,384 (Docket No. IST-02.006P), filed on Sep. 28, 2023, entitled “Artificial Intelligence (AI)-Assisted Streamlined Model Splice Generation, Unit Testing, and Documentation,” describes streamlined model splicing, testing and documentation with AI-assistance.
U.S. provisional patent application No. 63/470,870 (Docket No. IST-03.001P), filed on Jun. 3, 2023, entitled “Digital Twin and Physical Twin Management with Integrated External Feedback within a Digital Engineering Platform,” describes digital and physical twin management and the integration of external feedback within a DE platform.
U.S. provisional patent application No. 63/515,071 (Docket No. IST-03.002P), filed on Jul. 21, 2023, entitled “Generative Artificial Intelligence (AI) for Digital Engineering,” describes an AI-enabled digital engineering task fulfillment process within a DE software platform.
U.S. provisional patent application No. 63/517,136 (Docket No. IST-03.003P), filed on Aug. 2, 2023, entitled “Machine Learning Engine for Workflow Enhancement in Digital Engineering,” describes a machine learning engine for model splicing and DE script generation.
U.S. provisional patent application No. 63/516,891 (Docket No. IST-03.004P), filed on Aug. 1, 2023, entitled “Multimodal User Interfaces for Digital Engineering,” describes multimodal user interfaces for DE systems.
U.S. provisional patent application No. 63/580,384 (Docket No. IST-03.006P), filed on Sep. 3, 2023, entitled “Multimodal Digital Engineering Document Interfaces for Certification and Security Reviews,” describes multimodal user interfaces for certification and security reviews.
U.S. provisional patent application No. 63/613,556 (Docket No. IST-03.008P), filed on Dec. 21, 2023, entitled “Alternative Tool Selection and Optimization in an Integrated Digital Engineering Platform,” describes tool selection and optimization.
U.S. provisional patent application No. 63/584,165 (Docket No. IST-03.010P), filed on Sep. 20, 2023, entitled “Methods and Systems for Improving Workflows in Digital Engineering,” describes workflow optimization in a DE platform.
U.S. provisional patent application No. 63/590,456 (Docket No. IST-04.001P), filed on Oct. 15, 2023, entitled “Data Sovereignty Assurance for Artificial Intelligence (AI) Models,” relates to data sovereignty assurance during AI model training and evaluation.
U.S. provisional patent application No. 63/606,030 (Docket No. IST-04.001P2), filed on Dec. 4, 2023, also entitled “Data Sovereignty Assurance for Artificial Intelligence (AI) Models,” further details data sovereignty assurances during AI model training and evaluation.
U.S. provisional patent application No. 63/419,051, filed on Oct. 25, 2022, entitled “Interconnected Digital Engineering and Certification Ecosystem.”
U.S. non-provisional patent application Ser. No. 17/973,142 (Docket No. 54332-0057001) filed on Oct. 25, 2022, entitled “Interconnected Digital Engineering and Certification Ecosystem.”
U.S. non-provisional patent application Ser. No. 18/383,635 (Docket No. 54332-0059001), filed on Oct. 25, 2023, entitled “Interconnected Digital Engineering and Certification Ecosystem.”
U.S. provisional patent application No. 63/489,401, filed on Mar. 9, 2023, entitled “Security Architecture for Interconnected Digital Engineering and Certification Ecosystem.”

### NOTICE OF COPYRIGHTS AND TRADEDRESS

A portion of the disclosure of this patent document contains material which is subject to copyright protection. This patent document may show and/or describe matter which is or may become tradedress of the owner. The copyright and tradedress owner has no objection to the facsimile reproduction by anyone of the patent disclosure as it appears in the U.S. Patent and Trademark Office files or records, but otherwise reserves all copyright and tradedress rights whatsoever.

ISTARI DIGITAL is a trademark name carrying embodiments of the present invention, and hence, the aforementioned trademark name may be interchangeably used in the specification and drawings to refer to the products/process offered by embodiments of the present invention. The terms ISTARI and ISTARI DIGITAL may be used in this specification to describe the present invention, as well as the company providing said invention.

### FIELD OF THE INVENTION

This disclosure relates to tools for digital engineering and digital documentation systems, including modeling and simulation applications, and the certification of digitally engineered products.

### BACKGROUND OF THE INVENTION

The statements in the background of the invention are provided to assist with understanding the invention and its applications and uses, and may not constitute prior art.

Digital engineering (DE) is an integrated digital approach to systems engineering, using authoritative sources of systems data and digital models as a continuum across disciplines to support lifecycle activities from conception through disposal. While digital engineering could enable faster, data-driven decision makings in system design, development, testing, and certification, significant expenses and delays are often incurred from relying on massive teams of highly specialized engineers and software developers to integrate data and models from siloed digital engineering platforms and tools. Furthermore, there are generally a corpus of documentations pertinent to every stage of a digitally-engineered product's lifecycle, including collections of digital documents related to requirements, architecture, development and design, validation and verification, operations, lifecycle management, and new intellectual property (IP) development processes that often necessitate manual input and proper referencing.

Digital engineering documentation or digital document production, manipulation, and maintenance, and the accurate description and summarization of digital models using human-readable documents are not only laborious but also susceptible to errors and mistakes. Subject matter experts (SMEs) such as engineers and designers are required to manually interpret and translate digital model files into documents, as digital engineering models are continuously updated and revised. This process is not only time-consuming but also prone to human errors and inconsistencies due to the complex nature of digital models and sometimes subjective interpretations by the SMEs. Moreover, these manual processes do not allow for easy sharing, revision, or further aggregation or summarization of digital model data independently of the native digital tool or development platform used to generate the input digital model. This limitation restricts the flexibility and scalability of the digital documentation process and hinders the efficient management of the digital engineering life cycle.

Therefore, in view of the aforementioned difficulties, there is an unsolved need to provide a streamlined and efficient digital documentation system that works seamlessly with every stage and component of an integrated digital collaboration platform, across the design, manufacturing, assembly, validation, verification, and certification processes of complex systems. It would be a further advancement in the state of the art to enable AI-assistance in the documentation of multidisciplinary digital models and workflows over disparate, disconnected tools, in a unified, secure, scalable, and collaborative digital platform.

It is against this background that the present invention was developed.

### BRIEF SUMMARY OF THE INVENTION

This summary of the invention provides a broad overview of the invention, its application, and uses, and is not intended to limit the scope of the present invention, which will be apparent from the detailed description when read in conjunction with the drawings.

Broadly, the present invention relates to a streamlined and efficient documentation production, usage, maintenance, and collaboration system. Specifically, methods and systems as disclosed herein are directed to document splicing, or “splicing” of human-readable documents, and linking document splices with other digital model splices to generate or update live documents or “magic documents” that are configured through software-defined digital threads to reflect changes in linked digital models. Within the context of digital engineering (DE), embodiments of the present invention are applicable to every stage of an DE process, from design, manufacturing, assembly, validation, to verification, providing dynamic DE data updates and access control as well as full traceability and auditability for a zero-trust implementation of the DE process.

Accordingly, various methods, processes, systems, and non-transitory storage medium storing program code for executing processes for generating a live digital document are provided. Other embodiments include “splicing” of digital documents without incorporating data from model splices. For example, embodiments include enabling API or SDK endpoint access to subcomponents of documents for purposes other than splicing with model data, such as for document sharing, document collaborating, and the like. Yet other embodiments include model splicing of digital model files without incorporating the data into document splices. Other embodiments and sub-combinations are also envisioned to be within the scope of the present invention.

According to a first aspect or in one embodiment, a non-transitory physical storage medium storing program code is provided. The program code is executable by a hardware processor. The hardware processor when executing the program code causes the hardware processor to execute a computer-implemented process for generating a live digital document. The program code includes code that may receive a static document file comprising human-readable data. The program code may comprise code to parse the static document file into a plurality of subunits. The program code may comprise code to generate a sharable document splice of the static document file. The sharable document splice may comprise access to a subset of the plurality of subunits. The access may be provided through an Application Programming Interface (API) or Software Development Kit (SDK) endpoint for each subunit in the subset. The program code may comprise code to execute a digital thread script to generate the live digital document from the sharable document splice and an input digital model representation, using API or SDK endpoints in the sharable document splice. The live digital document may be configured through the digital thread script to reflect changes in the input digital model representation. Finally, the program code may comprise code to add execution metadata for the execution of the digital thread script to the live digital document.

In one embodiment, the non-transitory physical storage medium further includes program code to update a given subunit of the sharable document splice, based on a digital artifact from the input digital model representation.

In one embodiment, the live digital document may comprise a hyperlink that links the digital thread execution metadata to a data field in the given subunit updated by the execution of the digital thread script.

In one embodiment, the digital thread script to update the sharable document splice may further comprise code to generate the digital artifact from the input digital model representation. The digital thread script to update the sharable document splice may further comprise code to send a prompt to a large language model (LLM)-based Artificial Intelligence (AI) module. The prompt may be generated based on a given subunit and the digital artifact. Finally, the digital thread script to update the sharable document splice may further comprise code to receive, from the LLM-based AI module, as an update to the given subunit in the sharable document splice, a document part generated by the LLM-based AI module in response to the prompt.

In one embodiment, the digital thread script to update the sharable document splice may comprise code to receive a user feedback on the generated document part. The digital thread script to update the sharable document splice may further comprise code to update the generated document part based on the user feedback. Finally, the digital thread script to update the sharable document splice may further comprise code to store a tuple of the given subunit, the digital artifact, and the updated document part as training data for the LLM-based AI module.

In one embodiment, the program code to generate a sharable document splice may further comprises code to generate at least one external, commonly-accessible document splice function that enables external access to a given subunit in the subset through the given subunit's API or SDK endpoint. The at least one external, commonly-accessible document splice function may provide a unified programming interface to sharable document splices.

In one embodiment, the static digital document may be machine-readable. The live digital document may be human-readable. Finally, the human-readable data may comprise at least one of textual data, tabular data, graphical data, image data, and hypertext data.

In one embodiment, the execution metadata may comprise an identifier of the digital thread script, an identifier of the input digital model representation, and a timestamp of the execution of the digital thread script.

In one embodiment, the identifier of the input digital model representation may comprise versioning information for the input digital model representation.

In one embodiment, the digital thread script may be a first digital thread script. The static document file may be a second digital thread script. At least one of the plurality of subunits may be a code block. Finally, the live digital document may comprise the code block and metadata of the input digital model representation.

In one embodiment, the digital thread script to generate the live DE document from the sharable document splice may comprise code to determine whether an information security tag that indicates a level of access to the subunit is met or exceeded by a user for each subunit in the subset of the plurality of subunits. The digital thread script to generate the live DE document from the sharable document splice may further comprise code to add the subunit's API or SDK endpoint to the live digital document in response to determining that the information security tag is met or exceeded.

In one embodiment, the non-transitory physical storage medium further includes program code to provide a prompt to the user for accessing the subunit in response to determining that the information security tag is not met or exceeded.

In one embodiment, the static document file may be a document template.

In one embodiment, each of the plurality of subunits may be selected from the group consisting of a title, a table of contents, an index, a chapter, a subsection, a paragraph, a sentence, a word, a sheet, a page, a table, a chart, a graph, an image, a hypertext link, and sub-parts thereof.

In one embodiment, the non-transitory physical storage medium further includes program code to update the live digital document based on another sharable document splice or another live digital document.

In a second aspect or in yet another embodiment, a computer-implemented method for generating a live digital document is disclosed. The method includes receiving a static document file that includes human-readable data. The method may further include parsing the static document file into a plurality of subunits. The method may further include generating a sharable document splice of the static document file. The sharable document splice may comprise access to a subset of the plurality of subunits. The access may be provided through an Application Programming Interface (API) or Software Development Kit (SDK) endpoint for each subunit in the subset. The method may further include executing a digital thread script to generate the live digital document from the sharable document splice and an input digital model representation, using API or SDK endpoints in the sharable document splice. The live digital document may be configured through the digital thread script to reflect changes in the input digital model representation. Finally, the method may further include adding execution metadata for the execution of the digital thread script to the live digital document.

Embodiments as set out for the first aspect may apply equally to the second aspect.

In one embodiment, the digital thread script to generate the live digital document may comprise code to update the sharable document splice, based on a digital artifact from the input digital model representation.

In one embodiment, the generating a sharable document splice may further comprise generating at least one external, commonly-accessible document splice function that enables external access to a given subunit in the subset through the given subunit's API or SDK endpoint. The at least one external, commonly-accessible document splice function may provide a unified programming interface to sharable document splices.

In one embodiment, the execution metadata may comprise an identifier of the digital thread script, an identifier of the input digital model representation, and a timestamp of the execution of the digital thread script.

In one embodiment, the digital thread script to generate the live digital document from the sharable document splice may comprises code to determine whether an information security tag that indicates a level of access to the subunit is met or exceeded by a user for each subunit in the subset of the plurality of subunits. The digital thread script to generate the live digital document from the sharable document splice may comprises code to add the subunit's API or SDK endpoints to the live digital document in response to determining that the information security tag is met or exceeded.

According to a third aspect or in one embodiment, a non-transitory physical storage medium storing program code is provided. The program code is executable by a hardware processor. The hardware processor when executing the program code causes the hardware processor to execute a computer-implemented process for generating a sharable digital document. The program code includes code that may receive a static document file comprising human-readable data. The program code may comprise code to parse the static document file into a plurality of subunits. The program code may comprise code to generate a sharable document splice of the static document file. The sharable document splice may comprise access to a subset of the plurality of subunits. The access may be provided through an Application Programming Interface (API) or Software Development Kit (SDK) endpoint for each subunit in the subset.

One embodiment may further include program code to update a given subunit of the sharable document splice based on a digital artifact from an input digital model representation.

One embodiment may further include program code to receive a user feedback on a generated document part and to update the generated document part based on the user feedback.

In one embodiment, the program code to generate a sharable document splice may further comprise code to generate at least one external, commonly-accessible document splice function that enables external access to a given subunit in the subset through the given subunit's API or SDK endpoint. The at least one external, commonly-accessible document splice function may provide a unified programming interface to sharable document splices.

In one embodiment, the static digital document may be machine-readable. The sharable digital document may be human-readable. Finally, the human-readable data may comprise at least one of textual data, tabular data, graphical data, image data, and hypertext data.

One embodiment may further include program code to determine whether an information security tag that indicates a level of access to the subunit is met or exceeded by a user for each subunit in the subset of the plurality of subunits. One embodiment may further include program code to add the subunit's API or SDK endpoint to the sharable digital document in response to determining that the information security tag is met or exceeded.

One embodiment may further include program code to provide a prompt to the user for accessing the subunit in response to determining that the information security tag is not met or exceeded.

In one embodiment, the static document file may be a document template.

In one embodiment, each of the plurality of subunits may be selected from the group consisting of a title, a table of contents, an index, a chapter, a subsection, a paragraph, a sentence, a word, a sheet, a page, a table, a chart, a graph, an image, a hypertext link, and sub-parts thereof.

One embodiment may further include program code to update the sharable digital document based on another sharable document splice or another live digital document.

In various aspects and embodiments, a computer program product is provided. The computer program may be used for generating a live digital document, and may include a computer-readable storage medium having program instructions, or program code, embodied therewith, the program instructions executable by a processor to cause the processor to perform the aforementioned steps.

In various aspects and embodiments, a system for generating a live digital document is provided, the system including a memory that stores computer-executable components, and a hardware processor, operably coupled to the memory, and that executes the computer-executable components stored in the memory, wherein the computer-executable components may include components communicatively coupled with the processor that execute the aforementioned steps.

In various aspects and embodiments, a system for generating a live digital document is provided, the system including a user device having a processor, a display, a first memory; a server including a second memory and a data repository; a communications link between said user device and said server; and a plurality of computer codes embodied on said first and second memory of said user device and said server, said plurality of computer codes which when executed causes said server and said user device to execute a process including the steps described herein.

In various aspects and embodiments, a computerized server is provided, including at least one processor, memory, and a plurality of computer codes embodied on said memory, said plurality of computer codes which when executed causes said processor to execute a process including the steps described herein.

In various aspects and embodiments, an edge computerized system is provided, the edge computerized system running on a physical system or physical twin (PTw) with either access to, or dedicated, processing, memory, computer code stored on a non-transitory computer-readable storage medium of the physical system or PTw, and a plurality of sensor data being measured on said physical system or PTw, the computer code causing the processor to perform the aforementioned steps.

Embodiments as set out for the first and/or second aspect(s) may apply equally to these aforementioned various aspects and embodiments.

Other aspects and embodiments of the present invention include the methods, processes, and algorithms comprising the steps described herein, and also include the processes and modes of operation of the systems and servers described herein.

Features which are described in the context of separate aspects and/or embodiments of the invention may be used together and/or be interchangeable wherever possible. Similarly, where features are, for brevity, described in the context of a single embodiment, those features may also be provided separately or in any suitable sub-combination. Features described in connection with the non-transitory physical storage medium may have corresponding features definable and/or combinable with respect to a digital documentation system and/or method and/or system, or vice versa, and these embodiments are specifically envisaged.

Yet other aspects and embodiments of the present invention will become apparent from the detailed description of the invention when read in conjunction with the attached drawings.

### BRIEF DESCRIPTION OF THE DRAWINGS

The accompanying drawings, which are incorporated in and constitute part of this specification, illustrate embodiments of the invention and together with the description, serve to explain the principles of the disclosed embodiments. For clarity, simplicity, and flexibility, not all elements, components, or specifications are defined in all drawings. Not all drawings corresponding to specific steps or embodiments of the present invention are drawn to scale. Emphasis is instead placed on illustration of the nature, function, and product of the manufacturing method and devices described herein.

Embodiments of the present invention described herein are exemplary, and not restrictive. Embodiments will now be described, by way of examples, with reference to the accompanying drawings, in which:

FIG. 1 shows an exemplary interconnected digital engineering (IDEP) platform architecture, in accordance with some embodiments of the present invention.

FIG. 2 shows an exemplary implementation of the IDEP as an interconnected digital engineering (DE) and certification ecosystem, and exemplary digitally certified products, in accordance with some embodiments of the present invention.

FIG. 3 shows another exemplary implementation of the IDEP illustrating its offered services and features, in accordance with some embodiments of the present invention.

FIG. 4 shows potential scenarios for instantiating an IDEP in connection to a customer's physical system and IT environment, in accordance with some embodiments of the present invention.

FIG. 5 shows exemplary multimodal interface designs for integration of feedback in am IDEP, in accordance with some embodiments of the present invention.

FIG. 6 is a schematic diagram comparing exemplary digital threads that connect DE models, in accordance with some embodiments of the present invention.

FIG. 7 is a schematic showing an exemplary DE model splicing setup, in accordance with some embodiments of the present invention.

FIG. 8 is a schematic showing digital threading of DE models via model splicing, in accordance with some embodiments of the present invention.

FIG. 9 is a schematic illustrating the linking of DE model splices in a splice plane and comparing digital threading with and without model splicing, in accordance with some embodiments of the present invention.

FIG. 10 shows an exemplary directed acyclic graph (DAG) representation of pipelined DE tasks related to digital threads, in accordance with some embodiments of the present invention.

FIG. 11 shows a flowchart for an exemplary process for generating a DE document splice and a live DE document, in accordance with some embodiments of the present invention.

FIG. 12 shows an example system for generating a DE document splice, in accordance with some embodiments of the present invention.

FIG. 13 shows an illustrative example of CAD model splicing results within the IDEP, in accordance with some embodiments of the present invention.

FIG. 14 shows an illustrative example of document model splicing within the IDEP, in accordance with some embodiments of the present invention.

FIG. 15 shows an illustrative example of viewing a document with component-level access control via document splicing, in accordance with some embodiments of the present invention.

FIG. 16 shows an exemplary document splice function in a document model splice, in accordance with some embodiments of the present invention.

FIG. 17 shows an illustrative example for linking a DE model splice and a document model splice to generate a design requirement document by parameter substitution, in accordance with some embodiments of the present invention.

FIG. 18 is an illustrative flow diagram for a process to generate an expense report from a document template, in accordance with some embodiments of the present invention.

FIG. 19 a screenshot of an exemplary graphical user interface (GUI) for viewing and interacting with a live document in a digital documentation system, in accordance with some embodiments of the present invention.

FIG. 20 shows a screenshot of the GUI displaying a digital artifact with versioning information, in accordance with some embodiments of the present invention.

FIG. 21 shows a screenshot of a live document associated with a digital thread within the IDEP, in accordance with some embodiments of the present invention.

FIG. 22 is a flow diagram for an exemplary use case for DE model-to-document model linking and magic docs in a preliminary design review (PDR) process, in accordance with some embodiments of the present invention.

FIG. 23 illustrates the complex process of documenting digital threads in a technical review, in accordance with example embodiments of the present invention.

FIG. 24 describes neural network operation fundamentals, in accordance with some embodiments of the present invention.

FIG. 25 shows an overview of an IDEP neural network training process, in accordance with some embodiments of the present invention.

FIG. 26 is an illustrative flow diagram showing the different phases and datasets involved in training an IDEP machine learning model, in accordance with some embodiments of the present invention.

FIG. 27 provides illustrative schematics of a server (management computing entity) and a client (user computing entity) used for documentation within an IDEP, in accordance with some embodiments of the present invention.

### DETAILED DESCRIPTION OF THE INVENTION

In the following description, for purposes of explanation, numerous specific details are set forth in order to provide a thorough understanding of the invention. It will be apparent, however, to one skilled in the art that the invention can be practiced without these specific details. In other instances, structures, devices, activities, methods, and processes are shown using schematics, use cases, and/or diagrams in order to avoid obscuring the invention. Although the following description contains many specifics for the purposes of illustration, anyone skilled in the art will appreciate that many variations and/or alterations to suggested details are within the scope of the present invention. Similarly, although many of the features of the present invention are described in terms of each other, or in conjunction with each other, one skilled in the art will appreciate that many of these features can be provided independently of other features. Accordingly, this description of the invention is set forth without any loss of generality to, and without imposing limitations upon, the invention.

Broadly, the present invention relates to a streamlined and efficient documentation production, usage, maintenance, and collaboration system. Specifically, methods and systems as disclosed herein are directed to document splicing, or “model splicing” human-readable documents, and linking document splices with other digital model splices to generate or update live documents or “magic documents” that are configured through software-defined digital threads to reflect changes in linked digital models. Within the context of digital engineering (DE), embodiments of the present invention are applicable to every stage of an DE process, from design, manufacturing, assembly, validation, to verification, providing dynamic DE data updates and access control as well as full traceability and auditability for a zero-trust implementation of the DE process.

As discussed in more detail herein, DE model splicing encapsulates and compartmentalizes DE model data and model data manipulation and access functionalities, and enables the scripting of DE model operations encompassing disparate DE tools into a corpus of normative program code. As a result, a large space of DE activities can be threaded into program code in the form of digital threads, thus enabling controlled sharing, revision, and manipulation of DE models outside their native environments. Embodiments of the present invention unify conventional, static, human-readable documents into a generalized DE model splicing framework, resulting in granular document components, Application Programming Interface (API) or Software Development Kit (SDK) endpoints, and associated API function scripts that enable the interfacing of documents with different software tools and individual data sources via digital threads for continuous and dynamic document updates that reflect the most current changes in linked data sources (e.g., DE models). In the context of DE, a DE document can be viewed as a special case of DE models. Linking document splices with other model splices via API endpoints facilitates bi-directional propagation of data updates with minimal human error and manual referencing. Granular linking at the document subunit or component (e.g., paragraph) level further makes live updates more computationally efficient and secure, aids in the prefiltering and compilation of document components for traceable and auditable use in DE tasks, and enables the aggregation and summarization of DE model data independently of native DE tools or development platforms used to generate the DE models in the first place.

Methods and systems thus described herein are further directed to AI-assisted DE model and DE document model linking and interaction. This integration of AI assistance, especially via Large Language Model (LLMs), expedites the process to describe or summarize a DE model into texts that are easy to read and understand, improves the referencing process, and allows single-click generation of model documentation. Similarly, DE workflows may be monitored to generate a summary of changes to models, accompanied by history of workflows that may lead to updates to linked documents. In various embodiments, the ML and AI engines or modules thus disclosed may be trained and/or fine-tuned on datasets of user inputs and exemplary document templates, document splices, and model splices. Fine-tuning may be further customized with enterprise documents and data when appropriate, to capture specific language and document dependencies within client databases.

Accordingly, various methods, processes, and non-transitory storage media storing program code for splicing a human-readable document and for generating a live human-readable document linked to a data source such as a DE model are within the scope of the present invention. A “DE model splicer” for a given DE model type, when applied to a specific digital model file of the DE model type, extracts model data from the model file, instantiates API endpoints according to input/output schemas, and encapsulates a set of selected scripts that allow access and modification of the model data. A “document splicer,” or “document model splicer,” when applied to a human-readable document and given a specific use case, partitions, segments, or granularizes document data, instantiates API endpoints according to the use case, generate splice function scripts that allow access and modification of document content, and enables the generation, dynamic update, and manipulation of a live DE document based on one or more linked data sources such as DE models. The live DE document thus generated can provide security and access control as well as full traceability for a zero-trust implementation of the digital engineering process.

With reference to the figures, embodiments of the present invention are now described in detail. First, general DE system and splicing-specific terminologies are introduced. Next, the DE system (IDEP) is explained in detail. Finally, the document splicing and live document generation and manipulation system, which may be considered a subsystem of the IDEP, is described in detail.

### General Terminology

Some illustrative terminologies used with the IDEP are provided below to assist in understanding the present invention, but these are not to be read as restricting the scope of the present invention. The terms may be used in the form of nouns, verbs, or adjectives, within the scope of the definition.
Digital engineering (DE): According to the Defense Acquisition University (DAU) and the Department of Defense (DOD) Digital Engineering Strategy published in 2018, digital engineering is “an integrated digital approach to systems engineering, using authoritative sources of systems' data and models as a continuum across disciplines to support lifecycle activities from concept through disposal.” Digital engineering incorporates digital technological innovations into an integrated, model-based approach that empowers a paradigm shift from the traditional design-build-test methodology of systems engineering to a new model-analyze-build methodology, thus enabling systems design, prototyping, and testing all in a virtual environment.
DE data: Digital engineering (DE) data comprises project management, program management, product management, design review, and/or engineering data.
DE data field: A data field for DE data, for example, in a DE document template.
Phases: The stages within a DE product lifecycle, including but not limited to, stakeholder analysis, concept studies, requirements definition, preliminary design and technology review, system modeling, final design, implementation, system assembly and integration, prototyping, verification and validation on system, sub-system, and component levels, and operations and maintenance.
DE model, also referred to as a “digital model”: A computer-generated model that represents characteristics or behaviors of a complex product or system. A DE model can be created or modified using a DE tool, and a DE model may be represented by one or more DE model files. A DE model file is the computer model file created or modified using the DE tool. In the present disclosure, the terms “digital model”, “DE model” and “DE model file” may be used interchangeably, as the context requires. A DE model within the IDEP as disclosed herein refers to any digital file uploaded onto the platform, including documents that are appropriately interpreted, as defined below. For example, a computer-aided design (CAD) file, a Systems Modeling Language (SysML) file, a Systems Requirements Document (SDR) text file, and a Neural Network Model JSON file may each be considered a DE model, in various embodiments of the present invention. A DE model may be machine-readable only, may be human-readable as well but written in programming codes, or may be human-readable and written in natural language-based texts. For example, a word-processing document comprising a technical specification of a product, or a spreadsheet file comprising technical data about a product, may also be considered a DE model.
Digital Model: A computer-generated model that represents characteristics or behaviors of a complex product, system, or process. Digital models include DE models but are not limited to the field of digital engineering. For example, digital models include medical model files used to build digital twins of patients (e.g., digital patients), such as clinical documentation, laboratory results, physiological test results, psychological test results, patient communications and reports, patient medical data, health records, remote monitoring data, and the like. Digital models also include the financial models used to build digital twins of financial assets, such as enterprise data, business financial data, process data (e.g., manufacturing, logistics, sales, supply chain), research results, etc. Other examples of digital models are also within the scope of the present invention, for example, scientific models, geophysical models, climate models, biological models, biochemical models, chemical models, drug models, petrochemical models, oceanographic models, business process models, management science models, economic models, econometric models, sociological models, population dynamics models, socioeconomic models, planetary science models, mining models, mineral models, metallurgical models, supply chain logistics models, manufacturing models, and so on. Digital models include one or more digital artifacts, where each digital artifact is accessible with a security network. A model file can be created or modified using a software tool. A model file within the Interconnected Digital Model Platform (IDMP) as disclosed herein refers to any digital file uploaded onto the platform. All the terms and concepts defined above and included herein, including model splicing, model splices, and software-defined digital threads, apply in the context of the digital model and within the context of the IDMP.
Interconnected Digital Engineering Platform (IDEP), also referred to as a “Digital Engineering and Certification Ecosystem”: According to the DAU, a “DE ecosystem” is the “interconnected infrastructure, environment, and methodology (process, methods, and tools) used to store, access, analyze, and visualize evolving systems' data and models to address the needs of the stakeholders.” Embodiments of the IDEP as disclosed herein comprise software platforms running on hardware to realize the aforementioned capabilities under zero-trust principles. A DE and certification ecosystem performs verification and validation tasks, defined next.
Interconnected Digital Model Platform (IDMP): Embodiments of the IDMP as disclosed herein include interconnected infrastructure, environment, and methodology (process, methods, and tools) used to store, access, analyze, visualize, and modify data and digital models associated with a product or system. In some embodiments, IDMPs include software platforms running on hardware to realize the aforementioned capabilities under zero-trust principles. Specifically, an embodiment of the IDMP is a software platform that interconnects a plurality of spliced model files through one or more software-defined digital threads.
Verification: According to the DAU, verification “confirms that a system element meets design-to or build-to specifications. Through the system's life cycle, design solutions at all levels of the physical architecture are verified through a cost-effective combination of analysis, examination, demonstration, and testing.” Verification refers to evaluating whether a product, service, or system meets specified requirements and is fit for its intended purpose, checking externally against customer or stakeholder needs. For example, in the aerospace industry, a verification process may include testing an aircraft component to ensure it can withstand the forces and conditions it will encounter during flight.
Validation: According to the DAU, validation is “1) the review and approval of capability requirement documents by a designated validation authority. 2) The process by which the contractor (or as otherwise directed by the DoD component procuring activity) tests a publication/technical manual for technical accuracy and adequacy. 3) The process of evaluating a system or software component during, or at the end of, the development process to determine whether it satisfies specified requirements.” Thus, validation refers to evaluating whether the overall performance of a product, service, or system is suitable for its intended use, including its compliance with regulatory requirements, and its ability to meet the needs of its intended users, checking internally against specifications and regulations. For example, for an industrial product manufacturing, a validation process may include consumer surveys that inform product design, modeling and simulations for validating the design, prototype testing for failure limits and feedback surveys from buyers.
Common Verification & Validation (V&V) products: Regulatory and certification standards, compliances, calculations, and tests (e.g., for the development, testing, and certification of products and/or solutions) are referred to herein as “common V&V products.”
DE tool: A tool or DE tool is a DE application software (e.g., a CAD software), computer program, and/or script that creates or manipulates a DE model during at least one stage or phase of a product lifecycle. A DE tool may comprise multiple functions or methods.
Application Programming Interface (API): A software interface that provides programmatic access to services by a software program, thus allowing application software to exchange data and communicate with each other using standardized requests and responses. It allows different programs to work together without revealing the internal details of how each works. A DE tool is typically provided with an API library for code-interface access.
Script: A sequence of instructions that is interpreted and run within or carried out by another program, without compilation into a binary file to be run by itself through a computer processor without the support of other programs.
API scripts: Scripts that implement particular functions available via the IDEP as disclosed herein. An API script may be an API function script encapsulated in a model splice, or an “orchestration script” or “platform script” that orchestrates a workflow through a digital thread built upon interconnected model splices.
Platform API or ISTARI API: A library of API scripts available on the IDEP as disclosed herein.
API function scripts, “splice functions.” “splice methods.” “ISTARI functions,” or “function nodes”: A type of API scripts. When executed, an API function script inputs into or outputs from a DE model or DE model splice. An “input” function, input method, or “input node” allows updates or modifications to an input DE model. An “output” function, output method, or “output node” allows data extraction or derivation from an input DE model via its model splice. An API function script may invoke native API function calls of native DE tools, where the terms “native” and “primal” may refer to existing DE model files, functions, and API libraries associated with specific third-party DE tools, including both proprietary and open-source ones.
Endpoints: an endpoint in the context of software and networking is a specific digital location or destination where different software systems communicate with each other. It enables external systems to access the features or data of an application, operating system, or other services. An API endpoint is the point of interaction where APIs receive requests and return data in response. A software development kit (SDK) endpoint or SDK-defined endpoint similarly provides a service handle for use with an SDK. References to API endpoints in the present disclosure are equally applicable to SDK endpoints.
Artifact: According to the DAU, a digital artifact is “an artifact produced within, or generated from, a DE ecosystem” to “provide data for alternative views to visualize, communicate, and deliver data, information, and knowledge to stakeholders.” In the present disclosure, a “digital artifact” or “artifact” is an execution result from an output API function script within a model splice. Multiple artifacts may be generated from a single DE model or DE model splice.
Model splice: Within the present disclosure, a “model splice”, “model wrapper”, or “model graft” of a given DE model file comprises locators to or copies of (1) DE model data or digital artifacts extracted or derived from the DE model file, including model metadata, and (2) splice functions (e.g., API function scripts) that can be applied to the DE model data. The splice functions provide unified and standardized input and output API endpoints for accessing and manipulating the DE model data. The DE model data are model-type-specific, and a model splice is associated with model-type-specific input and output schemas. One or more different model splices may be generated from the same input DE model file(s), based on the particular user application under consideration, and depending on data access restrictions. In some contexts, the shorter terms “splice”, “wrapper”, and/or “graft” are used to refer to spliced, wrapped, and/or grafted DE models.
Model representation: Within the present disclosure, “model representation” of a given DE model includes any embodiment of the engineering model in the form of DE model file(s), model splices, or collections of digital artifacts derived from the DE model. In some embodiments, a DE model representation comprises model-type-specific locators to DE model data and metadata, potentially including standardized input and output API endpoints for accessing and manipulating the DE model data. Discussions related to the usage of model splices in the present disclosure are applicable to any other forms of model representation as well.
Model splicing or DE model splicing: A process for generating a model splice from a DE model file. DE model splicing encompasses human-readable document model splicing or document splicing, where the DE model being spliced is a DE document comprising human-readable data such as text, images, graphs, charts, high-level programming code, hypertext, and the like.
Model splicer: Program code or script (uncompiled) that performs model splicing of DE models. A DE model splicer for a given DE model type, when applied to a specific DE model file of the DE model type, retrieves, extracts, or derives DE model data associated with the DE model file, generates and/or encapsulates splice functions and instantiates API endpoints according to input/output schemas.
Model splice linking: Generally refers to jointly accessing two or more DE model splices via API endpoints or splice functions. For example, data may be retrieved from one splice to update another splice (e.g., an input splice function of a first model splice calls upon an output splice function of a second model splice); data may be retrieved from both splices to generate a new output (e.g., output splice functions from both model splices are called upon); data from a third splice may be used to update both a first and a second splice (e.g., input splice functions from both model splices are called upon). In the present disclosure, “model linking” and “model splice linking” may be used interchangeably, as linked model splices map to correspondingly linked DE models.
Digital thread, Software-defined digital thread, Software-code-defined digital thread, or Software digital thread: According to the DAU, a digital thread is “an extensive, configurable and component enterprise-level analytical framework that seamlessly expedites the controlled interplay of authoritative technical data, software, information, and knowledge in the enterprise data-information-knowledge systems, based on the digital system model template, to inform decision makers throughout a system's lifecycle by providing the capability to access, integrate, and transform disparate data into actionable information.” Within the IDEP as disclosed herein, a digital thread is a platform script that calls upon the platform API to facilitate, manage, or orchestrate a workflow through linked model splices to provide the aforementioned capabilities. That is, a digital thread within the IDEP is a script that connects data from one or more DE models, data sources, or physical artifacts to accomplish a specific mission or business objective, and may be termed a “software-defined digital thread” or “software digital thread” that implements a communication framework or data-driven architecture that connects traditionally siloed DE models to enable seamless information flow among the DE models via model splices.
Tool linking: Similar to model splice linking, tool linking generally refers to jointly accessing two or more DE tools via model splices, where model splice functions that encapsulate disparate DE tool functions are called upon jointly to perform a DE task.
Zero-trust security: An information security principle based on the assumption of no implicit trust between any elements, agents, or users. Zero trust may be carried out by implementing systematic mutual authentication and least privileged access, typically through strict access control, algorithmic impartiality, and data isolation. Within the IDEP as disclosed herein, least privileged access through strict access control and data isolation may be implemented via model splicing and the IDEP system architecture.
Hyperscale capabilities: The ability of a system architecture to scale adequately when faced with massive demand.
IDEP enclave or DE platform enclave: A central command hub responsible for the management and functioning of DE platform operations. An enclave is an independent set of cloud resources that are partitioned to be accessed by a single customer (i.e., single-tenant) or market (i.e., multi-tenant) that does not take dependencies on resources in other enclaves.
IDEP exclave or DE platform exclave: A secondary hub situated within a customer environment to assist with customer DE tasks and operations. An exclave is a set of cloud resources outside enclaves managed by the IDEP, to perform work for individual customers. Examples of exclaves include virtual machines (VMs) and/or servers that the IDEP maintains to run DE tools for customers who may need such services.
Digital twin: According to the DAU, a digital twin is “a virtual replica of a physical entity that is synchronized across time. Digital twins exist to replicate configuration, performance, or history of a system. Two primary sub-categories of digital twin are digital instance and digital prototype.” A digital instance is “a virtual replica of the physical configuration of an existing entity: a digital instance typically exists to replicate each individual configuration of a product as-built or as-maintained.” A digital prototype is “an integrated multi-physical, multiscale, probabilistic model of a system design; a digital prototype may use sensor information and input data to simulate the performance of its corresponding physical twin; a digital prototype may exist prior to realization of its physical counterpart.” Thus, a digital twin is a real-time virtual replica of a physical object or system, with bi-directional information flow between the virtual and physical domains.
Authoritative twin: A reference design configuration at a given stage of a product life cycle. At the design stage, an authoritative twin is the twin configuration that represents the best design target. At the operational stage, an authoritative twin is the twin configuration that best responds to the actual conditions on the ground or “ground-truths”.
Admins or Administrators: Project managers or other authorized users. Admins may create templates in the documentation system and have high-level permissions to manage settings in the IDEP.
Requesters: Users who use the platform for the implementation of the modeling and simulations towards certification and other purposes, and who may generate documentation in the digital documentation system, but do not have admin privileges to alter the required templates, document formats, or other system settings.
Reviewers/Approvers: Users who review and/or approve templates, documents, or other system data.
Contributors: Users who provide comments or otherwise contribute to the IDEP.
Security Network: A set of networked resources having identical access control restrictions (e.g., a security level), where each networked resource provides access to one or more digital model files. Information security networks are security networks that are configured to maintain the confidentiality, integrity, and availability of digital information (e.g., digital model data) through cybersecurity measures such as encryption, firewalls, intrusion detection systems, and access controls. Embodiments of the present invention allow digital model files to be accessed securely and in an auditable fashion from multiple and distinct security networks (including ones with inconsistent access levels) across enterprise networks.

### Document Splicing and Live Document Update-Specific Terminology

Document: An electronic file that provides information as an official record. Document examples (i.e., documents with one or more previously completed data fields) may play a similar role to templates, where data fields can be replaced. Documents include human-readable files that are freeform and can be naturally read by humans with or without specialized software, for example in text editing or processing formats (e.g., .txt, .rtf, .docx, .doc, .ppt, .xlsx) portable document formats (e.g., .pdf, .ps), or in graphics formats (e.g., .jpg, .bmp, .png). Documents may also contain data structures and codifications that make them both human-readable and machine-readable. Some examples of human-readable and machine-readable files include comma-separated values files (.csv), JavaScript Object Notation files (.json), Extensible Markup Language (XML) files, markdown (.md) files and high-level computer programming and scripting files.
Human-readable data: information presented in a format that can be directly interpreted by humans. Examples include but are not limited to, textual data, tabular data, graphical data, image data, and hypertext data. Textual data may further include natural language text, numeric data, and high-level computer programming code and scripts. Textual data may be encoded in ASCII or Unicode formats. Human-readable data may have freeform layouts and typesets that are easily deciphered by humans but are hard for machines to understand without assistance from artificial intelligence.
Machine-readable data: data encoded or formatted to facilitate efficient transfer and processing for computers, digital devices, or specialized machines. Machine-readable data may be human-readable as well. For example, a machine may read and process a .json file but ignore descriptive comments within, which a human user may understand directly. Machine-readable data such as binary data are machine-readable only and cannot be naturally interpreted by a human user.
DE or Digital Document: A document with digital engineering (DE) or other digital data, for example, project management, program management, design review, and/or engineering data.
Static document: A type of document that contains fixed content, which does not change unless the document is manually edited or updated by an authorized user. Once created and finalized, a static document remains the same every time it is opened, regardless of changes in external data or the passage of time. Static documents do not support real-time interactivity or dynamic data retrieval, and are intended for viewing, printing, and distribution with very limited collaboration capabilities. An update made to a static document typically results in a new version of the document.
Live Document: Also referred to as “dynamic documents” or “magic documents” within the present disclosure, live documents are linked to data sources such as DE models or external databases and are capable of updating its content in real-time or on-demand as the underlying data changes. Live documents reflect the current or latest state of information with minimal manual intervention. In embodiments of present invention, live documents are updated through execution of software-defined digital threads or digital thread scripts.
Digital Thread Execution Metadata: Data that describes the processes and decisions that occur when a software-defined digital thread is executed. Such execution metadata may include, but are not limited to, information about operations and procedures, tasks executed, specific parameters, configurations, or setting used, decisions made, alternatives considered, collaboration communication logged, versioning and evolution over time, access and security measures, and performance metrics. Such digital thread execution metadata enable accuracy, traceability, accountability, and transparency for live document data updated via digital thread execution.
Document Template: A predetermined page and content layout, with optional style designations, and with designated sample data or data fields to be used as a guide. Templates could be created by a system administrator and/or by another authorized user. A document template may comprise one or more structured document parts having fillable data fields. Templates comprise one or more data fields that may be blank or have placeholder values. Templates also include example or prior documents with completed data fields that are updated or replaced when the example or prior document is used as a starting template for a new document. Templates also include blank or partially filled in documents that serve as starting templates for new documents. Therefore, the term “template” also includes document examples. Indeed, in some of the methods and systems described herein, a template may be defined as any reference starting-point document with a similar structure (e.g., data fields). Therefore, the terms “document template,” “template,” “example document,” “prior example,” and “blank document” may be used interchangeably herein, as the context requires.
DE Document Template and DE Template: A template with fields for DE data, for example, program management, product management, design review, and/or engineering data fields.

### An Interconnected Digital Engineering Platform (IDEP) Architecture

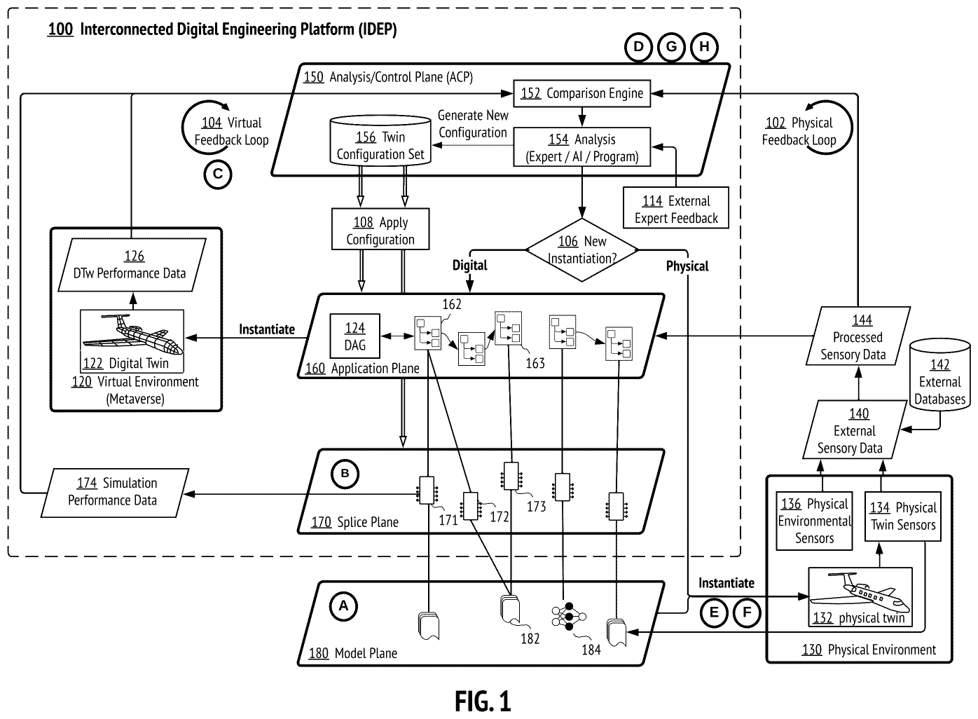

FIG. 1 shows an exemplary interconnected digital engineering platform (IDEP) architecture, in accordance with some embodiments of the present invention. IDEP 100 streamlines the process of product development from conception to production, by using a virtual representation or digital twin (DTw) 122 of the product to optimize and refine features before building a physical prototype or physical twin (PTw) 132, and to iteratively update DTw 122 until DTw 122 and PTw 132 are in sync to meet the product's desired performance goals.

Specifically, a product (e.g., airplane, spacecraft, exploration rover, missile system, automobile, rail system, marine vehicle, remotely operated underwater vehicle, robot, drone, medical device, biomedical device, pharmaceutical compound, drug, power generation system, smart grid metering and management system, microprocessor, integrated circuit, building, bridge, tunnel, chemical plants, oil and gas pipeline, refinery, etc.) manufacturer may use IDEP platform 100 to develop a new product. The engineering team from the manufacturer may create or instantiate digital twin (DTw) 122 of the product in a virtual environment 120, encompassing detailed computer-aided design (CAD) models and finite element analysis (FEA) or computational fluid dynamics (CFD) simulations of component systems such as fuselage, wings, engines, propellers, tail assembly, and aerodynamics. DTw 122 represents the product's design and performance characteristics virtually, allowing the team to optimize and refine features before building a physical prototype 132 in a physical environment 130. In some embodiments, PTw 132 may be an existing entity, while DTw 122 is a digital instance that replicates individual configurations of PTw 132, as-built or as-maintained. In the present disclosure, for illustrative purposes only, DTw 122 and PTw 132 are discussed in the context of building a new product, but it would be understood by persons of ordinary skill in the art that the instantiation of DTw 122 and PTw 132 may take place in any order, based on the particular use case under consideration.

Digital models (e.g., CAD models, FEA models, CFD models) used for creating DTw 122 are shown within a model plane 180 in FIG. 1. Also shown in model plane 180 is a neural network (NN) model 184, which may provide machine-learning based predictive modeling and simulation for a DE process. A DE model such as 182 may be spliced into one or more model splices, such as 172 and 173 within a splice plane 170. Individual DTws such as 122 are instantiated from splice plane 170 via an application plane 160. A model splice such as 172 may be linked to another model splice such as 171 by a platform script or application 162 on application plane 160 into a digital thread. Multiple digital threads such as 162 and 163 may be further linked across different stages or phases of a product life cycle, from concept, design, testing, to production. Digital threads further enable seamless data exchange and collaboration between departments and stakeholders, ensuring optimized and validated designs.

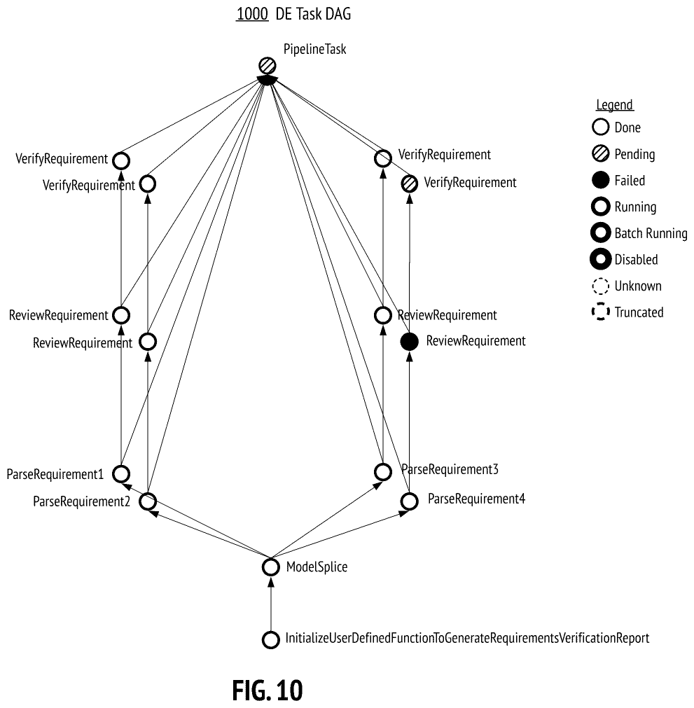

As model splicing provides input and output splice functions that can access and modify DE model data, design updates and DE tasks associated with the digital threads may be represented by scripted, interconnected, and pipelined tasks arranged in Directed Acyclic Graphs (DAGs) such as 124. A DE task DAG example is discussed in further detail with reference to FIG. 10.

To enhance the design, external sensory data 140 may be collected, processed, and integrated into application plane 160. This process involves linking data from different sources, such as physical sensors 134 on prototype 132, physical environmental sensors 136, and other external data streams such as simulation data from model plane 180. API endpoints provide access to digital artifacts from various environments (e.g., physical twin (PTw) sensor 134 data) and integrate them into the spliced plane 170 for the DTw 122. Model splices on the splice plane 170 enable autonomous data linkages and digital thread generation, ensuring DTw 122 accurately represents the product's real-world performance and characteristics.

To validate DTw 122's accuracy, the engineering team may build or instantiate PTw 132 based on the same twin configuration (i.e., digital design). Physical prototype 132 may be equipped with numerous sensors 134, such as accelerometers and temperature sensors, to gather real-time performance data. This data may be compared with the DTw's simulations to confirm the product's performance and verify its design.

Processed sensory data 144 may be used to estimate parameters difficult to measure directly, such as aerodynamic forces or tire contact patch forces. Such processed sensory data provide additional data for DTw 122, further refining its accuracy and reliability. Processed sensory data 144 may be generated from physical environment sensors 136 with physical environment 130, and may be retrieved from other external databases 142, as discussed below.

During development, feedback from customers and market research may be collected to identify potential improvements or adjustments to the product's design. At an analysis & control plane (ACP) 150, subject matter experts (SMEs) may analyze processed sensory data 144 and external expert feedback 114, to make informed decisions on necessary design changes. Such an analysis 154 may be enhanced or entirely enabled by algorithms (i.e., static program code) or artificial intelligence (AI) modules. Linking of digital threads such as 162, physical sensors 134 and 136, processed sensory data 144, and expert feedback data 114 occurs at ACP 150, where sensor and performance data is compared, analyzed, leading to modifications of the underlying model files through digital threads.

In particular, sensory data 144 from physical environment 130 and performance data 126 from virtual environment 120 may be fed into a comparison engine 152. Comparison engine 152 may comprise tools that enable platform users to compare various design iterations with each other and with design requirements, identify performance lapses and trends, and run verification and validation (V&V) tools.

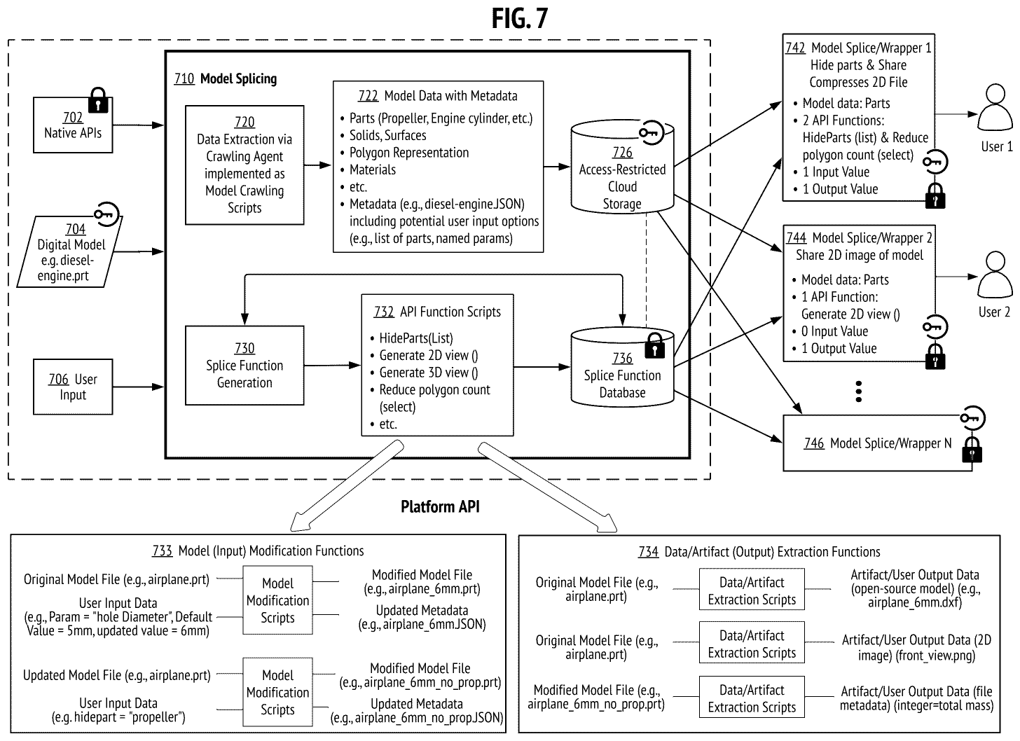

Model splicing is discussed in further detail with reference to FIGS. 7 to 9, and 11 to 33. Model splicing enables the scripting of any DE operation involving DE model files in model plane 180, where each DE model is associated with disparate and siloed DE tools. Codification of DE models and DE operations with a unified corpus of scripts enable IDEP 100 to become an aggregator where a large space of DE activities associated with a given product (e.g., airplane, spacecraft, exploration rover, missile system, automobile, rail system, marine vehicle, remotely operated underwater vehicle, robot, drone, medical device, biomedical device, pharmaceutical compound, drug, power generation system, smart grid metering and management system, microprocessor, integrated circuit, building, bridge, tunnel, chemical plants, oil and gas pipeline, refinery, etc.) may be threaded through program code. Thus, model splicing enables the linking and manipulation of all model files (e.g., 182, 184) associated with a given product within the same interconnected DE platform or DE ecosystem 100. As a consequence, the generation and training of AI modules for the purpose of manipulating DE models (e.g., 182), digital threads (e.g., 162), and digital twins (e.g., 122) become possible over the programmable and unified IDEP 100.

### Virtual and Physical Feedback Loops

FIG. 1 uses letter labels “A” to “H” to denote different stages of a product's lifecycle. At each stage, IDEP 100 enables feedback loops whereby data emanating from a PTw or a DTw is analyzed at ACP 150, leading to the generation of a new twin configuration based on design modifications. The new twin configuration may be stored in a twin configuration set and applied through the application and splice planes, yielding modified model files that are registered on the digital thread.

A virtual feedback loop 104 starts with a decision 106 to instantiate new DTw 122. A DAG of hierarchical tasks 124 allows the automated instantiation of DTw 122 within virtual environment 120, based on a twin configuration applied at a process step 108 from a twin configuration set 156. DTw 122 and/or components thereof are then tested in virtual environment 120, leading to the generation of DTw performance data 126. Concurrently, DTw 122 and/or components thereof may be tested and simulated in model plane 180 using DE software tools, giving rise to test and simulation performance data 174. Performance data 126 and 174 may be combined, compared via engine 152, and analyzed at ACP 150, potentially leading to the generation and storage of a new twin configuration. The eventual decision to instantiate a DTw from the new twin configuration completes virtual feedback loop 104.

A physical feedback loop 102 starts with a decision 106 to instantiate a new PTw 132. PTw 132 may be instantiated in a physical environment 130 from the model files of model plane 180 that are associated with an applied twin configuration from the twin configuration set 156. PTw 132 and/or components thereof are then tested in physical environment 132, leading to the generation of sensory data from PTw sensors 134 and environmental sensors 136 located in physical environment 130. This sensory data may be combined with data from external databases to yield processed sensory data 144.

Data from PTw sensors 134 may be directly added to the model files in model plane 180 by the DE software tools used in the design process of PTw 132. Alternatively. PTw sensor data may be added to digital thread 162 associated with PTw 132 directly via application plane 160. In addition, processed sensory data 144 may be integrated into IDEP 100 directly via application plane 160. For example, processed sensory data 144 may be sent to ACP 150 for analysis, potentially leading to the generation and storage of a new twin configuration. The eventual decision to instantiate a PTw from the new twin configuration completes physical feedback loop 102.

At each stage A to H of the product life cycle, the system may label one twin configuration as a current design reference, herein described as an “authoritative twin” or “authoritative reference”. The authoritative twin represents the design configuration that best responds to actual conditions (i.e., the ground truth). U.S. provisional patent application No. 63/470,870 (Docket No. IST-03.001P) provides a more complete description of authoritative twins and their determination, and is incorporated by reference in its entirety herein.

With faster feedback loops from sensor data and expert recommendations, the system updates DTw 122 to reflect latest design changes. This update process may involve engineering teams analyzing feedback 154 and executing the changes through IDEP 100, or automated changes enabled by IDEP 100 where updates to DTw 122 are generated through programmed algorithms or AI modules. This iterative updating process continues until DTw 122 and PTw 132 are in sync and the product's performance meets desired goals. While IDEP 100 may not itself designate the authoritative reference between a DTw or a PTw, the platform provides configurable mechanisms such as policies, algorithms, voting schema, and statistical support, whereby agents may designate a new DTw as the authoritative DTw, or equivalently in what instances the PTw is the authoritative source of truth.

When significant design improvements are made, a new PTw prototype may be built based on the updated DTw. This new prototype undergoes further testing and validation, ensuring the product's performance and design align with project objectives.

Once DTw 122 and PTw 132 have been validated and optimized, the product is ready for production. A digital thread connecting all stages of development can be queried via splice plane 170 to generate documentation as needed to meet validation and verification requirements. The use of model splicing, along with the feedback architecture shown in FIG. 1, improves the efficiency of the overall product innovation process.

### Interconnected DE Platform and Product Lifecycle

In FIG. 1, letter labels “A” to “H” indicate the following major steps of a product lifecycle, according to some embodiments of the current invention:
A. Digital models reside within customer environments: a product may be originally represented by model files that are accessible via software tools located within customer environments. Model plane 180 encompasses all model files (e.g., 182) associated with the product.
B. Preparatory steps for design in the digital realm: splice plane 170 encompasses model splices (e.g., 172) generated from DE model file through model splicing. Model splicing enables the integration and sharing of DE model files within a single platform, as described in detail with reference to FIGS. 7 to 9, and 11 to 33
C. Link threads as needed among model splices: to implement a product, model splices are linked through scripts within application plane 160. A digital twin (DTw) 122 englobing as-designed product features may be generated from application plane 160 for running in virtual environment 120. The complete twin configuration of a generated DTw is saved in twin configuration set 156 located at the analysis & control plane (ACP) 150. Features or parts of DTw 122 may be simulated in model plane 180, with performance data 174 accessed through splice plane 170. In one embodiment, features or parts of PTw 132 or DTw 122 configuration may be simulated outside the platform, where performance data is received by the ACP 150 for processing, in a similar way as performance data 126 received from DTw 122.
D. Finalize “As-designed”: performance data 126 from DTw 122 or simulation performance data 174 attained through model plane 180 and accessed through model splicing may be collected and sent to ACP 150 for analysis. Performance data from different iterations of DTw 122 may be compared via engine 152 to design requirements. Analysis of the differences may lead to the generation of new twin configurations that are stored at twin configuration set 156. Each twin configuration in twin configuration set 156 may be applied at application plane 160 and splice plane 170 via process step 108 to instantiate a corresponding DTw. Multiple DTws may be generated and tested, consecutively or simultaneously, against the design requirements, through comparison engine 152 and analysis module 154. Verification and validation tools may be run on the various DTw iterations.
E. Finalize “As-manufactured”: once a DTw 122 satisfies the design requirements, a corresponding PTw 132 prototype may be instantiated from the spliced model files (e.g., 172). Sensor data originating from the PTw 134 or from within the physical environment 136 may be collected, combined with other external data 142 (e.g., sensor data from other physical environments). The resulting processed sensory data 144 may be sent to the analysis & control plane 150 to be compared with performance data 126 from DTws and simulations (e.g., 174), leading to further DTw 122 and PTw 132 iterations populating the twin configuration set 156. Processed sensory data 144 may also be mapped to the digital threads (e.g., 164) and model splices (e.g., 172) governing the tested PTw 132 through the application plane 160.
F. Finalize “As-assembled”: once the manufacturing process is completed for the various parts, as a DTw and as a PTw, the next step is to finalize the assembled configuration. This involves creating a digital representation of the assembly to ensure it meets the specified requirements. The digital assembly takes into account the dimensions and tolerances of the “as-manufactured” parts. To verify the feasibility of the digital assembly, tests are conducted using the measured data obtained from the physical assembly and its individual components. Measurement data from the physical component parts may serve as the authoritative reference for the digital assembly, ensuring alignment with the real-world configuration. The digital assembly is compared with the actual physical assembly requirements for validation of the assembled configuration. Subsequently, the digital assembly tests and configurations serve as an authoritative reference for instructions to guide the physical assembly process and ensure accurate replication. IDEP 100 components described above may be used in the assembly process. In its authoritative iteration, DTw 122 ultimately captures the precise details of the physical assembly, enabling comprehensive analysis and control in subsequent stages of the process.
G. Finalize “As-operated”: to assess the performance of the physical assembly or its individual component parts, multiple digital twins 122 may be generated as needed. These digital twins are created based on specific performance metrics and serve as virtual replicas of the physical system. Digital twins 122 are continuously updated and refined in real-time using the operational data (e.g., 144) collected from monitoring the performance of the physical assembly or its components. This data may include, but are not limited to, processed sensory data, performance indicators, and other relevant information. By incorporating this real-time operational data, digital twins 122 stay synchronized with the actual system and provide an accurate representation of its operational performance. Any changes or improvements observed via sensory data 144 during the real-world operation of the assembly are reflected in DE models within the digital twins and recorded in the twin configuration set 156. This ensures that the digital twins remain up-to-date and aligned with the current state of the physical system.
H. Predictive analytics/Future performance: The design process may continue iteratively in virtual environment 120 through new DTw 122 configurations as the product is operated. Multiple digital twins may be created to evaluate the future performance of the physical assembly or its component parts based on specific performance metrics. Simulations are conducted with various control policies to assess the impact on performance objectives and costs. The outcome of these simulations helps in deciding which specific control policies should be implemented (e.g., tail volume coefficients and sideslip angle for an airplane product). The digital twin DE models (e.g., 182) are continuously updated and refined using the latest sensor data, control policies, and performance metrics to enhance their predictive accuracy. This iterative process ensures that the digital twins (e.g., 122, 156) provide reliable predictions of future performance and assist in making informed decisions.

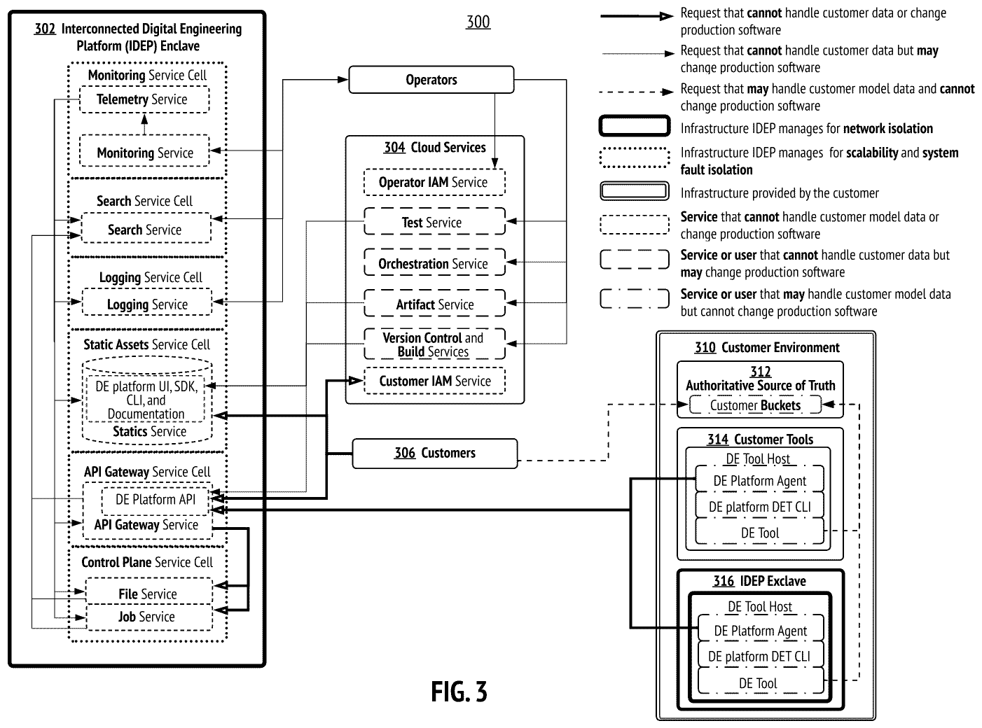

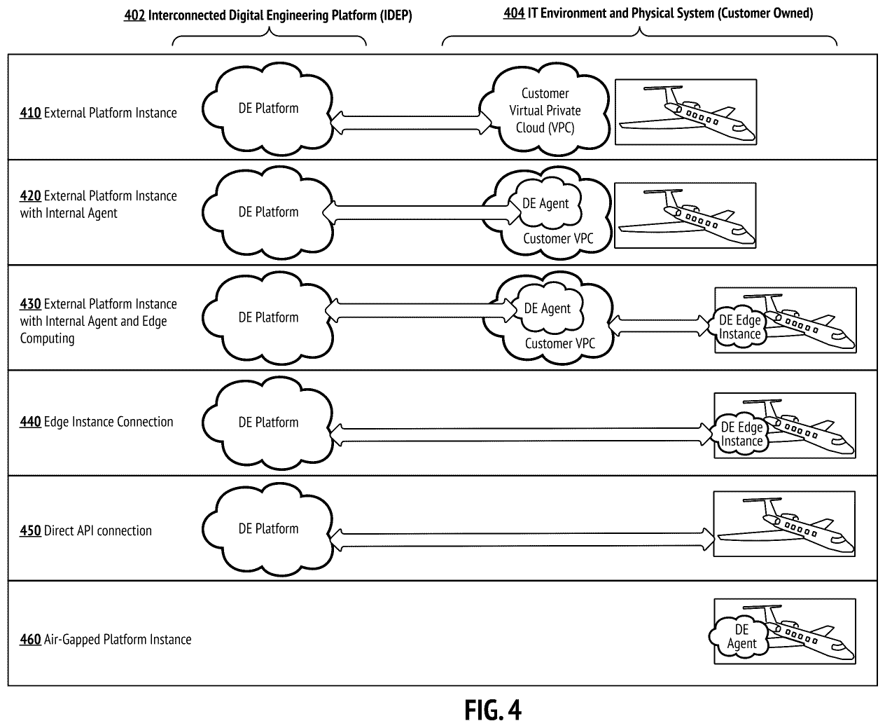

The hardware components making up IDEP 100 (e.g., servers, computing devices, storage devices, network links) may be centralized or distributed among various entities, including one or more DE service providers and DE clients, as further discussed in the context of FIGS. 3 and 4. FIG. 4 shows an illustration of various potential configurations for instancing a DE platform within a customer's physical system and information technology (IT) environment, usually a virtual private cloud (VPC) protected by a firewall.

DE Documentation with Live or Magic Documents

The methods and systems described herein enable the updating and generation of DE documents using the full functionality of the IDEP shown in FIG. 1. In FIG. 1, the IDEP virtual feedback loop 104 allows the scripting of program code within a digital thread 162 for the generation, storing, and updating of digital twins 122 and twin configurations 156. Similarly, the IDEP virtual feedback loop 104 also allows the scripting of program code within a digital thread 162 for the generation, storing, and updating of DE documents. This enables the creation and maintenance of so-called live digital engineering documents.

Live DE documents are more akin to a DTw than a conventional static document in that they are configured, through a digital thread, to be continuously updated to reflect the most current changes within a particular twin configuration. In particular, an authoritative live DE document is configured to reflect the latest authoritative twin configuration. The “printing” of a live DE document corresponds to the generation of a frozen (i.e., static) time-stamped version of a live DE document. Therefore, “printing”—for a live DE document—is equivalent to “instantiation” for a DTw.

Live DE documents may also be known as magic documents as changes implemented within a twin configuration (e.g., through a modification of a model file) may appear instantaneously within the relevant data fields and sections of the live DE document. Similarly, authoritative live DE documents may also be known as authoritative magic documents as they continuously reflect data from the authoritative twin, thus always representing the authoritative source of truth.

Given the massive quantities of data and potential modifications that are carried out during a product's lifecycle, the scripts implementing live DE documentation may be configured to allow for a predefined maximum delay between the modification of a model file and the execution of the corresponding changes within a live DE document. Moreover, for similar reasons, the scripts implementing live DE documentation may be restricted to operate over a specified subset of model files within a DTw, thus reflecting changes only to key parameters and configurations of the DTw.

In one embodiment of the present invention, an IDEP script (e.g., an IDEP application) having access to model data via one or more model splices and DE document templates to create and/or update a live DE document may dynamically update the live DE document using software-defined digital threads over an IDEP platform. In such an embodiment, the IDEP script may receive user interactions dynamically. In response to the user updating data for a model and/or a specific parameter setting, the IDEP script may dynamically propagate the user's updates into the DE document through a corresponding digital thread.

In another embodiment of the present invention, the IDEP script may instantiate a DE document with sufficient specification to generate a physical twin (PTw). In such an embodiment, the IDEP script may receive a digital twin configuration of a physical twin, generate a live DE document associated with the digital twin configuration, receive a predetermined timestamp, and generate a printed DE document (i.e., a static, time-stamped version of the live DE document at the predetermined timestamp). Such an operation may be referred to as the “printing of a digital twin”.

In yet another embodiment of the present invention, an IDEP script may instantiate (i.e., “print”) a DE document specifying an updated digital twin upon detecting the update. In such an embodiment, the IDEP script may detect a modification of a DE model or an associated digital thread. In response to detecting the modification, the IDEP script may update relevant data fields and sections of the live DE document based on the detected modification, and generate an updated printed DE document with the updated relevant data fields and sections based on the always-updated live DE document.

In various embodiments, a software-defined digital thread can be associated with a companion magic document (or “magic doc”) that encompasses live updates for one or more core parameters of the digital thread. In one embodiment, the magic doc includes key parameters describing the implementation of a user's intent. For example, In one embodiment, a companion magic doc for a given digital thread may include key data points and key orchestration script examples illustrating a user's intent (e.g., “increase a drone's wing span by 1%”). In one embodiment, a script-generating ML model receiving as input pseudocode or detailed user instructions derived from a user's intent, is trained on prior IDEP digital threads and documents. In addition to generating a digital thread (with orchestration scripts and comments), the script-generating ML model is also configured to generate a magic doc that explains how the generated digital thread addresses the user intent.

In some embodiments, receiving user interactions with a DE model, modifications to a DE model, or modifications to an associated digital thread, may be carried out through a push configuration, where a model splicer or a script of the digital thread sends any occurring relevant updates to the IDEP script immediately or within a specified maximum time delay. In other embodiments, receiving user interactions with a DE model, modifications of a DE model, or modifications of an associated digital thread, may be carried out through a pull configuration, where a model splicer or a script of the digital thread flag recent modifications until the IDEP script queries relevant DE models (via their model splices) or associated digital threads, for flagged modification. In these embodiments, the IDEP script may extract the modified information from the modified DE models (via their model splices) or the modified digital threads, in order to update a live DE document. In yet other embodiments, receiving user interactions with a DE model, modifications of a DE model, or modifications of an associated digital thread, may be carried out through a pull configuration, where the IDEP script regularly checks relevant DE models (via their model splices) or associated digital threads, for modified data fields, by comparing the data found in the live DE document with regularly extracted model and digital thread data. In these embodiments, the IDEP script may use the modified data to update the live DE document.

### Dynamic Document Updates

Some embodiments described herein center around documentation, or document preparation and update and on document management (e.g., for reviews). As discussed, some embodiments of the system allow for dynamic updates to documents, which pertain to software-defined digital threads in the IDEP platform and the accompanying documentation.

Use of an ML engine with the model data and templates to create and/or update documents almost instantaneously as a one-time action have been presented. Furthermore, the digital engineering platform interacts dynamically with the user. As the user interacts with the system and updates data for a model or a specific parameter setting, these changes may be propagated through the corresponding digital threads and to the associated documentation. The AI architectures involved include locally-instanced large language model (LLMs, for data security reasons) as well as non-LLM approaches (e.g., NLP-based), in order to create, update, or predict documentation in the form of sentences, paragraphs, and whole documents. At the same time, trying to update the entire system of digital threads for every update may be prohibitively slow and may present security risks to the system. Generating live DE documents that are updated based on a subset of a system's DE models and within a maximum time delay may therefore be more efficient.

### Interconnected Digital Engineering and Certification Ecosystem

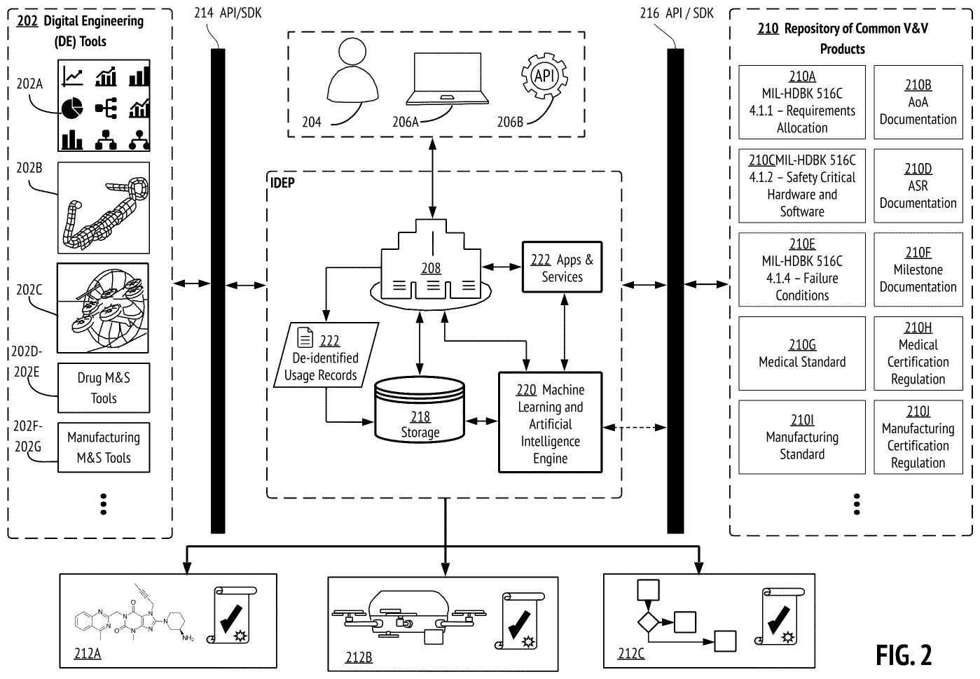

FIG. 2 shows an exemplary implementation of the IDEP as an interconnected digital engineering (DE) and certification ecosystem 200, and exemplary digitally certified products, in accordance with some embodiments of the present invention. Interconnected DE and certification ecosystem 200 may be viewed as a particular instantiation or implementation of IDEP 100 shown in FIG. 1. The IDEP may also be referred to as a “DE Metaverse.”

Interconnected DE and certification ecosystem 200 is a computer-based system that links models and simulation tools with their relevant requirements in order to meet verification, validation, and certification purposes. Verification refers to methods of evaluating whether a product, service, or system meets specified requirements and is fit for its intended purpose. For example, in the aerospace industry, a verification process may include testing an aircraft component to ensure it can withstand the forces and conditions it will encounter during flight. Verification also includes checking externally against customer or stakeholder needs. Validation refers to methods of evaluating whether the overall performance of a product, service, or system is suitable for its intended use, including its compliance with regulatory requirements and its ability to meet the needs of its intended users. Validation also includes checking internally against specifications and regulations. Interconnected DE and certification ecosystem 200 as disclosed herein is designed to connect and bridge large numbers of disparate DE tools and models from multitudes of engineering domains and fields, or from separate organizations who may want to share models with each other but have no interactions otherwise. In various embodiments, the system implements a robust, scalable, and efficient DE model collaboration platform, with extensible model splices having data structures and accompanying functions for widely distributed DE model types and DE tools, an application layer that links or connects DE models via APIs, digital threads that connect live engineering model files for collaboration and sharing, digital documentation management to assist with the preparation of engineering and certification documents appropriate for verification and validation (V&V) purposes, and AI-assistance with the functionalities of the aforementioned system components.

More specifically, FIG. 2 shows an example of an interconnected DE and certification ecosystem and examples of digitally certified products 212A, 212B, and 212C (collectively referred to as digitally certified products 212). For example, in some implementations, digitally certified product 212A may be an unmanned aerial vehicle (UAV) or other aircraft, digitally certified product 212B may be a drug or other chemical or biologic compound, and the digitally certified product 212C may be a process such as a manufacturing process. In general, the digitally certified products 212 can include any product, process, or solution that can be developed, tested, or certified (partially or entirely) using DE tools such as 202. In some implementations, digitally certified products 212 may not be limited to physical products, but can include non-physical products such as methodologies, processes and software, etc. While physical and physically-interacting systems often require multiple DE tools to assess for compliance with common V&V products simply by virtue of the need for modeling and simulation (M&S), many complex non-physical systems may also require multiple DE tools for product development, testing, and/or certification. With this in mind, various other possibilities for digitally certified products will be recognized by one of ordinary skills in the art. The inclusion of regulatory and certification standards, compliances, calculations, and tests (e.g., for the development, testing, and certification of products and/or solutions) enables users to incorporate relevant regulatory and certification standards, compliances, calculations, and test data directly into their DE workflow. Regulatory and certification standards, compliances, calculations, and tests are sometimes referred to herein as “common validation and verification (V&V) products.”

Digitally certified products 212 in FIG. 2 may be designed and/or certified using interconnected DE and certification ecosystem 200. Interconnected DE and certification ecosystem 200 may include a user device 206A, API 206B, or other similar human-to-machine, or machine-to-machine communication interfaces operated by a user. A user may be a human 204 of various skill levels, or artificial users such as algorithms, artificial intelligence, or other software that interface with ecosystem 200 through API 206B. Ecosystem 200 may further comprise a computing and control system 208 (“computing system 208” hereinafter) connected to and/or including a data storage unit 218, an artificial intelligence (AI) engine 220, and an application and service layer 222. In some embodiments, the artificial intelligence (AI) engine 220 is a machine learning (ML) engine. References to “machine learning engine 220” or “ML engine 220” may be extended to artificial intelligence (AI) engines 220 more generally. For the purposes of clarity, any user selected from various potential human or artificial users are referred to herein simply as the user 204. In some implementations, computing system 208 may be a centralized computing system; in some implementations, computing system 208 may be a distributed computing system. In some cases, user 204 may be considered part of ecosystem 200, while in other implementations, user 204 may be considered separately from ecosystem 200. Ecosystem 200 may include one or more DE tools 202, such as data analysis tool 202A, computer-aided design (CAD) and finite element analysis (FEA) tool 202B, simulation tool 202C, drug modeling and simulation (M&S) tools 202D-202E, manufacturing M&S tools 202F-202G, etc. Ecosystem 200 may also include a repository of common V&V products 210, such as regulatory standards 210A-210F related to the development and certification of a UAV, medical standard 210G (e.g., CE marking (Europe), FCC Declaration of Conformity (USA), IECEE CB Scheme (Europe, North America, parts of Asia & Australia), CDSCO (India), FDA (USA), etc.), medical certification regulation 210H (e.g., ISO 13485, ISO 14971, ISO 9001, ISO 62304, ISO 10993, ISO 15223, ISO 11135, ISO 11137, ISO 11607, IEC 60601, etc.), manufacturing standard 210I (e.g., ISO 9001, ISO 9013, ISO 10204, EN 1090, ISO 14004, etc.), and manufacturing certification regulation 210J (e.g., General Certification of Conformity (GCC), etc.), etc.

In FIG. 2, computing system 208 is centrally disposed within the architecture and is configured to communicate with (e.g., receive data from and transmit data to) user device 206A or API 206B such as an API associated with an artificial user, DE tools 202 via an API or software development kit (SDK) 214, and repository of common V&V products 210 via an API/SDK interface 216. For example, computing system 208 may be configured to communicate with user device 206A and/or API 206B to send or receive data corresponding to a prototype of a design, information about a user (e.g., user credentials), engineering-related inputs/outputs associated with DE tools 202, digitized common V&V products, an evaluation of a product design, user instructions (e.g., search requests, data processing instructions, etc.), and more. Computing system 208 may also be configured to communicate with one or more DE tools 202 to send engineering-related inputs for executing analyses, models, simulations, tests, etc. and to receive engineering-related outputs associated with the results. Computing system 208 may also be configured to communicate with repository of common V&V products 210 to retrieve data corresponding to one or more digitized common V&V products 210 and/or upload new common V&V products, such as those received from user 204, to repository of common V&V products 210. All communications may be transmitted and corroborated securely, for example, using methods relying on zero-trust security. In some implementations, the computing system of the ecosystem may interface with regulatory and/or certification authorities (e.g., via websites operated by the authorities) to retrieve digitized common V&V products published by the regulatory authorities that may be relevant for a product that a user is designing. In some implementations, the user may upload digitized common V&V products to the ecosystem themselves.

Computing and control system 208 may process and/or store the data that it receives to perform analysis and control functionalities, and in some implementations, may access machine learning engine 220 and/or application and service layer 222, to identify useful insights based on the data, as further described herein. The central disposition of computing system 208 within the architecture of the ecosystem has many advantages including reducing the technical complexity of integrating the various DE tools; improving the product development experience of user 204; intelligently connecting common V&V products such as standards 210A-210F to DE tools 202 most useful for satisfying requirements associated with the common V&V products; and enabling the monitoring, storing, and analysis of the various data that flows between the elements of the ecosystem throughout the product development process. In some implementations, the data flowing through and potentially stored by the computing system 208 can also be auditable to prevent a security breach, to perform data quality control, etc. Similarly, any analysis and control functions performed via computing system 208 may be tracked for auditability and traceability considerations.

Referring to one particular example shown in FIG. 2, user 204 may use the DE and certification ecosystem to produce a digitally certified UAV 212B. For example, user 204 may be primarily concerned with certifying the UAV as satisfying the requirements of a particular regulatory standard 210E relating to failure conditions of the UAV (e.g., “MIL-HDBK 516C 4.1.4—Failure Conditions”). In this usage scenario, user 204 may develop a digital prototype of the UAV on user device 206A or using API 206B and may transmit prototype data (e.g., as at least one of a CAD file, a MBSE file, etc.) to computing system 208. Along with the prototype data, user 204 can transmit, via user device 206A, additional data including an indication of the common V&V product that user 204 is interested in certifying the product for (e.g., regulatory standard 210E), user credential information for accessing one or more capabilities of computing system 208, and/or instructions for running one or more digital models, tests, and/or simulations using a subset of DE tools 202.

Referring to another example shown in FIG. 2, user 204 can use the DE and certification ecosystem to produce a digitally certified drug, chemical compound, or biologic 212A. For example, user 204 may be primarily concerned with certifying drug, chemical compound, or biologic 212A as satisfying the requirements of a particular medical standard 210G and medical certification regulation 210H. In this usage scenario, user 204 can develop a digital prototype of the drug, chemical compound, or biologic on user device 206A or using API 206B and can transmit the prototype data (e.g., as a molecular modeling file) to computing system 208. Along with the prototype data, user 204 can transmit, via user device 206A, additional data including an indication of the common V&V products that user 204 is interested in certifying the product for (e.g., medical standard 210G and medical certification regulation 210H), user credential information for accessing one or more capabilities of computing system 208, and/or instructions for running one or more digital models, tests, and/or simulations using a subset of DE tools 202 (e.g., drug M&S tools 202D-202E).

Referring to yet another example shown in FIG. 2, user 204 can use the digital engineering and certification ecosystem to produce a digitally certified manufacturing process 212C. For example, user 204 may be primarily concerned with certifying manufacturing process 212C as satisfying the requirements of a particular manufacturing standard 210I and manufacturing certification regulation 210J. In this usage scenario, user 204 can develop a digital prototype of the manufacturing process on user device 206A or using API 206B and can transmit the prototype data to computing system 208. Along with the prototype data, user 204 can transmit, via the user device 206A, additional data including an indication of the common V&V products that user 204 is interested in certifying the process for (e.g., manufacturing standard 210I and manufacturing certification regulation 210J), user credential information for accessing one or more capabilities of computing system 208, and/or instructions for running one or more digital models, tests, and/or simulations using a subset of DE tools 202 (e.g., manufacturing M&S tools 202F-202G).

In any of the aforementioned examples, computing system 208 can receive the data transmitted from user device 206A and/or API 206B and can process the data to evaluate whether the common V&V product of interest (e.g., regulatory standard 210E, medical standard 210G, medical certification regulation 210H, manufacturing standard 210I, manufacturing certification regulation 210J, etc.) is satisfied by the user's digital prototype, in the context of analysis and control plane 150 shown in FIG. 1. For example, this can involve communicating with the repository of common V&V products 210 via the API/SDK 216 to retrieve the relevant common V&V product of interest and processing the regulatory and/or certification data associated with the common V&V product to identify one or more requirements for the UAV prototype; the drug, chemical compound, or biologic prototype; the manufacturing process prototype; etc. In some implementations, repository of common V&V products 210 can be hosted by a regulatory and/or certification authority (or another third party), and retrieving the regulatory and/or certification data can involve using API/SDK 216 to interface with one or more data resources maintained by the regulatory and/or certification authority (or the another third party). In some implementations, the regulatory and/or certification data can be provided directly by user 204 via user device 206A and/or API 206B (e.g., along with the prototype data).

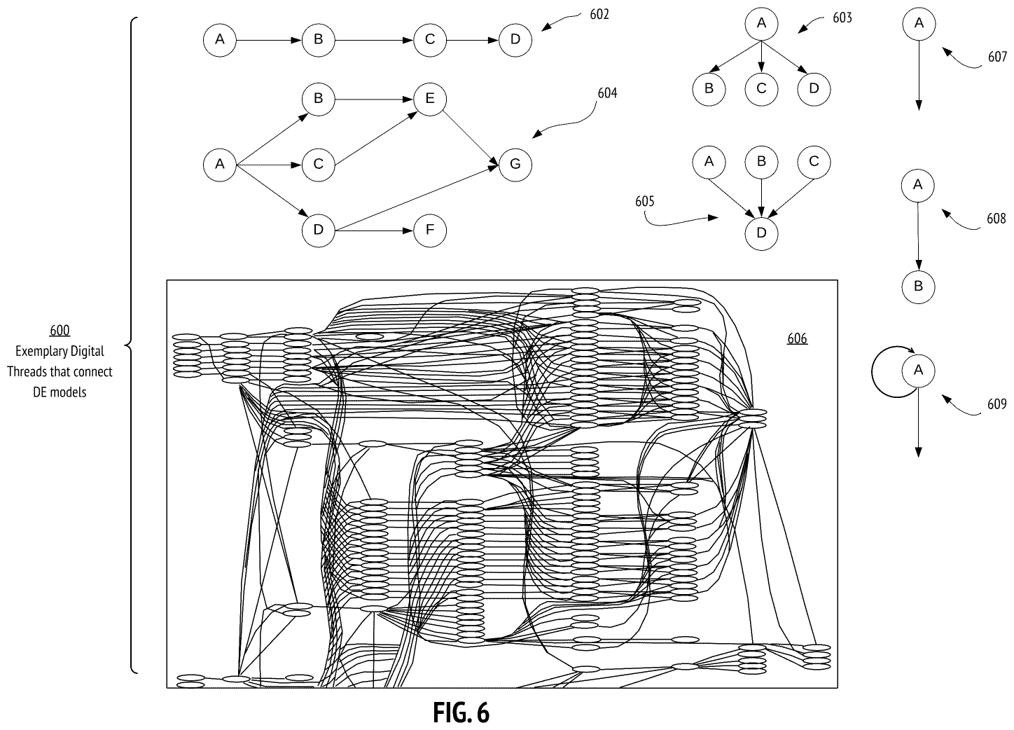

Evaluating whether the common V&V product of interest is satisfied by the user's digital prototype can also involve processing the prototype data received from user device 206A or API 206B to determine if the one or more identified requirements are actually satisfied. In some implementations, computing system 208 can include one or more plugins, local applications, etc. to process the prototype data directly at the computing system 208. For example, model splicing and digital threading applications are discussed in detail later with reference to FIGS. 6 to 9. In some implementations, the computing system can simply pre-process the received prototype data (e.g., to derive inputs for DE tools 202) and can then transmit instructions and/or input data to a subset of DE tools 202 via API/SDK 214 for further processing.

Not all DE tools 202 are necessarily required for the satisfaction of particular regulatory and/or certification standards. Therefore, in the UAV example provided in FIG. 2, computing system 208 may determine that only a data analysis tool 202A and a finite element analysis tool 202B are required to satisfy regulatory standard 210E for failure conditions. In the drug, chemical compound, or biologic example provided in FIG. 2, computing system 208 may determine that only drug M&S tools 202D-202E are required to satisfy medical standard 210G and medical certification regulation 210H. In the manufacturing process example provided in FIG. 2, computing system 208 may determine that only manufacturing M&S tools 202F-202G are required to satisfy manufacturing standard 210I and manufacturing certification regulation 210J. In other implementations, user 204 may themselves identify the particular subset of DE tools 202 that should be used to satisfy the common V&V product of interest, provided that user 204 is a qualified subject matter expert (SME). In other implementations, user 204 may input to computing system 208 some suggested DE tools 202 to satisfy a common V&V product of interest, and computing system 208 can recommend to user 204 a modified subset of DE tools 202 for final approval by user 204, provided that user 204 is a qualified SME. After a subset of DE tools 202 has been identified, computing system 208 can then transmit instructions and/or input data to the identified subset of DE tools 202 to run one or more models, tests, and/or simulations. The results (or “engineering-related data outputs” or “digital artifacts”) of these models, tests, and/or simulations can be transmitted back and received at computing system 208.

In still other implementations, user 204 may input a required DE tool such as 202F for meeting a common V&V product 210I, and the computing system 208 can determine that another DE tool such as 102G is also required to satisfy common V&V product 210I. The computing system can then transmit instructions and/or input data to both DE tools (e.g., 202F and 202G), and the outputs of these DE tools can be transmitted and received at computing system 208. In some cases, the input data submitted to one of the DE tools (e.g., 202G) can be derived (e.g., by computing system 208) from the output of another of the DE tools (e.g., 202F).

After receiving engineering-related data outputs or digital artifacts from DE tools 202, computing system 208 can then process the received engineering-related data outputs to evaluate whether or not the requirements identified in the common V&V product of interest (e.g., regulatory standard 210E, medical standard 2110G, medical certification regulation 210H, manufacturing standard 210I, manufacturing certification regulation 210J, etc.) are satisfied. For example, applications and services 222 may provide instructions for orchestrating validation or verification activities. In some implementations, computing system 208 can generate a report summarizing the results of the evaluation and can transmit the report to device 206A or API 206B for review by user 204. If all of the requirements are satisfied, then the prototype can be certified, resulting in digitally certified product 212 (e.g., digitally certified drug, chemical compound, or biologic 212A; digitally certified UAV 212B; digitally certified manufacturing process 212C, etc.). However, if some of the regulatory requirements are not satisfied, then additional steps may need to be taken by user 204 to certify the prototype of the product. In some implementations, the report that is transmitted to the user can include recommendations for these additional steps (e.g., suggesting one or more design changes, suggesting the replacement of one or more components with a previously designed solution, suggesting one or more adjustments to the inputs of the models, tests, and/or simulations, etc.). If the requirements of a common V&V product are partially met, or are beyond the collective capabilities of distributed engineering tools 202, computing systems 208 may provide user 204 with a report recommending partial certification, compliance, or fulfillment of a subset of the common V&V products (e.g., digital certification of a subsystem or a sub-process of the prototype). The process of generating recommendations for user 204 is described in further detail below.

In response to reviewing the report, user 204 can make design changes to the digital prototype locally and/or can send one or more instructions to computing system 208 via user device 206A or API 206B. These instructions can include, for example, instructions for computing system 208 to re-evaluate an updated prototype design, use one or more different DE tools 202 for the evaluation process, and/or modify the inputs to DE tools 202. Computing system 208 can, in turn, receive the user instructions, perform one or more additional data manipulations in accordance with these instructions, and provide user 204 with an updated report. Through this iterative process, user 204 can utilize the interconnected digital engineering and certification ecosystem to design and ultimately certify (e.g., by providing certification compliance information) the prototype (e.g., the UAV prototype, drug prototype, manufacturing process prototype, etc.) with respect to the common V&V product of interest. Importantly, since all of these steps occur in the digital world (e.g., with digital prototypes, digital models/tests/simulations, and digital certification), significant amount of time, cost, and materials can be saved in comparison to a process that would involve the physical prototyping, evaluation and/or certification of a similar UAV, drug, manufacturing process, etc. If the requirements associated with a common V&V product are partially met, or are beyond the collective capabilities of DE tools 202, computing system 208 may provide user 204 with a report recommending partial certification, compliance or fulfillment of a subset of the common V&V products (e.g., digital certification of a subsystem or a sub-process of the prototype).

While the examples described above focus on the use of the interconnected digital engineering and certification ecosystem by a single user, additional advantages of the ecosystem can be realized through the repeated use of the ecosystem by multiple users. As mentioned above, the central positioning of computing system 208 within the architecture of the ecosystem enables computing system 208 to monitor and store the various data flows through the ecosystem. Thus, as an increasing number of users utilize the ecosystem for digital product development, data associated with each use of the ecosystem can be stored (e.g., in storage 218), traced (e.g., with metadata), and analyzed to yield various insights, which can be used to further automate the digital product development process and to make the digital product development process easier to navigate for non-subject matter experts.

Indeed, in some implementations, user credentials for user 204 can be indicative of the skill level of user 204, and can control the amount of automated assistance the user is provided. For example, non-subject matter experts may only be allowed to utilize the ecosystem to browse pre-made designs and/or solutions, to use DE tools 202 with certain default parameters, and/or to follow a predetermined workflow with automated assistance directing user 204 through the product development process. Meanwhile, more skilled users may still be provided with automated assistance, but may be provided with more opportunities to override default or suggested workflows and settings.

In some implementations, computing system 208 can host applications and services 222 that automate or partially automate components of common V&V products; expected or common data transmissions, including components of data transmissions, from user 204; expected or common interfaces and/or data exchanges, including components of interfaces, between various DE tools 202; expected or common interfaces and/or data exchanges, including components of interfaces, with machine learning (ML) models implemented on computing system 208 (e.g., models trained and/or implemented by the ML engine 220); and expected or common interfaces and/or data exchanges between the applications and services themselves (e.g., within applications and services layer 222).

In some implementations, the data from multiple uses of the ecosystem (or a portion of said data) can be aggregated to develop a training dataset. For example, usage records 217 collected via computing system 208 may be de-identified or anonymized, before being added to the training set. Such usage records may comprise model parameters and metadata, tool configurations, common V&V product matching to specific models or tools, user interactions with the system including inputs and actions, and other user-defined or system-defined configurations or decisions in using the ecosystem for digital engineering and certification. For instance, an exemplary de-identified usage record may comprise the combination of a specific DE tool, a specific target metric, a specific quantity deviation, and a corresponding specific user update to a DE model under this configuration. Another exemplary de-identified usage record may comprise a user-identified subset of DE tools 202 that should be used to satisfy a common V&V product of interest.

This training dataset can then be used to train ML models (e.g., using ML engine 220) to learn the steps and actions for certification processes and to perform a variety of tasks including the identification of which of DE tools 202 to use to satisfy a particular common V&V product; the identification of specific models, tests, and/or simulations (including inputs to them) that should be performed using DE tools 202; the identification of the common V&V products that need to be considered for a product of a particular type; the identification of one or more recommended actions for user 204 to take in response to a failed regulatory requirement; the estimation of model/test/simulation sensitivity to particular inputs; etc. The outputs of the trained ML models can be used to implement various features of the interconnected digital engineering and certification ecosystem including automatically suggesting inputs (e.g., inputs to DE tools 202) based on previously entered inputs, forecasting time and cost requirements for developing a product, predictively estimating the results of sensitivity analyses, and even suggesting design changes, original designs or design alternatives (e.g. via assistive or generative AI) to a user's prototype to overcome one or more requirements (e.g., regulatory and/or certification requirements) associated with a common V&V product. In some implementations, with enough training data, ML engine 220 may generate new designs, models, simulations, tests, common V&V products and/or digital threads on its own based on data collected from multiple uses of the ecosystem. Furthermore, such new designs, models, simulations, tests, common V&V products and digital threads generated by ML engine 220, once approved and adjusted by a user, may be added to the training set for further fine-tuning of ML algorithms in a reinforcement learning setup.

As shall be discussed in the context of FIGS. 7 to 9 and 11 to 33, the aforementioned collection of training datasets and the training of ML and AI modules including ML engine 220 may be enabled by model splicing technologies. Model splicing, as described herein, allows the scripting of DE model operations encompassing disparate DE tools into a corpus of normative program code, and facilitates the code-defined digital threading of a large space of DE activities involving DE models across different disciplines. ML and AI techniques may be used to create scripts to carry out almost any DE task and to execute any digital thread, allowing for programmable, machine-learnable, and dynamic changes to DE model files, digital threads, and ultimately to digital or physical twins, throughout the product life cycle. For example, in the embodiment shown in FIG. 2. ML engine 220 may manage or orchestrate the interactions between spliced DE models, DE tools, and common V&V products (e.g., DE requirements), based on digital thread options specific to user's intent and input. Sample DE tasks that may be carried out by ML engine 220 include, but are not limited to, (1) aligning models/analysis to certification lifecycle requirement steps, (2) optimizing compute by determining the appropriate fidelity of each model, (3) optimizing compute resources for specific tools/models, or (4) optimizing compute resources across multiple models. ML-enabled executions of DE tasks are not limited to certification or resource optimization, but encompass the whole DE space of operations. Rather, ML engine 220 may act as an AI multiplexer for the DE platform.

In addition to storing usage data to enable the development of ML models, previous prototype designs and/or solutions (e.g., previously designed components, systems, models, simulations and/or other engineering representations thereof) can be stored within the ecosystem (e.g., in storage 218) to enable users to search for and build upon the work of others. For example, previously designed components, systems, models, simulations and/or other engineering representations thereof can be searched for by user 204 and/or suggested to user 204 by computing system 208 in order to satisfy one or more requirements associated with a common V&V product. The previously designed components, systems, models, simulations and/or other engineering representations thereof can be utilized by user 204 as is, or can be utilized as a starting point for additional modifications. This store, or repository, of previously designed components, systems, models, simulations and/or other engineering representations thereof (whether or not they were ultimately certified) can be monetized to create a marketplace of digital products, which can be utilized to save time during the digital product development process, inspire users with alternative design ideas, avoid duplicative efforts, and more. In some implementations, data corresponding to previous designs and/or solutions may only be stored if the user who developed the design and/or solution opts to share the data. In some implementations, the repository of previous designs and/or solutions can be containerized for private usage within a single company, team, organizational entity, or technical field for private usage (e.g., to avoid the unwanted disclosure of confidential information). In some implementations, user credentials associated with user 204 can be checked by computing system 208 to determine which designs and/or solutions stored in the repository can be accessed by user 204. In some implementations, usage of the previously designed components, systems, models, simulations and/or other engineering representations thereof may be available only to other users who pay a fee for a usage.

Exemplary IDEP Implementation Architecture with Services and Features

FIG. 3 shows another exemplary implementation of the IDEP illustrating its offered services and features, in accordance with some embodiments of the present invention. Specifically, an exemplary implementation architecture diagram 300 is shown in FIG. 3 to include multiple illustrative components: an IDEP enclave 302, cloud services 304, and a customer environment 310 which optionally includes an IDEP exclave 316. This exemplary architecture 300 for the IDEP is designed in accordance with zero-trust security principles and is further designed to support scalability as well as robust and resilient operations. IDEP enclave 302 and IDEP exclave 316 together instantiate IDEP 100 shown in FIG. 1, with IDEP exclave 316 implementing model splicing and splice plane 170 in some embodiments of the present invention. An enclave is an independent set of cloud resources that are partitioned to be accessed by a single customer (i.e., single-tenant) or market (i.e., multi-tenant) that does not take dependencies on resources in other enclaves. An exclave is a set of cloud resources outside enclaves managed by the IDEP, to perform work for individual customers. Examples of exclaves include virtual machines (VMs) and/or servers that the IDEP maintains to run DE tools for customers who need such services.

In particular, IDEP enclave or DE platform enclave 302 may serve as a starting point for services rendered by the IDEP, and may be visualized as a central command and control hub responsible for the management and orchestration of all platform operations. For example, enclave 302 may be implemented using computer system 208 of the interconnected DE and certification ecosystem shown in FIG. 2. DE platform enclave 302 is designed to integrate both zero-trust security models and hyperscale capabilities, resulting in a secure and scalable processing environment tailored to individual customer needs. Zero-trust security features include, but are not limited to, strict access control, algorithmic impartiality, and data isolation. Enclave 302 also supports an ML engine such as 220 for real-time analytics, auto-scaling features for workload adaptability, and API-based interoperability with third-party services. Security and resource optimization are enhanced through multi-tenancy support, role-based access control, and data encryption both at rest and in transit. DE platform enclave 302 may also include one or more of the features described below.

First, IDEP enclave 302 may be designed in accordance with zero-trust security principles. In particular, DE platform enclave 302 may employ zero-trust principles to ensure that no implicit trust is assumed between any elements, such as digital models, platform agents or individual users (e.g., users 204) or their actions, within the system. That is, no agent may be inherently trusted and the system may always authenticate or authorize for specific jobs. The model is further strengthened through strict access control mechanisms, limiting even the administrative team (e.g., a team of individuals associated with the platform provider) to predetermined, restricted access to enclave resources. To augment this robust security stance, data encryption is applied both at rest and in transit, effectively mitigating risks of unauthorized access and data breaches.

IDEP enclave 302 can also be designed to maintain isolation and independence. A key aspect of the enclave's architecture is its focus on impartiality and isolation. DE enclave 302 disallows cryptographic dependencies from external enclaves and enforces strong isolation policies. The enclave's design also allows for both single-tenant and multi-tenant configurations, further strengthening data and process isolation between customers 306 (e.g., users 204). Additionally, DE enclave 302 is designed with decoupled resource sets, minimizing interdependencies and thereby promoting system efficiency and autonomy.

IDEP enclave 302 can further be designed for scalability and adaptability, aligning well with varying operational requirements. For example, the enclave 302 can incorporate hyperscale-like properties in conjunction with zero-trust principles to enable scalable growth and to handle high-performance workloads effectively.

IDEP enclave 302 can further be designed for workflow adaptability, accommodating varying customer workflows and DE models through strict access control mechanisms. This configurability allows for a modular approach to integrate different functionalities ranging from data ingestion to algorithm execution, without compromising on the zero-trust security posture. Platform 300's adaptability makes it highly versatile for a multitude of use-cases, while ensuring consistent performance and robust security.

IDEP enclave 302 can further be designed to enable analytics for robust platform operations. At the core of the enclave's operational efficiency is a machine learning engine (e.g., machine learning engine 220) capable of performing real-time analytics. This enhances decision-making and operational efficiency across platform 300. Auto-scaling mechanisms can also be included to enable dynamic resource allocation based on workload demand, further adding to the platform's responsiveness and efficiency.

In the exemplary embodiment shown in FIG. 3, IDEP enclave 302 includes several components as described in further detail herein.

A “Monitoring Service Cell. may provide “Monitoring Service” and “Telemetry Service.” A cell may refer to a set of microservices, for example, a set of microservices executing within a kubernetes pod. These components focus on maintaining, tracking and analyzing the performance of platform 300 to ensure good service delivery, including advanced machine learning capabilities for real-time analytics. A “Search Service Cell” provides “Search Service” to aid in the efficient retrieval of information from DE platform 300, adding to its overall functionality. A “Logging Service Cell” and a “Control Plane Service Cell” provides “Logging Service,” “File Service”, and “Job Service” to record and manage operational events and information flow within platform 300, and instrumental in the functioning of platform 300. A “Static Assets Service Cell,” provides “Statics Service”, and may house user interface, SDKs, command line interface (CLI), and documentation for platform 300. An “API Gateway Service Cell” provides “API Gateway Service,” and may provide DE platform API(s) (e.g., APIs 214, 216) and act as a mediator for requests between the client applications (e.g., DE tools 202, the repository of common V&V products 210, etc.) and the platform services. In some embodiments, the API gateway service cell may receive and respond to requests from agents such as DE platform exclave 316 to provide splice functions for model splicing purposes.

As shown in FIG. 3, the architecture of DE platform 300 may also include a cloud services 304 that provide services which cannot interact with customer data but can modify the software for the orchestration of DE platform operations. In example implementations, several cloud resources provide support and foundational services to the platform. For example, in the embodiment of the DE platform 300 shown in FIG. 3, cloud services 304 includes a “Customer Identity and Access Management (IAM) Service” that ensures secure and controlled access to platform 300. Cloud services 304 also includes a “Test Service” that tests tools to validate platform operations. Cloud services 304 may also include an “Orchestration Service” that controls and manages the lifecycle of containers on the platform 300. Cloud services 304 may also include an “Artifact Service” and “Version Control and Build Services,” which may be used to maintain the evolution of projects, codes, and instances in the system, while also managing artifacts produced during the product development process.

As shown in FIG. 3, the architecture of DE platform 300 may also include a customer environment 310 with an “Authoritative Source of Truth” 312, customer tools 314, and an optional DE platform exclave 316. Customer environment 310 is where customer data resides and is processed in a zero-trust manner by DE platform 300. As described previously, DE platform enclave 302, by focusing on both zero-trust principles and hyperscale-like properties, provides a robust and scalable environment for the secure processing of significant workloads, according to the customer's unique needs. In some examples, DE platform exclave 316 may be situated within customer environment 310 in order to assist the customer(s) 306 with their DE tasks and operations, including model splicing and digital threading.

When a customer 306 (e.g., user 204) intends to perform a DE task using DE platform 300 (e.g., IDEP 100), typical operations may include secure data ingestion and controlled data retrieval. Derivative data generated through the DE operations, such as updated digital model files or revisions to digital model parameters, may be stored only within customer environment 310, and DE platform 300 may provide tools to access the metadata of the derivative data. Here metadata refers to data that can be viewed without opening the original data, and may comprise versioning information, time stamps, access control properties, and the like. Example implementations may include secure data ingestion, which utilizes zero-trust principles to ensure customer data is securely uploaded to customer environment 310 through a pre-validated secure tunnel, such as Secure Socket Layer (SSL) tunnel. This can enable direct and secure file transfer to a designated cloud storage, such as a simple storage service (S3) bucket, within customer environment 310. Example implementations may also include controlled data retrieval, in which temporary, pre-authenticated URLs generated via secure token-based mechanisms are used for controlled data access, thereby minimizing the risk of unauthorized interactions. Example implementations may also include immutable derivative data, with transformed data generated through operations like data extraction being securely stored within customer environment 310 while adhering to zero-trust security protocols. Example implementations may also include tokenization utility, in which a specialized DE platform tool referred to as a “tokenizer” is deployed within customer environment 310 for secure management of derivative metadata, conforming to zero-trust guidelines.

Customer environment 310 may interact with other elements of secure DE platform 300 and includes multiple features that handle data storage and secure interactions with platform 300. For example, one element of the customer environment 310 is “Authoritative Source of Truth” 312, which is a principal repository for customer data, ensuring data integrity and accuracy. Nested within this are “Customer Buckets” where data is securely stored with strict access controls, limiting data access to authorized users or processes through pre-authenticated URL links. This setup ensures uncompromising data security within customer environment 310 while providing smooth interactions with other elements of DE platform 300.

Customer environment 310 may also include additional software tools such as customer tools 314 that can be utilized based on specific customer requirements. For example, a “DE Tool Host” component may handle necessary DE applications for working with customer data. It may include a DE Tools Command-Line Interface (DET CLI), enabling user-friendly command-line operation of DE tools (e.g., DE tools 102). A “DE platform Agent” ensures smooth communication and management between customer environment 310 and elements of DE platform 300. Furthermore, there can be another set of optional DE tools designed to assist customer-specific DE workflows. Native DE tools are typically access-restricted by proprietary licenses and end-user license agreements paid for by the customer. IDEP platform functions call upon native DE tools that are executed within customer environment 310, therefore closely adhering to the zero-trust principle of the system design. Exemplary DE tools include, but are not limited to, proprietary and open-source versions of model-based systems engineering (MBSE) tools, augmented reality (AR) tools, computer aided design (CAD) tools, data analytics tools, modeling and simulation (M&S) tools, product lifecycle management (PLM) tools, multi-attribute trade-space tools, simulation engines, requirements model tools, electronics model tools, test-plan model tools, cost-model tools, schedule model tools, supply-chain model tools, manufacturing model tools, cyber security model tools, or mission effects model tools.

In some cases, an optional “IDEP Exclave” 316 may be employed within customer environment 310 to assist with customer DE tasks and operations, supervise data processing, and rigorously adhering to zero-trust principles while delivering hyperscale-like platform performance. IDEP exclave 316 is maintained by the IDEP to run DE tools for customers who need such services. IDEP exclave 316 may contain a “DE Tool Host” that runs DE tools and a “DE Platform Agent” necessary for the operation. Again, native DE tools are typically access-restricted by proprietary licenses and end-user license agreements paid for by the customer. IDEP exclave 316 utilities and manages proprietary DE tools hosted with customer environment 310, for example, to implement model splicing and digital threading functionalities.

In some embodiments, the machine learning (ML) models and artificial intelligence (AI) assistance approaches as described herein adapt to suit different customer instances of the IDEP (see FIG. 4) and the availability of training data. In an example, a pre-trained ML or AI model (e.g. within the IDEP enclave 302) is deployed in instances where there are restrictions around sharing customer data. In another example, AI models are deployed in a federated manner adjacent to DE agents and DE tools in the customer environment (e.g., within IDEP exclave 316). In another example, an AI model deployed inside the customer environment is trained behind its firewalls. In yet another example, the customer may allow sharing of subsets of their metadata for a training database located within the IDEP enclave.

### IDEP Deployment Scenarios

FIG. 4 shows potential scenarios for instantiating an IDEP in connection to a customer's physical system and IT environment, in accordance with some embodiments of the present invention. Specifically, FIG. 4 illustrates various potential configurations for instancing or instantiating an IDEP (“DE platform) 402 in connection to a customer's IT environment and physical system 404. The IT environment may be located on a virtual private cloud (VPC) protected by a firewall. The physical system may refer to a physical twin as discussed with reference to FIG. 1. In some embodiments, IDEP 402 may be instanced as an enclave such as 302 shown in FIG. 3. For example, IDEP 402 may be instanced on the cloud, possibly in a software-as-a-service (SaaS) configuration. The platform instances in these embodiments include software and algorithms, and may be described as follows:
1. External Platform Instance 410: This option showcases the IDEP as a separate platform instance. The platform interacts with the physical system through the customer's virtual environment, or a Customer Virtual Private Cloud (“Customer VPC”), which is connected to the physical system.
2. External Platform Instance 420 with Internal Agent: The IDEP is instantiated as a separate platform, connected to an internal agent (“DE Agent”) wholly instanced within the Customer VPC. For example, the IDEP may be instantiated as enclave 302, and the DE agent may be instantiated as exclave 316 within the Customer VPC linked to the physical system.
3. External Platform Instance with Internal Agent and Edge Computing 430: This scenario displays the IDEP as a separate instantiation, connected to an internal DE Agent wholly instanced within the Customer VPC, which is further linked to an edge instance (“DE Edge Instance”) on the physical system. The DE agent is nested within the customer environment, with a smaller edge computing instance attached to the physical system.
4. Edge Instance Connection 440: This option shows the DE platform linked directly to an DE edge instance on the physical system. The DE platform and the physical system are depicted separately, connected by an edge computing instance in the middle, indicating the flow of data.
5. Direct API Connection 450: This deployment scenario shows the DE platform connecting directly to the physical system via API calls. In this depiction, an arrow extends directly from the platform sphere to the physical system sphere, signifying a direct interaction through API.
6. Air-Gapped Platform Instance 460: This scenario illustrates the IDEP being completely instanced on an air-gapped, or isolated, physical system as a DE agent. The platform operates independently from any networks or Internet connections, providing an additional layer of security by eliminating external access points and potential threats. Interaction with the platform in this context would occur directly on the physical system, with any data exchange outside the physical system being controlled following strict security protocols to maintain the air-gapped environment.

Across these deployment scenarios, the IDEP plays an important role in bridging the gap between a digital twin (DTw) established through the IDEP and its physical counterpart. Regardless of how the IDEP is instantiated, it interacts with the physical system, directly or through the customer's virtual environment. The use of edge computing instances in some scenarios demonstrates the need for localized data processing and the trade-offs between real-time analytics and more precise insights in digital-physical system management. Furthermore, the ability of the platform to connect directly to the physical system through API calls underscores the importance of interoperability in facilitating efficient data exchange between the digital and physical worlds. In all cases, the DE platform operates with robust security measures.

In some embodiments, the IDEP deployment for the same physical system can comprise a combination of the deployment scenarios described above. For example, for the same customer, some physical systems may have direct API connections to the DE platform (scenario 5), while other physical systems may have an edge instance connection (scenario 4).

### Multimodal User Interfaces

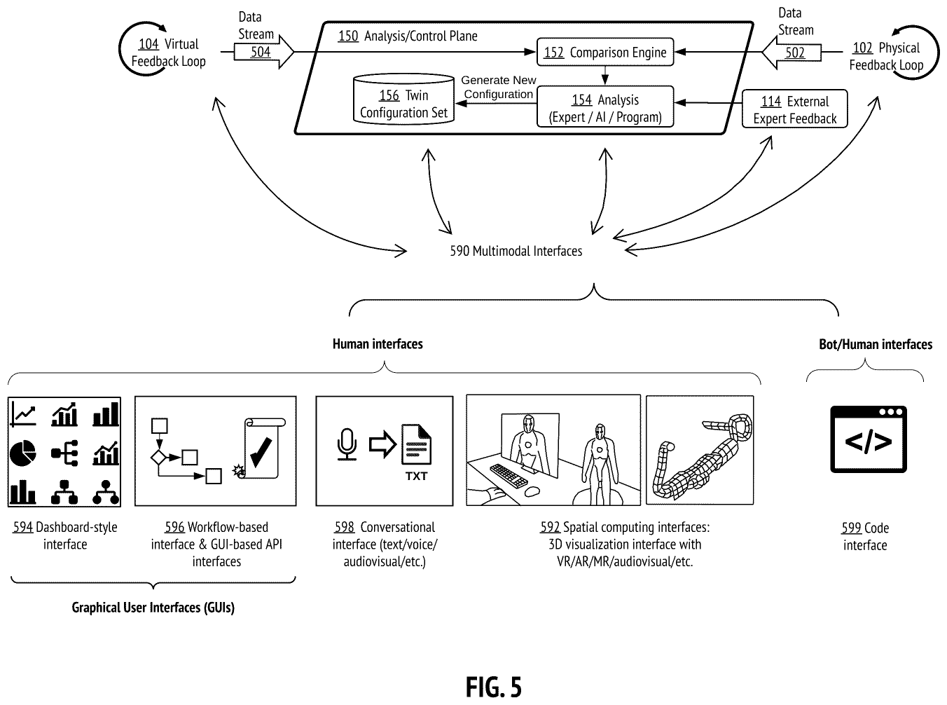

FIG. 5 illustrates the use of multimodal user interfaces 590 for the interconnected DE platform, which can handle various input and output modalities such as Virtual Reality (VR), Mixed Reality (MR), auditory, text, and code. These interfaces are designed to manage the complexity of data streams and decision-making processes, and provide decision support including option visualization, impact prediction, and specific decision invocation. Specifically, data streams 502 and 504 are processed in the Analysis & Control Plane (ACP) 150 of FIG. 1. The user interface may receive data streams from physical and virtual feedback loops 102 and 104, as well as external expert feedback 114, analysis module 154, and twin configuration set 156 of ACP 150.

The multimodal interfaces illustrated in FIG. 5 are configured to carry out all the DE tasks and actions described in the context of FIG. 1, by catering to both humans and bots/algorithms, handling the intricacies of data stream frequency and complexity, decision-making time scales, and latency impacts. In the case of human decision makers, the user interface may need to manage inputs and outputs while for algorithmic decision making, the user interface may need to present rationale and decision analysis to human users. Some examples of human interfaces include a dashboard-style interface 594, a workflow-based interface 596, conversational interfaces 598, spatial computer interfaces 592, and code interfaces 599.

Dashboard-style interface 594 offers a customizable overview of data visualizations, performance metrics, and system status indicators. It enables monitoring of relevant information, sectional review of documents, and decision-making based on dynamic data updates and external feedback. Such an interface may be accessible via web browsers and standalone applications on various devices.

Workflow-based interface 596 guides users through the decision-making process, presenting relevant data, options, and contextual information at each stage. It integrates external feedback and is designed as a progressive web app or a mobile app. In the context of alternative tool selection, workflow-based interface 596 may provide options on individual tools at each stage, or provide combinations of tool selections through various stages to achieve better accuracy or efficiency for the overall workflow.

Conversational interfaces 598 are based on the conversion of various input formats such as text, prompt, voice, audio-visual, etc. into input text, then integrating the resulting input text within the DE platform workflow. Outputs from the DE platform may undergo the reverse process. This enables interoperability with the DE platform, and specifically the manipulation of model splices. In the broad context of audio-visual inputs, the conversational interfaces may comprise data sonification, which involves using sound to represent data, information, or events, and using auditory cues or patterns to communicate important information to users, operators, or reviewers. Sonified alerts (e.g., alerts sent via sound, e.g., via a speaker) are especially useful when individuals need to process information quickly without having to visually focus on a screen. For example, sonified alerts can be used to notify security analysts of potential threats or breaches.

FIG. 5 also illustrates the use of spatial computing interfaces 592 and code interfaces 599 in the management of DTws and PTws. Spatial computing interfaces allow for more immersive and intuitive user experiences, and enable real-time synchronization between DTws and PTws. Code interfaces allow bots and digital engineers to interact with the DE platform through scripting and code. It also allows the collection of user preference, task history, and tool usage patterns for alternative tool selection purposes.

### Digital Threads and Autonomous Data Linkages

As discussed previously, a “digital thread” is intended to connect two or more digital engineering (DE) models for traceability across the systems engineering lifecycle, and collaboration and sharing among individuals performing DE tasks. In a digital thread, appropriate outputs from a preceding digital model may be provided as the inputs to a subsequent digital model, allowing for information and process flow. That is, a digital thread may be viewed as a communication framework or data-driven architecture that connects traditionally siloed elements to enable the flow of information and actions between digital models.

FIG. 6 describes the architecture and inherent complexity of digital threads, in accordance with the examples disclosed herein. Specifically, FIG. 6 is a schematic diagram comparing exemplary digital threads 600 of various complexities that manipulate and/or connect DE models, in accordance with some embodiments of the present invention. In the most basic sense, a digital thread may “thread” together DE models into a simple daisy-chain architecture 602 where modifications in any upstream DE model will affect all DE models downstream from the modified DE model. For example, a modification of any parameter or process of a DE model B will cause changes in DE model C, which in turn will cause changes in DE model D. Cause-and-effect changes will therefore cascade downstream. As another example, diagram 604 represents a more complex digital thread where a change in one DE model may affect more than one downstream model. In both 602 and 604, digital threads are represented by a directed acyclic graph (DAG).

DAGs are frequently used in many kinds of data processing and structuring tasks, such as scheduling tasks, data compression algorithms, and more. In the context of service platforms and network complexities, a DAG might be used to represent the relationships between different components or services within the platform. In digital thread 604, different models may depend on each other in different ways. Model A may affect models B, C, and D, with models B and C affecting model E, and models D and E affecting model G. Such dependencies are denoted as a DAG, where each node is associated with a component (e.g., a model), and each directed edge represents a dependency.

A major issue with dealing with interdependent DE models is that graph consistencies can be polynomial, and potentially exponential, in complexity. Hence, if a node fails (e.g., a model is unreliable), this can have a cascading effect on the rest of the digital thread, disrupting the entire design. Furthermore, adding nodes or dependencies to the graph does not yield a linear increase in complexity because of the interdependencies between models. If a new model is added that affects or depends on several existing models, the resulting increase in graph complexity is multiplicative in nature, hence potentially exponential. The multiplicative nature of digital thread consistencies is compounded by the sheer number of interconnected models, which may number in the hundreds or thousands. Diagram 606 is a partial representation of a real-world digital thread, illustrating the complexity of digital threads and its multiplicative growth.

FIG. 6 further shows special cases 603, 605, 607, 608, and 609 of exemplary simple digital threads. Diagram 607 represents a degenerate digital thread where data is shared from a single DE model. Diagram 608 represents a model-to-document digital thread where data (e.g., system attributes, performance attributes) extracted from a single DE model may be used to generate or update a text-based document (e.g., a Capability Development Document (CDD)). Diagrams 603 and 605 are generalized from 608 to represent cases where data extracted from a single model may be used to update multiple models, or vice versa. Specifically, diagram 605 may represent the dynamic updates of live or magic documents discussed in the context of FIG. 1. Here the logic to connect the DE models shown are very simple: data are extracted from multiple DE models A. B. and C to update a document model D. There are no interactions between the extracted data. Furthermore, diagram 609 shows a special case of a digital thread where data is loaded to and extracted from only a single model A. For example, as discussed in the context of FIG. 7 next, input splice functions of the model A shown in 609 may be executed to update the model, and output splice functions of model A shown in 609 may be executed to produce digital artifacts for sharing. For these special simple threads, the IDEP may provide a GUI-based interface to the user to connect the models and execute the digital threads. For complex threads such as 606, a code-based interface may be necessary.

### Model Splicing for Digital Threading and Digital Twin Generation

As disclosed herein, model splicing encapsulates and compartmentalizes digital engineering (DE) model data and model data manipulation and access functionalities. As such, model splices provide access to selective model data within a DE model file without exposing the entire DE model file, with access control to the encapsulated model data based on user access permissions. Model splicing also provides the DE model with a common, externally-accessible Application Programming Interface (API) for the programmatic execution of DE models. Model splices thus generated may be shared, executed, revised, or further spliced independently of the native DE tool and development platform used to generate the input digital model. The standardization of DE model data and the generalization of API interfaces and functions allow the access of DE model type files outside of their native software environments, and enable the linking of different DE model type files that may not previously be interoperable. Model splicing further enables the scripting and codification of DE operations encompassing disparate DE tools into a corpus of normative program code, facilitating the generation and training of artificial intelligence (AI) and machine learning (ML) models for the purpose of manipulating DE models through various DE tools across different stages of a DE process, DE workflow, or a DE life cycle.

Digital threads are created through user-directed and/or autonomous linking of model splices. A digital thread is intended to connect two or more DE models for traceability across the systems engineering life cycle, and collaboration and sharing among individuals performing DE tasks. In a digital thread, appropriate outputs from a preceding digital model are provided as inputs to a subsequent digital model, allowing for information flow. That is, a digital thread may be viewed as a communication framework or data-driven architecture that connects traditionally siloed elements to enable the flow of information between digital models. The extensibility of model splicing over many different types of DE models and DE tools enables the scaling and generalization of digital threads to represent each and every stage of the DE life cycle.

A digital twin (DTw) is a real-time virtual replica of a physical object or system, with bi-directional information flow between the virtual and physical domains, allowing for monitoring, analysis, and optimization. Model splicing allows for making individual DE model files into executable splices that can be autonomously and securely linked, thus enabling the management of a large number of DE models as a unified digital thread. Such a capability extends to link previously non-interoperable DE models to create digital threads, receive external performance and sensor data streams (e.g., data that is aggregated from DE models or linked from physical sensor data), calibrate digital twins with data streams from physical sensors outside of native DTw environments, and receive expert feedback that provides opportunity to refine simulations and model parameters.

Unlike a DTw, a virtual replica, or simulation, is a mathematical model that imitates real-world behavior to predict outcomes and test strategies. Digital twins use real-time data and have bidirectional communication, while simulations focus on analyzing scenarios and predicting results. In other words, a DTw reflects the state of a physical system in time and space. A simulation is a set of operations done on digital models that reflects the potential future states or outcomes that the digital models can progress to in the future. A simulation model is a DE model within the context of the IDEP as disclosed herein.

When testing different designs, such as variations in wing length or chord dimensions, multiple DTws (sometimes numbering in 100s to 1,000s) may be created, as a bridge between design specifications and real-world implementations of a system, allowing for seamless updates and tracking of variations through vast numbers of variables, as detailed in the context of FIG. 1. As an example, if three variations of a system are made, each one would have its own DTw with specific measurements. These DTws may be accessed and updated via API function scripts, which allow for easy input of new measurements from the physical parts during the manufacturing process. By autonomous linking with appropriate data, a DTw may be updated to reflect the actual measurements of the parts, maintaining traceability and ensuring accurate data representation through hundreds or thousands of models.

### Exemplary Model Splicing Setup

FIG. 7 is a schematic showing an exemplary model splicing setup, according to some embodiments of the present invention. Specifically, FIG. 7 is a schematic showing an embedded CAD model splicing example.

In the present disclosure, a “model splice”, “model wrapper”, or “model graft” of a given DE model file comprises locators to or copies of (1) DE model data or digital artifacts extracted or derived from the DE model file, including model metadata, and (2) splice functions (e.g., API function scripts) that can be applied to the DE model data. A model splice may take on the form of a digital file or a group of digital files. A locator refers to links, addresses, pointers, indexes, access keys, Uniform Resource Locators (URL) or similar references to the aforementioned DE digital artifacts and splice functions, which themselves may be stored in access-controlled databases, cloud-based storage buckets, or other types of secure storage environments. The splice functions provide unified and standardized input and output API or SDK endpoints for accessing and manipulating the DE model data. The DE model data are model-type-specific, and a model splice is associated with model-type-specific input and output schemas. One or more different model splices may be generated from the same input DE model file, based on the particular user application under consideration, and depending on data access restrictions. In some contexts, the shorter terms “splice”, “wrapper”, and/or “graft” are used to refer to spliced, wrapped, and/or grafted models.

Model splicing is the process of generating a model splice from a DE model file. Correspondingly, model splicers are program codes or uncompiled scripts that perform model splicing of DE models. A DE model splicer for a given DE model type, when applied to a specific DE model file of the DE model type, retrieves, extracts, and/or derives DE model data associated with the DE model file, generates and/or encapsulates splice functions, and instantiates API or SDK endpoints to the DE model according to input/output schemas. In some embodiments, a model splicer comprises a collection of API function scripts that can be used as templates to generate DE model splices. “Model splicer generation” refers to the process of setting up a model splicer, including establishing an all-encompassing framework or template, from which individual model splices may be deduced.

Thus, a DE model type-specific model splicer extracts or derives model data from a DE model file and/or stores such model data in a model type-specific data structure. A DE model splicer further generates or enumerates splice functions that may call upon native DE tools and API functions for application on DE model data. A DE model splice for a given user application contains or wraps DE model data and splice functions that are specific to the user application, allowing only access to and enabling modifications of limited portions of the original DE model file for collaboration and sharing with stakeholders of the given user application.

Additionally, a document splicer is a particular type of DE model splicer, specific to document models. A “document” is an electronic file that provides information as an official record. Documents include human-readable data that can be read by humans with or without specialized software such as word processors and/or web services. Thus, a document is a special case of DE models, and may contain natural language-based text and/or graphics that are directly readable by a human without the need of additional machine compilation, rendering, visualization, or interpretation by a dedicated DE tool. A “document splice”, “document model splice” or “document wrapper” for a given user application can be generated by wrapping document data and splice functions (e.g., API function scripts) that are specific to the user application, thus revealing text at the component or part (e.g., title, table of contents, chapter, section, paragraph) level via API or SDK endpoints, and allowing access to and enabling modifications of portions of an original document or document template for collaboration and sharing with stakeholders of the given user application, while minimizing manual referencing and human errors.

In the CAD model splicing example shown in FIG. 7, a CAD model file diesel-engine.prt 704 proceeds through a model splicing process 710 that comprises a data extraction step 720 and a splice function generation step 730. This input DE model 704 is in a file format .prt native to certain DE tools. Data extraction may be performed via a DE model crawling agent implemented as model crawling scripts within a model splicer to crawl through the input DE model file and to distill model data with metadata 722. Metadata are data that can be viewed without opening the entire input DE model file, and may include entries such as file name, file size, file version, last modified date and time, and potential user input options as identified from a user input 706. Model data are extracted and/or derived from the input DE model, and may include but are not limited to, parts (e.g., propeller, engine cylinder, engine cap, engine radiator, etc.), solids, surfaces, polygon representation, and materials, etc. When a model splicer crawls through the model file, it determines how model data may be organized and accessed, as fundamentally defined by a DE tool 702 that is being used in splicing the DE model, and establishes a model data schema. This data schema describes the structure and format of the model data, some of which are translated into, or used to create input/output API endpoints with corresponding input/output schemas. In some embodiments, model data with metadata 722 may be stored in an access-restricted storage 726, such as the “customer buckets” 312 within customer environment 310 in FIG. 3, so that model splices such as 742, 744, and 746 may be generated on-demand once an input DE model 704 has been crawled through.

The model splicer further generates splice functions (e.g., API function scripts) 732 from native APIs 702 associated with the input CAD model. In the present disclosure, “native” and “primal” refer to existing DE model files, functions, and API libraries associated with specific third-party DE tools, including both proprietary and open-source ones. Native API 702 may be provided by a proprietary or open-source DE tool. For example, the model splicer may generate API function scripts that call upon native APIs of native DE tools to perform functions such as: HideParts(parts_list), Generate2DView( ), etc. These model-type-specific splice functions may be stored in a splice function database 736, again for on-demand generation of individual model splices. A catalog or specification of splice functions provided by different model splices supported by the IDEP, and orchestration scripts that link multiple model splices, constitutes a Platform API. This platform API is a common, universal, and externally-accessible platform interface that masks native API 702 of any native DE tool integrated into the IDEP, thus enabling engineers from different disciplines to interact with unfamiliar DE tools, and previously non-interoperable DE tools to interoperate freely.

Next, based on user input or desired user application 706, one or more model splices or wrappers 742, 744, and 746 may be generated, wrapping a subset or all of the model data needed for the user application with splice functions or API function scripts that can be applied to the original input model and/or wrapped model data to perform desired operations and complete user-requested tasks. In various embodiments, a model splice may take on the form of a digital file or a group of digital files, and a model splice may comprise locators to or copies of the aforementioned DE digital artifacts and splice functions, in any combination or permutation. Any number of model splices/wrappers may be generated by combining a selective portion of the model data such as 722 and the API function scripts such as 732. As the API function scripts provide unified and standardized input and output API endpoints for accessing and manipulating the DE model and DE model data, such API handles or endpoints may be used to execute the model splice and establish links with other model splices without directly calling upon native APIs. Such API endpoints may be formatted according to an input/output scheme tailored to the DE model file and/or DE tool being used, and may be accessed by orchestration scripts or platform applications that act on multiple DE models.

In some embodiments, when executed, an API function script inputs into or outputs from a DE model or DE model splice. “Input” splice functions or “input nodes” such as 733 are model modification scripts that allow updates or modifications to an input DE model. For example, a model update may comprise changes made via an input splice function to model parameters or configurations. “Output” splice functions or “output nodes” 734 are data/artifact extraction scripts that allow data extraction or derivation from a DE model via its model splice. An API function script may invoke native API function calls of native DE tools. An artifact is an execution result from an output API function script within a model splice. Multiple artifacts may be generated from a single DE model or DE model splice. Artifacts may be stored in access-restricted cloud storage 726, or other similar access-restricted customer buckets.

One advantage of model splicing is its inherent minimal privileged access control capabilities for zero-trust implementations of the IDEP as disclosed herein. In various deployment scenarios discussed with reference to FIG. 4, and within the context of IDEP implementation architecture discussed with reference to FIG. 3, original DE input model 704 and model data storage 726 may be located within customer buckets 312 in customer environment 310 of FIG. 3. Splice functions 732 stored in database 736 call upon native APIs 702. The execution or invocation of splice functions 732 may rely on job-specific authentication or authorization via proprietary licenses of DE tools (e.g., residing within customer environment 310 of FIG. 3 and/or information security clearance levels of the requesting user. Thus, model splicing unbundles monolithic access to digital model-type files as whole files and instead provides specific access to a subset of functions that allow limited, purposeful, and auditable interactions with subsets of the model-type files built from component parts or atomic units that assemble to parts.

### Digital Threading of DE Models Via Model Splicing

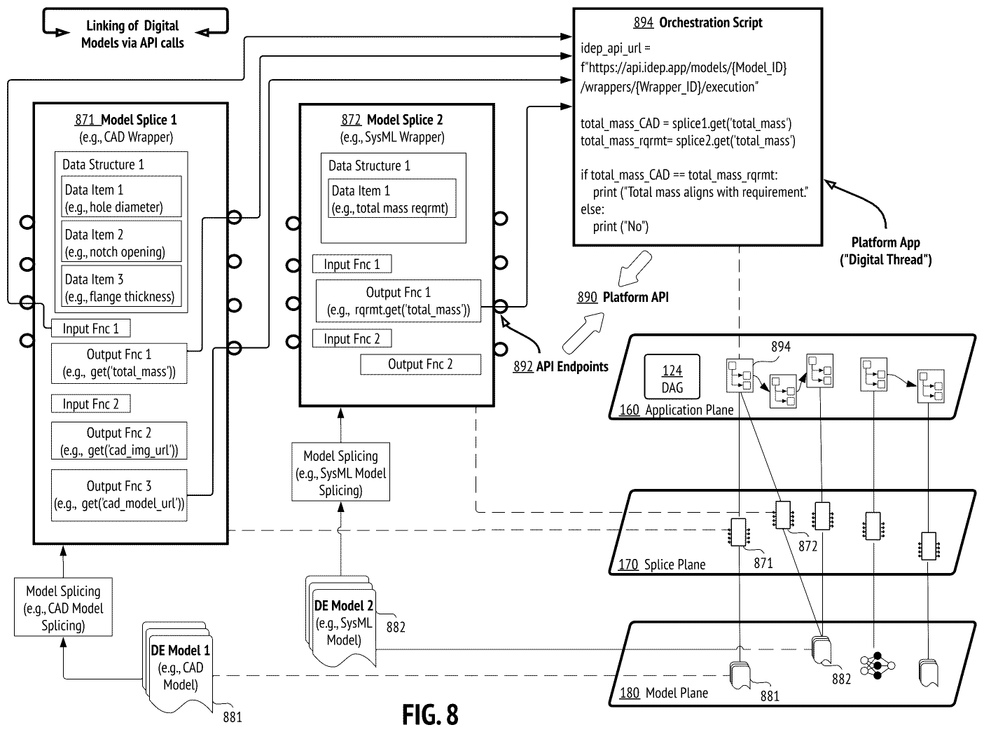

FIG. 8 is a schematic showing digital threading of DE models via model splicing, according to some embodiments of the present invention. A digital thread is intended to connect two or more DE models for traceability across the systems engineering lifecycle, and collaboration and sharing among individuals performing DE tasks.

Linking of model splices generally refers to jointly accessing two or more DE model splices via API endpoints or splice functions. For example, data may be retrieved from one splice to update another splice (e.g., an input splice function of a first model splice calls upon an output splice function of a second model splice); data may be retrieved from both splices to generate a new output (e.g., output splice functions from both model splices are called upon); data from a third splice may be used to update both a first splice and a second splice (e.g., input splice functions from both model splices are called upon). In the present disclosure, “model linking” and “model splice linking” may be used interchangeably, as linked model splices map to correspondingly linked DE models. Similarly, linking of DE tools generally refers to jointly accessing two or more DE tools via model splices, where model splice functions that encapsulate disparate DE tool functions may interoperate and call each other, or be called upon jointly by an orchestration script to perform a DE task.

Thus, model splicing allows for making individual digital model files into model splices that can be autonomously and securely linked, enabling the management of a large number of digital models as a unified digital thread written in scripts. Within the IDEP as disclosed herein, a digital thread is a platform script that calls upon the platform API to facilitate, manage, or orchestrate a workflow through linked model splices. Model splice linking provides a communication framework or data-driven architecture that connects traditionally siloed elements to enable the flow of information between digital models via corresponding model splices. The extensibility of model splicing over many different types of digital models enables the scaling and generalization of digital threads to represent each and every stage of the DE lifecycle and to instantiate and update DTws as needed.

In the particular example shown in FIG. 8, an orchestration script 894 is written in Python code and designed to interact via API endpoints such as 892 to determine if a CAD model meets a total mass requirement. API endpoint 892 is an output splice function and part of a platform API 890. Platform API 890 comprises not only splice functions but also platform scripts or orchestration scripts such as 894 itself.

Orchestration script 894 is divided into three main steps:
1. Get Data From a CAD Model Splice: A POST request may be sent via the IDEP platform API to execute a computer-aided design (CAD) model splice 871. This model splice provides a uniform interface to modify and retrieve information about a CAD model 881. The parameters for the CAD model, such as hole diameter, notch opening, flange thickness, etc., may be sent in the request and set via an input splice function. The total mass of the CAD model may be derived from model parameters and retrieved via an output splice function. The response from the platform API includes the total mass of CAD model 881, and a Uniform Resource Identifier/Locator (URL) for the CAD model. The response may further comprise a URL for an image of the CAD model.
2. Get Data From a SysML Model Splice: Another POST request may be sent via the IDEP platform API to execute a Systems Modeling Language (SysML) model splice 872. SysML is a general-purpose modeling language used for systems engineering. Output function 892 of model splice 872 retrieves the total mass requirements for the system from a SysML model 882. The response from the platform API includes the total mass requirement for the system.
3. Align the Variables and Check If Requirement Met: The total mass from CAD model 881 is compared with the total mass requirement from SysML model 882. If the two values are equal, a message is printed indicating that the CAD model aligns with the requirement. Otherwise, a message is printed indicating that the CAD model does not align with the requirement.

In short, orchestration script 894, which may be implemented in application plane 160 of IDEP 100 shown in FIG. 1, links digital models 881 and 882 via model splice API calls. Orchestration script 894 is a scripted platform application that modifies a CAD model, retrieves the total mass of the modified CAD model, retrieves the total mass requirement from a SysML model, and compares the two values to check if the CAD model meets the requirement. In some embodiments, a platform application within IDEP 100 utilizes sets of functions to act upon more than one DE model.

### Model Splice Plane

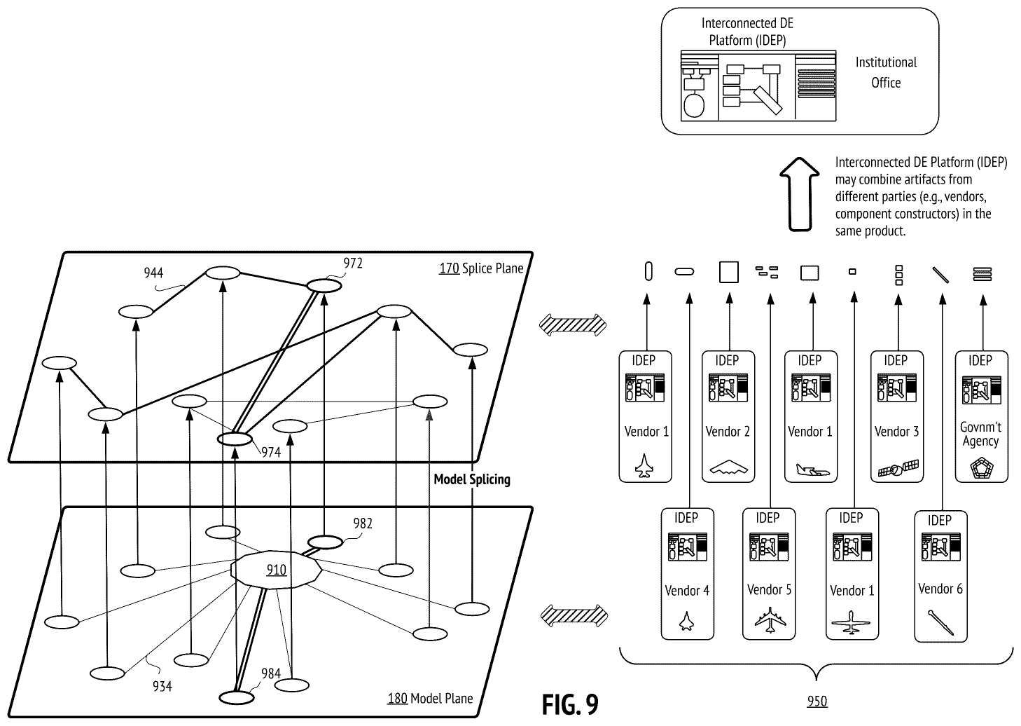

FIG. 9 is a schematic illustrating the linking of DE model splices in a splice plane and comparing digital threading with and without model splicing, according to some embodiments of the present invention. The bottom model plane 180 demonstrates current digital threading practices, where each small oval represents a DE model, and the linking between any two DE models, such as models 982 and 984, requires respective connections to a central platform 910, and potential additional linkages from every model to every other model. The central platform 910 comprises program code that is able to interpret and manipulate original DE models of distinct model types. For example, platform 910 under the control of a subject matter expert may prepare data from digital model 982 into formats that can be accessed by digital model 984 via digital model 984's native APIs, thus allowing modifications of digital model 982 to be propagated to digital model 984. Any feedback from digital model 984 to digital model 982 would require similar processing via platform 910 so that data from digital model 984 are converted into formats that can be accessed by digital model 982 via digital model 982's native APIs. This hub-and-spoke architecture 934 is not scalable to the sheer number (e.g., hundreds or thousands) of digital models involved within typical large-scale DE projects, as model updates and feedback are only possible through central platform 910.

In contrast, once the DE models are spliced, each original model is represented by a model splice comprising relevant model data, unified and standardized API endpoints for input/output, as shown in the upper splice plane 170. Splices within splice plane 170 may be connected through scripts (e.g., python scripts) that call upon API endpoints or API function scripts and may follow a DAG architecture, as described with reference to FIG. 1 and FIG. 6. Note that in FIG. 1, only the set of generated splices are shown within splice plane 170, while in FIG. 9, scripts that link model splices are also shown for illustrative purposes within the splice plane. Such scripts are referred to as orchestration scripts or platform scripts in this disclosure, as they orchestrate workflow through a digital thread built upon interconnected DE model splices. Further note that while splice plane 170 is shown in FIG. 1 as part of IDEP 100 for illustrative purposes, in some embodiments, splice plane 170 may be implemented behind a customer firewall and be part of an agent of the DE platform, as discussed in various deployment scenarios shown in FIG. 4. That is, individual API function scripts generated via model splicing by a DE platform agent may be tailored to call upon proprietary tools the customer has access to in its private environment. No centralized platform 910 with proprietary access to all native tools associated with all individual digital models shown in FIG. 9 is needed. Instead, orchestration scripts call upon universal API function scripts that may be implemented differently in different customer environments.

Hence, model splicing allows model splices such as model splice 972 from digital model 982 and model splice 974 from digital model 984 to access each other's data purposefully and directly, thus enabling the creation of a model-based “digital mesh” 944 via platform scripts and allowing autonomous linking without input from subject matter experts.

An added advantage of moving from the model plane 180 to the splice plane 170 is that the DE platform enables the creation of multiple splices per native model (e.g., see FIG. 7), each with different subsets of model data and API endpoints tailored to the splice's targeted use. For example, model splices may be used to generate multiple digital twins (DTws) that map a physical product or object design into the virtual space. Two-way data exchanges between a physical object and its digital object twin enable the testing, optimization, verification, and validation of the physical object in the virtual world, by choosing optimal digital model configuration and/or architecture combinations from parallel digital twins built upon model splices, each reacting potentially differently to the same feedback from the physical object.

Supported by model splicing, digital threading, and digital twining capabilities, the IDEP as disclosed herein connects DE models and DE tools to enable simple and secure collaboration on digital engineering data across engineering disciplines, tool vendors, networks, and model sources such as government agencies and institutions, special program offices, contractors, small businesses, Federally Funded Research and Development Centers (FFRDC), University Affiliated Research Centers (UARC), and the like. An application example 950 for the IDEP is shown on the right side of FIG. 9, illustrating how data from many different organizations may be integrated to enable cross-domain collaboration while maintaining data security, traceability, and auditability. Here DE models from multiple vendors or component constructors are spliced or wrapped by IDEP agents, and data artifacts are extracted with data protection. Turning DE models into data artifacts enables cross-domain data transfer and allows for the protection of critical information, so that model owners retain complete control over their DE models using their existing security and IT stack, continue to use DE tools that best fit their purposes, and also preserve the same modeling schema/ontology/profile that best fit their purposes. The IDEP turns DE models into micro-services to provide minimally privileged data bits that traverse to relevant stakeholders without the DE models ever leaving their home servers or being duplicated or surrogate. The IDEP also provides simple data access and digital threading options via secure web applications or secure APIs.

### DAG Representation of Threaded Tasks

Model splicing provides a unified interface among DE models, allowing model and system updates to be represented by interconnected and pipelined DE tasks. FIG. 10 shows an exemplary directed acyclic graph (DAG) representation 1000 of pipelined DE tasks related to digital threads, in accordance with some embodiments of the present invention. In diagram 1000, tasks performed through a digital thread orchestration script (e.g., 894) are structured as nodes within a DAG. Actions are therefore interconnected and carried out in a pipeline linking the DE model splices with a range of corresponding parameter values. Therefore, a digital thread can be created by establishing, via interpretable DE platform scripts, the right connections between any model splices for their corresponding models at the relevant endpoints.

Referring to FIGS. 1 and 8, DAGs of threaded tasks are built from digital threads and are part of the DE platform's application plane 160. Different DAGs may target different DE actions. For example, in FIG. 1, building or updating a DTw 122 in the virtual environment 120 has its own DAG 124. Model splicing turns DE models into data structures that can be accessed via API, thus enabling the use of software development tools, from simple python scripts to complex DAGs, in order to execute DE actions. A digital thread of model splices eliminates the scalability issue of digital thread management, and speeds up the digital design process, including design updates based on external feedback.

Following the above description of the basic elements and core aspects of the IDEP as disclosed herein, the documentation system that enhances the IDEP's functionality with respect to document splicing and live document generation and update is described in detail next.

### Overview of DE Document Splicing and Live Document Generation and Update

The interconnected digital engineering platform (IDEP) as discussed within the context of FIG. 1 is a computer-based system that may be used to support a variety of DE product lifecycle activities from concept through disposal in a zero-trust setup. The DE model splicing and document splicing systems and methodologies are provided by the IDEP to integrate previously siloed DE tools, DE models, related digital artifacts, and DE documents from different disciplines and different organizations into secure, sharable DE model splices, document splices, software-defined digital threads, and digital twins, all in a zero-trust setup. By enabling the right stakeholders to access the right information from the right source with the right tools at the right time in the right context for the right purpose and all accompanied and streamlined by the right documentations, DE model splicing and document splicing facilitate the accurate, secure, auditable, traceable, iterative, and effective development and review of components and/or systems, from design to testing, validation, verification, certification, production, operation, and management.

While DE documents and DE models are used as examples of documents and data sources in the present disclosure, other types of documents and data sources are considered as within the scope of the invention and can be used analogously. For example, digital models from healthcare, medicine, sports, finance, business, and many other fields may be model spliced to provide data updates in documents such as medical records, treatment plans, clinical notes, pharmaceutical manufacturing documentation, personalized sports training plans, patent applications, financial reports, business plans and contracts, compliance documents, and the like. In another example, regulations and standard documents may be spliced and function as data sources to provide updated information for DE documentation during product validation and verification.

As discussed within the context of FIG. 7, a “model splicer” in the present disclosure refers to program code or uncompiled scripts that perform model splicing of DE models. A DE model splicer for a given DE model type, when applied to a specific DE model file of the DE model type, retrieves, extracts, or derives DE model data, digital artifacts, and associated metadata, generates and/or encapsulates splice functions (e.g., in the form of API function scripts) that can be applied to the model data or digital artifacts, and instantiates API endpoints according to input/output schemas. A DE model is a computer-generated digital model that represents characteristics or behaviors of a complex product or system, and may be created or modified using a DE tool. A DE model within the IDEP as disclosed herein refers to any digital file uploaded onto the platform, including DE documents that are appropriately interpreted. Thus, the DE model splicing and DE model linking processes discussed with reference to FIGS. 7 and 8 are generalizable and extensible to model splicing human-readable documents, or “document splicing”, where a human-readable document is disassembled or parsed into subunits with API or SDK endpoints or handles, allowing granular access and modifications of selective portions of the original document file, for collaborations and sharing with specific stakeholders as desired.

More specifically, a document splice of a given document file comprises locators to or copies of document subunits or components, each addressable via an API or SDK endpoint. For example, a subunit may be a title, a table of contents, an index, a chapter, a subsection, a paragraph, a sentence, a word, a sheet, a page, a table, a chart, a graph, an image, a hypertext link, sub-parts thereof, and the like. In some embodiments, document artifacts are extracted or derived from the input document file or parsed document subunits. An example of a document artifact is a table that summarizes key numeric parameters from a textual report document written in natural language. Another example of a document artifact is a document subunit (e.g., a title, a paragraph) retrieved directly from the document using a read-type splice function. Each document artifact may be associated with respective metadata, for example, context, order, or location information within the document (e.g., a paragraph number, a section number within a section order hierarchy), information security level (e.g., public, confidential, proprietary, etc.), inherent characteristics (e.g., number of rows and columns in a table, data type and size), and the like. Furthermore, document artifacts may include document metadata such as versioning information, ownership, information security level, and digital thread execution data.

For document subunits, their API or SDK endpoints may comprise unique, externally accessible subunit IDs or addresses. Alternatively, such API or SDK endpoints may be provided via document splice functions. Other document artifacts derived using document splice functions (e.g., API function scripts) from the document subunits or other document artifacts may be accessible via API or SDK endpoints provided via document splice functions as well. Such document splice functions may be encapsulated in a document splice, and invoked through digital threads that link DE models and DE documents.

A document splice may take on the form of a digital file or a group of digital files. For example, a document splice may include a text file and a separate image file. In some embodiments, a document splice may comprise links to or locators/addresses (e.g., pointers, indexes, Uniform Resource Locator (URL), etc.) of the aforementioned document subunits, artifacts and splice functions, which themselves may be stored in access-controlled databases, cloud-based storage buckets, or other types of secure storage environments. The aforementioned API/SDK endpoints provide a unified programming interface to document splices generated from documents of different native formats, and are externally and commonly-accessible by third-party applications and users via code interfaces or graphical user interface (GUIs). This unified programming interface enables universal accessibility to and effective engagement with document data by relevant stakeholders, regardless of their technical background or their knowledge of document processing or software programming.

Linking of spliced DE models and DE documents may be achieved by software-code-defined digital threads, which are scripts in the context of the IDEP platform, connecting data from one or more DE models, data sources, physical artifacts and/or documentations to accomplish a specific mission or business objective. A digital thread script calls upon the platform API comprising DE model API and DE document API, to facilitate, manage, or orchestrate information exchange and aggregation among linked model splices and document splices, thus enabling the generation and dynamic update of live documents or “magic documents” that reflect the current state of DE model information with minimal manual intervention. Metadata associated with the execution of digital thread scripts are recorded with the live document to ensure the auditability and traceability of any live document generation and update actions, thus providing data accessibility, understandability, and trustworthiness while mitigating any security and privacy risks. In some embodiments, changes implemented to a linked DE model (e.g., as part of a digital twin) may appear instantaneously within the relevant data fields and sections of the live DE document; in some embodiments, a predefined delay may be configured or tolerated between the modification of a DE model and the execution of the corresponding changes within a live DE document. In yet some embodiments, instead of DE model changes being “pushed” to the live document, the digital thread may periodically “pull” linked DE models for changes and modifications.

As disclosed herein, one feature of document splicing for live document generation and update is data access control and tracking, specifically the unbundling of monolithic access to DE documents as whole files, and instead providing specific access to subsets of document subunits that allow limited, purposeful, and auditable interactions with subsets of document artifacts. The view or content of a spliced document may be customized according to user preferences or subunit access privileges to suit the user's specific needs or requirements. Selective access and modification of certain document artifacts and digital artifacts within a larger live document allow for secure and collaborative engineering workflows without the need to expose sensitive or confidential technical information. The ability to track when, what, and how changes were made by digital thread execution via execution metadata further adds a layer of accountability and traceability, and can be invaluable for compliance and auditing purposes.

Furthermore, in the context of accessibility and collaborative workflows, it is clear that enhancing the shareability of DE documents and related data sources through Internet technologies could lead to a quantum leap in collaboration capabilities among industrial companies and government agencies. Nonetheless, simplistic approaches of document sharing via conventional methods, such as cloud-based word processing, on-demand cloud computing and storage services, email, instant messaging, and government data transfer services all fall short of the stringent security and auditability requirements for high-sensitivity industries such as aerospace and defense. By compartmentalizing and encapsulating document data and splice functions while tracking data sources and function executions with metadata, document splicing and model splicing transcend traditional web-based and API-based approaches to adequately address the core requirements of zero-trust principles, audit trails, and traceability of data access and modifications, thereby ensuring compliance with the strictest of security protocols.

In other words, the document splicing and live document generation and update system is designed to meet the complex demands of DE documentation and sharing, ensuring secure, selective, and zero-trust shareability of DE documents among a wide range of individuals and organizations, while incorporating rigorous auditability and traceability to adhere to industry standards and government regulations. The challenges in DE model sharing, integration, and collaboration, are recognizable. DE documents, in a similar fashion, also require a common, understandable framework to ensure that all stakeholders, regardless of their role and technical background, can effectively engage with authoritative and trustworthy information in an efficient manner.

A second feature of document splicing and live document generation and update is that dynamic document updates ensure document content is current and reliable, thus reducing the risk of decisions being made based on outdated or inaccurate information. This dynamic document update process eliminates or minimizes the manual effort typically associated with revising static DE documents, saving time, improving efficiency, and reducing the potential for human error during DE model data retrieval, data transcription, and document revision. Being able to dynamically capture changes in the underlying data sources is especially important as the volume of data or the number of linked DE models grows, and as the number of stakeholders or collaborators increases. Hence, model splicing, document splicing, and digital threading enable efficient scaling of the DE documentation preparation, revision, review, and approval processes to meet increased demands without compromising accuracy or functionality.

A third feature of document splicing and live document update is that versatile linking of document splices with DE model splices via software-defined digital threads supports the core capabilities and functionalities of the IDEP, and seamlessly integrates document-centric systems engineering practices into the realm of model-based digital engineering. For example, a digital thread may propagate requirements from document splices and/or design changes from individual model splices throughout a complex engineering system, enabling seamless and accountable collaboration among individuals participating in activities across DE phases, including but not limited to, stakeholder analysis, concept studies, requirements definition, preliminary design and technology review, system modeling, verification and validation, regulatory compliance, and certification.

A fourth feature of document splicing and live document update is the facilitation of software tool interoperability. By encapsulating the functions of various document processing or editing tools within document splice functions and providing a standardized, platform-wide document API, the complexity for stakeholders to engage deeply with multiple native DE tools and document processing tools is substantially reduced. Document splicing further enables the linking or joint access of native software tools that are not directly interoperable, allowing for the seamless invocation of document splice functions that encapsulate distinct tool functions to collaboratively execute a desired task, and to provide interactive feedback and comments.

Yet another feature of document splicing and live document update is its ability to provide core training data for AI-assisted capabilities such as digital threading and autonomous data linkages in DE systems. This integration of AI assistance, especially via Large Language Model (LLMs), expedites the process to describe or summarize DE models into texts that are easy to read and understand, improves the referencing process, and allows single-click generation of model documentation for complex systems and subsystems. In various embodiments, the ML and AI engines or modules thus disclosed may be trained and/or fine-tuned on datasets of user inputs and exemplary document templates, document splices, model splices, and digital threads. Fine-tuning may be further customized with enterprise documents and data when appropriate, to capture specific language and document dependencies within client databases.

In short, DE model splicing and document splicing encapsulate, containerize, and compartmentalize digital model and document data and functions to achieve data confidentiality and accessibility, while digital threading among model splices and document splices with generalized API interfaces allow scalability and generalizability from disparate models and complex documentations to a cohesive digital continuum throughout the system development life cycle.

### Exemplary Document Splicing and Live Document Generation/Update Process

In what follows, embodiments of the document splicing process, exemplary document splicer implementations, and live document generation and update via digital thread execution are discussed in further detail within the context of the IDEP.

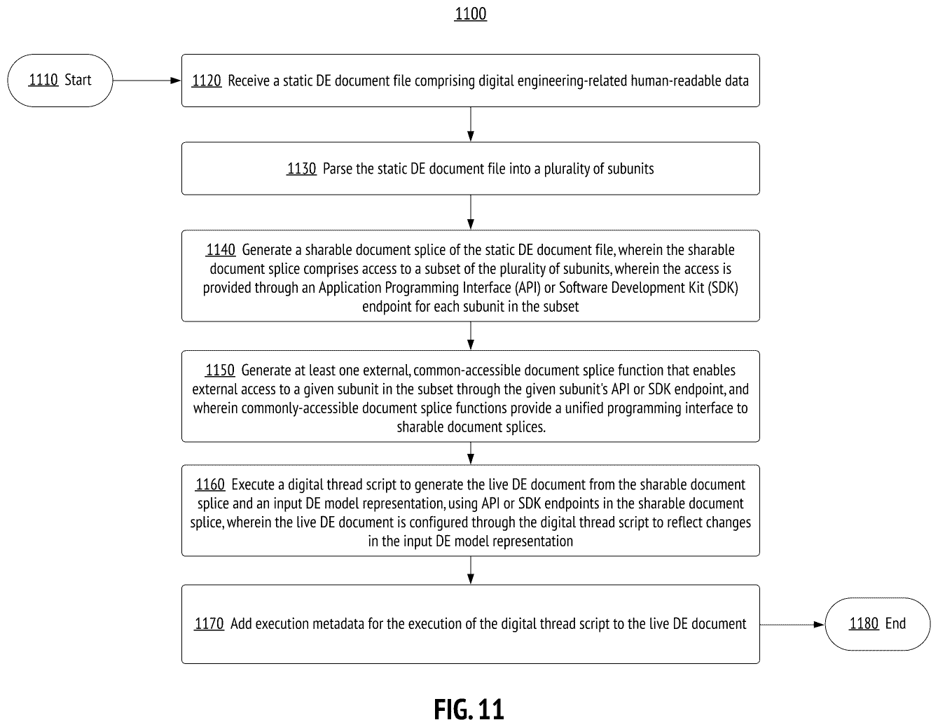

FIG. 11 shows a flowchart for an exemplary process for generating a DE document splice and a live DE document from the DE document splice, in accordance with some embodiments of the present invention. In this illustrative example, upon initialization at a step 1110, a static DE document file may be received at a step 1120, the static DE document file comprising digital engineering-related human-readable data. This input document acquisition process may be a file upload, a database retrieval, through an API call, or in other appropriate forms.

A DE document file is a document file with DE data, for example, requirements definition, capability design and development review, project management, program management, operation and training manuals, and/or engineering data. A DE document file may be in a text or binary file format. A DE document file may also be in a native format that is created, used, and maintained by a specific software application that has originated the DE document. This native format is designed to store all the information that the software application can handle, for example, typesetting, formatting, and layout information, file metadata and comments, and other parameters or configurations that are specific to the software's capabilities. For instance, MICROSOFT WORD uses proprietary binary file format .doc that is optimized but is not always fully supported by other word processors without some form of conversion or data exchange process. Other possible DE document file formats include, but are not limited to .docx, .ppt, plain text encodings, .txt, .html, .pages, .odt, .xml, .xmi, .md, .mdzip, .json, .dbk, .epub, .gdoc, .ps, .pdf, .rtf, .svg, .tex, and the like.

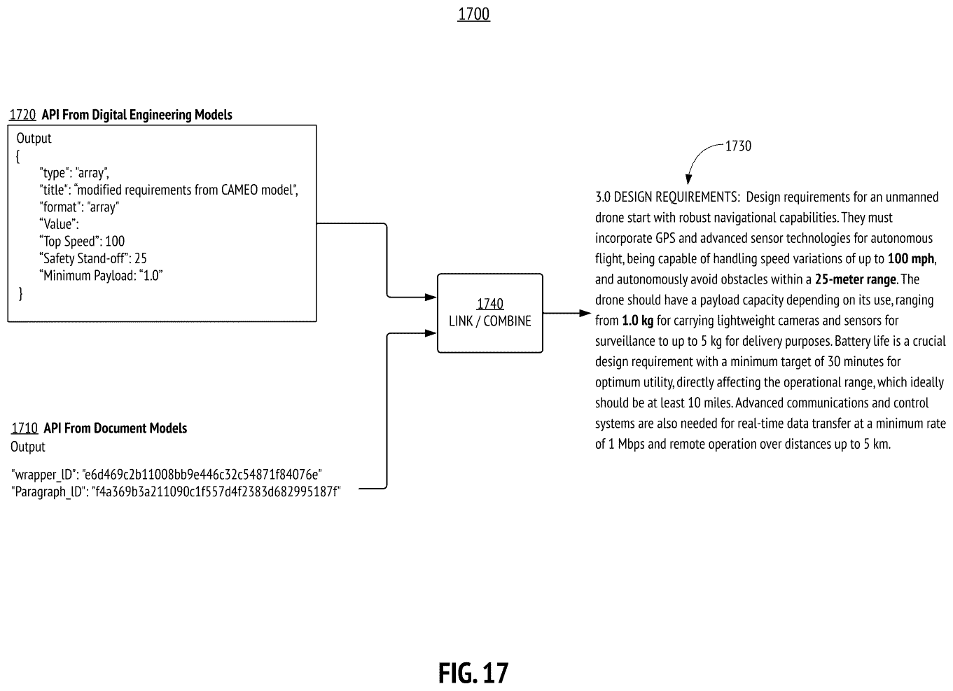

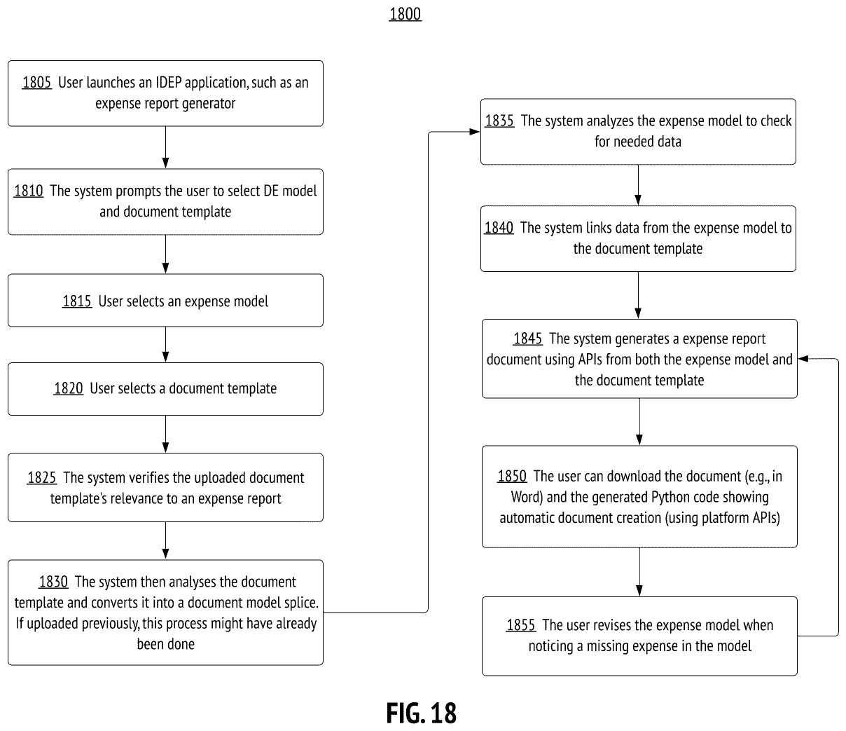

Some exemplary legacy DE documents used during the DE process include, but are not limited to, Analysis of Alternatives, Trade Studies, Concept of Operations (CONOPS), Initial Capabilities Document (ICD), Capabilities Development Document, System Design Document (SDD), Interface Control Document (ICD), Risk Assessment and Management Plan, Reliability, Availability, and Maintainability-Cost (RAM-C) Rationale Report, Test and Evaluation Master Plan, Lifecycle Sustainment Plan (LCSP), Integrated Master Plan (IMP), Integrated Master Schedule (IMS), Information Support Plan (ISP), Program Protection Plan (PPP), Capability Production Document (CPD), Cost Estimates (e.g., CARD). As discussed in the context of FIGS. 17 and 18, exemplary DE models needed for establishing such legacy DE documents include, but are not limited to, low-fidelity analytic models, trade-space models (e.g., MATLAB), requirements, operational models, architecture models, functional architecture models, system architecture models (e.g., CAMEO), Gantt chart models (e.g., MS Project), cost models (e.g., EXCEL), high-fidelity physics models (e.g., computational fluid dynamics (CFD), finite element analysis (FEA)), electromagnetic frequency models (e.g., high frequency simulation software (HFSS)), electronic system models, mission effects models, preliminary CAD models, manufacturing models, product lifecycle manager, and the like.

More specifically, a document is an electronic file that provides information as an official record. Documents include human-readable files that are freeform and can be naturally read by humans, for example in text editing or processing formats (e.g., .txt, .rtf, .doc, .docx, .ppt, .xlsl), portable document formats (e.g., .ps, .pdf), or in graphics formats (e.g., .jpg, .bmp, .png). Documents may also contain data structures and codifications that make them both human-readable and machine-readable. Some examples of human-readable and machine-readable files include comma-separated values files (.csv), JavaScript Object Notation files (.json), markdown files (.md), Extensible Markup Language files (.xml), and high-level computer programming and scripting files. Furthermore, in the present disclosure, human-readable data refers to information presented in a format that can be directly interpreted by humans. Examples include but are not limited to, textual data, tabular data, graphical data, image data, and hypertext data. Textual data may further include natural language text and high-level computer programming code and scripts. Textual data may be encoded in ASCII or Unicode formats. Human-readable data may have freeform layouts and typesets that are easily deciphered by humans but are hard for machines to understand without assistance from artificial intelligence. By comparison, machine-readable data are encoded or formatted to facilitate efficient transfer and processing for computers, digital devices, or specialized machines. Machine-readable data may be human-readable as well. For example, a machine may read and process a .json file but ignore descriptive comments within. Some machine-readable data such as binary data may be machine-readable only and cannot be naturally interpreted by a human user.

A static document is a type of document that contains fixed content, which does not change unless the document is manually edited or updated by an authorized user. Once created and finalized, a static document remains the same every time it is opened, regardless of changes in external data or the passage of time. Static documents do not support real-time interactivity or dynamic data retrieval from external sources, and are intended for viewing, printing, and distribution with very limited collaboration capabilities. An update made to a static document typically results in a new version of the document. Static documents are useful when the information is not expected to change frequently, such as published reports, legal contracts, user manuals, or archived records. They provide a snapshot of data that is accurate as of the time of the document's creation or last update, and may be electronically signed and time stamped upon verification of data authenticity.

Next, at step 1130, the static DE document file is parsed into subunits. As discussed with reference to FIG. 7, a document splicer may first identify a native file format of the input DE document, then call upon a document model crawler or document parser specific to the native file format to extract document subunits. A subunit may be a title, a table of contents, an index, a chapter, a subsection, a paragraph, a sentence, a word, a page, a number, a sheet, a table, a graph, a chart, an image, a hypertext link, sub-parts thereof, and the like. The document parser may examine the document, extract information, and put extracted document subparts into data structures tailored to the particular decomposition of the input DE document. In some embodiments, the parsed subunits may be stored in structured file formats such as .json and .xml.

In an exemplary implementation of a document parser for parsing or crawling through the input DE document, one or more of the following steps may be performed. First, the input DE document may be preprocessed or prepared for parsing. This may involve cleaning or converting the data, such as removing unnecessary formatting or converting the document into a consistent plain text format, for example using Optical Character Recognition (OCR). Next, text may be broken down into smaller pieces of tokens. Tokens can be words, phrases, sentences, or other meaningful elements depending on the structure of the document and the parsing tools or programming language used. The parser may further identify patterns or structures within the document, for example, recognizing headings, paragraphs, lists, tables, or other document elements. In some embodiments, regular expressions or machine learning models may be used. In some embodiments, user inputs may be received on how an input document may be decomposed. Based on the identified patterns, relevant document data may be extracted, converted into a standard format, and organized into a structured format. In one example, a requirements document may be parsed into sections, subsections, and paragraphs. Throughout the document parsing process, various techniques and tools may be employed, including natural language processing (NLP), OCR, and AI for understanding complex syntaxes and semantics.

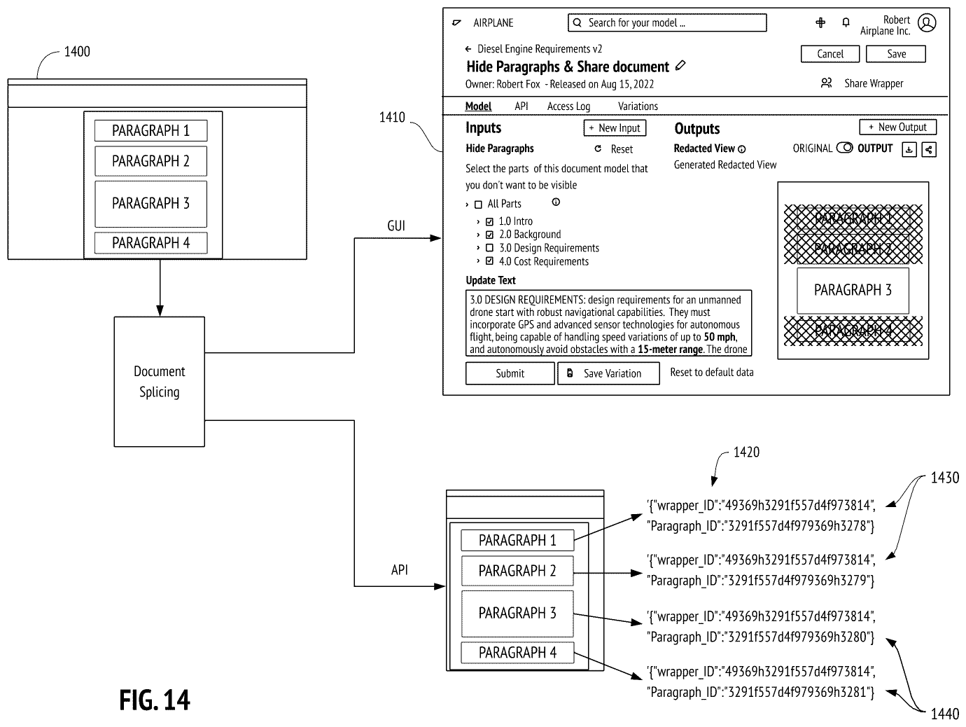

At step 1140, a sharable document splice of the static DE document file is generated. The sharable document splice comprises access to a subset of the subunits, wherein the access is provided through an API or SDK endpoint for each subunit in the subset. FIG. 14 provides an example where each paragraph of a parsed textual document is assigned an alphanumeric paragraph identifier (ID) as individual API endpoints associated with the document splice, also identified with an alphanumeric ID. In another example, the API endpoints may be URLs directed to a web-based server. Thus, in some embodiments, the sharable document splice comprises copies of addressable document subunits; in some embodiments, the sharable document splice comprises the API endpoints while the subunits are stored in a secure database, to be addressed by and accessed via the API endpoints.

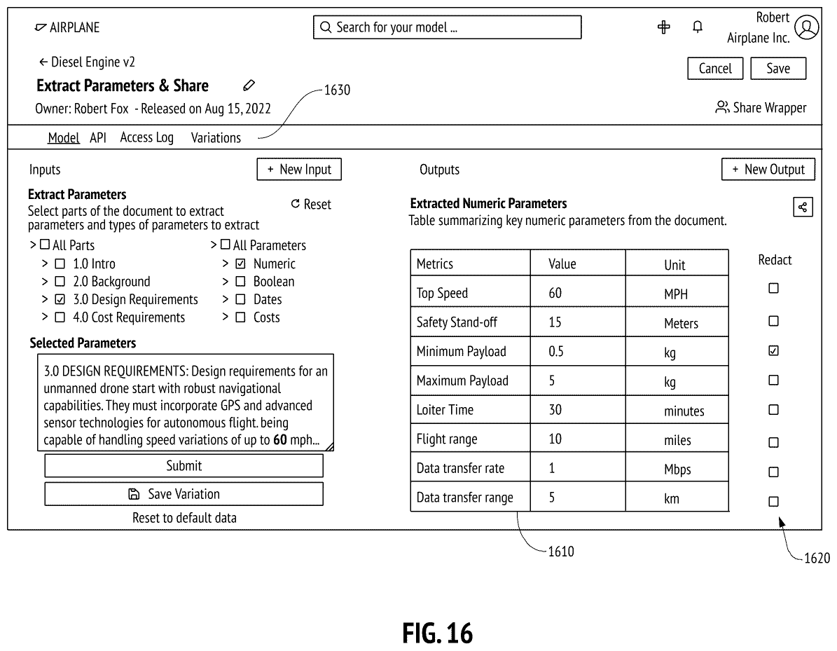

At an optional step 1150, at least one external, common-accessible document splice function is generated. As discussed in the context of FIG. 7, splice functions enable external access to document subunits contained in the sharable document splice, through the subunits' API/SDK endpoints. Across different documents of different formats and compositions, such commonly-accessible document splice functions provide a unified programming interface to sharable document spliced thus generated. Some illustrative splice functions are discussed in the context of FIGS. 14 and 16. For example, a read-type splice function (e.g., “get_section” or “get_section_heading”) may provide, as its function output, a particular document subunit; another splice function may generate a table summarizing key numeric parameters from the document; yet another splice function may provide a total world count or page number for the document.

In some embodiments, a splice function is defined and programmed by a subject matter expert (SME), and a process of generating a splice function may comprise receiving code input from a user. In some embodiments, a splice function may be pre-written by an SME or by an AI-based generator engine, and a process of generating a splice function may comprise retrieving a link to or a copy of the splice function from a datastore. In some embodiments, a process of generating a splice function may comprise receiving a user selection of the splice function from a list of pre-written splice functions in a datastore, and retrieving a link to or a copy of the selected splice function. In some embodiments, a process of generating a splice function may comprise receiving a user input that defines an input/output schema and/or functionality of the splice function, and prompting an AI-based recommender engine to locate a pre-written splice function or an AI-based generator engine to write/create a splice function script. In some embodiments, a process of generating a splice function may comprise using an AI-based recommender engine to recommend one or more pre-written candidate splice functions, based on one or more of a user input, a document file format, and other appropriate context information such as user role in the specific project for which the document splice is to be used.

In some embodiments, document artifacts are extracted or derived from the input document file or parsed document subunits through the execution of one or more document splice functions. An example of a document artifact is a table that summarizes key numeric parameters from a textual report document written in natural language. Another example of a document artifact is a document subunit (e.g., a title, a paragraph) retrieved directly from the document using a read-type splice function. Each document artifact may be associated with respective metadata, for example, context, order, or location information within the document (e.g., a paragraph number, a section number within a section order hierarchy), information security level (e.g., public, confidential, proprietary, etc.), inherent characteristics (e.g., number of rows and columns in a table, data type and size), and the like. Furthermore, document artifacts may include document metadata such as versioning information, ownership, information security level, and digital thread execution data.

For document subunits, their API or SDK endpoints may comprise unique, externally accessible subunit IDs or addresses. Alternatively, such API or SDK endpoints may be provided via document splice functions. Other document artifacts derived using document splice functions from the document subunits or other document artifacts may be accessible via API or SDK endpoints provided via document splice functions as well. Such document splice functions may be encapsulated in a document splice, and invoked through digital threads that link DE models and DE documents.

A document splice may take on the form of a digital file or a group of digital files. For example, a document splice may include a text file and a separate image file. In some embodiments, a document splice may comprise links to or locators/addresses (e.g., pointers, indexes, Uniform Resource Locator (URL), etc.) of the aforementioned document subunits, artifacts and splice functions, which themselves may be stored in access-controlled databases, cloud-based storage buckets, or other types of secure storage environments.

At step 1160, a live DE document is generated from the sharable document splice and an input DE model representation, by executing a digital thread script that uses the API/SDK endpoints of the sharable document splice to access the subset of document subunits. This live DE document is configured through the digital thread script to reflect changes in the input DE model representation. The digital thread script implements a software-defined digital thread as discussed in the context of FIG. 8. Within the IDEP as disclosed herein, a digital thread is a platform script that calls upon the platform API comprising DE model API and DE document API, to facilitate, manage, or orchestrate a workflow through linked model splices and document splices. Specifically, the digital thread script in step 1160 links the sharable document splice and the input DE model representation. A DE model representation may be the DE model itself, a collection of digital artifacts derived from the DE model, or a model splice that encapsulates DE model data and digital artifacts.

A live document is also referred to as a “dynamic document” or “magic document” within the present disclosure. A live document is linked to data sources such as DE models and is capable of updating its content in real-time or on-demand as the underlying data sources change. Live documents reflect the current or latest state of information with minimal manual intervention. As discussed in the context of FIG. 8, linking of DE models, DE documents, model splices, document splices, and live documents generally refers to jointly accessing two or more of the aforementioned objects via digital threads that call up API endpoints, splice functions, and/or platform orchestration scripts. For example, data may be retrieved from a DE model splice to update a document splice; data retrieved from a DE model splice may be compared to data retrieved from a DE document splice and the comparison result may be put into a live document.

In some embodiments, step 1160 is implemented as an update to the document splice based on a digital artifact from the input DE model representation. That is, the digital thread script, when executed, calls upon the input DE model representation for the digital artifact, and propagates the digital artifact into the document splice. When viewed on the IDEP through a dedicated viewer GUI, the document splice is presented as a live document linked to the input DE model representation through the digital thread script. In other words, the live document may be implemented as or built upon the sharable document splice itself, with the “live” or “dynamic” configuration brought in through associated digital threads that execute to update the document splice with digital artifacts. In the context of FIG. 7, a digital artifact is defined as an execution result from an output API function script within a model splice. That is, a digital artifact is a datum extracted or derived from an input DE model. Multiple digital artifacts may be generated from a single DE model or DE model splice. More generally, a digital artifact may be extracted or derived from another DE document. For example, a numerical parameter extracted from a requirements document is a digital artifact that can be used to update a document splice of a verification and validation report. In one document splice update example, the DE model representation may be a DE model splice, and the execution of the digital thread script may call upon a DE model splice function to output a numerical digital artifact (e.g., a total mass for an airplane part) that is then used to update or fill in a data field in a paragraph subunit of the document splice. In another example, the execution of the digital thread script may call upon a DE model splice function to output an image digital artifact (e.g., a front view of an airplane part in.png format) that is then inserted into the document splice as a new subunit.

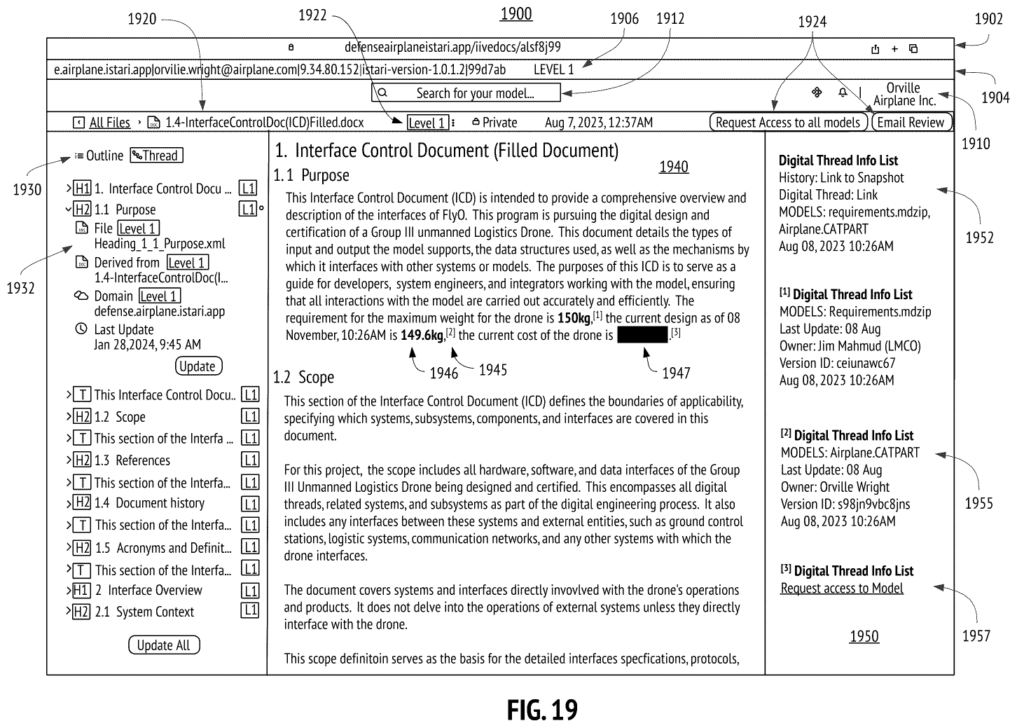

In the present disclosure, a document splice may refer to the splice of a static document or the splice of a live document. The splice of a static document may be used as a baseline or template for the splice of a live document. Furthermore, the terms “live document” and “live document splice” are used interchangeably in the present disclosure, as the presentation of a live document splice on a GUI may be interpreted as the live document by a human user. Exemplary GUI views of live documents or magic documents are shown in FIGS. 19, 20 and 21. In some embodiments, the live document or live document splice may comprise additional formatting or layout information for presentation to a user through a GUI.

In some embodiments, a live document or live document splice may be compiled from multiple component document splices and linked to multiple DE models. A component document splice may be static and fixed, or live and linked to relevant DE models via digital thread scripts. For example, a digital thread script may generate a live document by aggregating subunits of a first component document splice and a second component document splice. A first update digital thread script may update portions of the live document that originated from the first component document splice, and a second update digital thread script may update portions of the live document that originated from the second component document splice.

As digital documents may be viewed as a special case of digital models, any reference to the input DE model representation in step 1160 is equally applicable to an input digital document representation such as an input digital document splice. Similarly, any reference to the digital artifact is equally applicable to a document artifact. For example, a user may highlight different portions (e.g., sentences) from different input documents. Such highlighted sentences may be provided as document artifacts by input document splices, and used to generate, prepare, or update a summary document.

At step 1170, execution metadata for the execution of the digital thread script in step 1160 is added to the live DE document. This digital thread execution metadata are metadata that describe the processes and decisions that occur when the digital thread is executed. Such execution metadata may include, but are not limited to, an identifier of the digital thread script, an identifier of the input digital model representation, a timestamp of the update, information about operations and procedures, tasks executed, time executed, user initiating the execution or other triggers for execution, DE model or DE model splice called upon or linked to, documents or document splices called upon or linked to, specific parameters or setting used, decisions made, alternatives considered, collaboration communication logged, versioning and evolution over time, access and security measures, performance metrics, and a copy of or reference to the digital thread script itself. FIG. 19 shows an exemplary screenshot of a live document displaying digital thread execution metadata. In some embodiments, an identifier of an input digital model representation may contain versioning information. In some embodiments, digital thread execution metadata may be stored separately from the rest of the live document, for example in a secure database, or as non-fungible tokens on a blockchain. Digital thread execution metadata ensures traceability, auditability, accountability, and transparency for live document data updated via digital thread execution. The document splicing and live document generation process terminates at a step 1180.

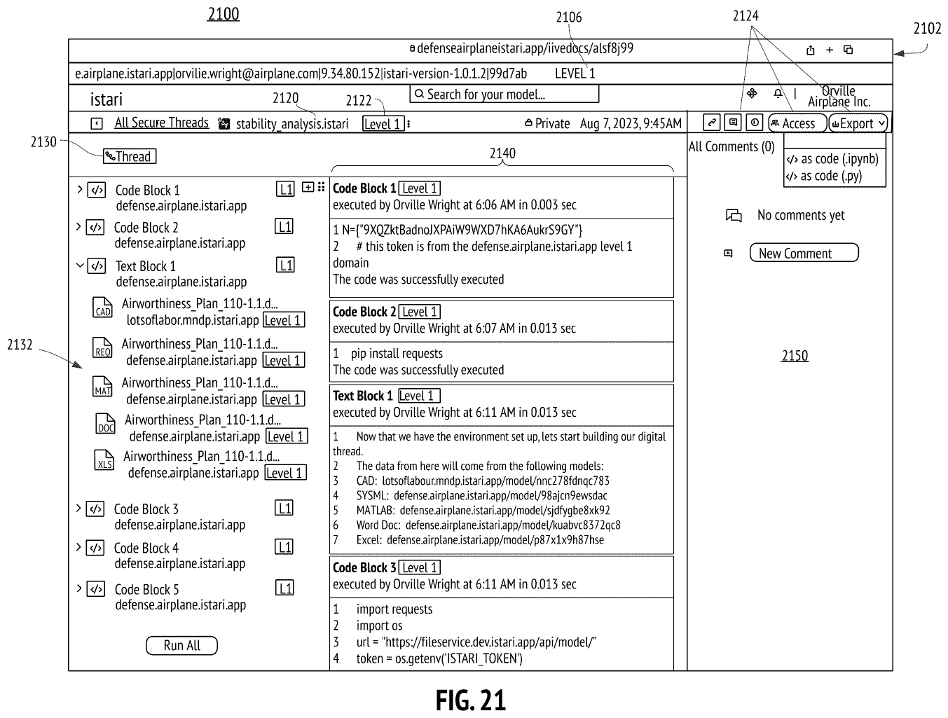

As discussed in reference to FIG. 21, a live document may accompany a digital thread to provide context, commentary, and tracking information (e.g., on ownership, information security level, modification and/or execution) on the digital thread. A digital thread implemented as a IDEP or IDMP platform script is a human-readable document as well. Thus, a digital thread may be document-spliced and used to build a companion document. As the digital thread is modified by a user or executed to complete specific DE tasks involving DE models, the companion is also dynamically updated. The companion document may contain one or more code blocks, as well as metadata on the DE models (e.g., identifier, versioning information, DE model type, etc.).

### Exemplary Document Splicer Implementation

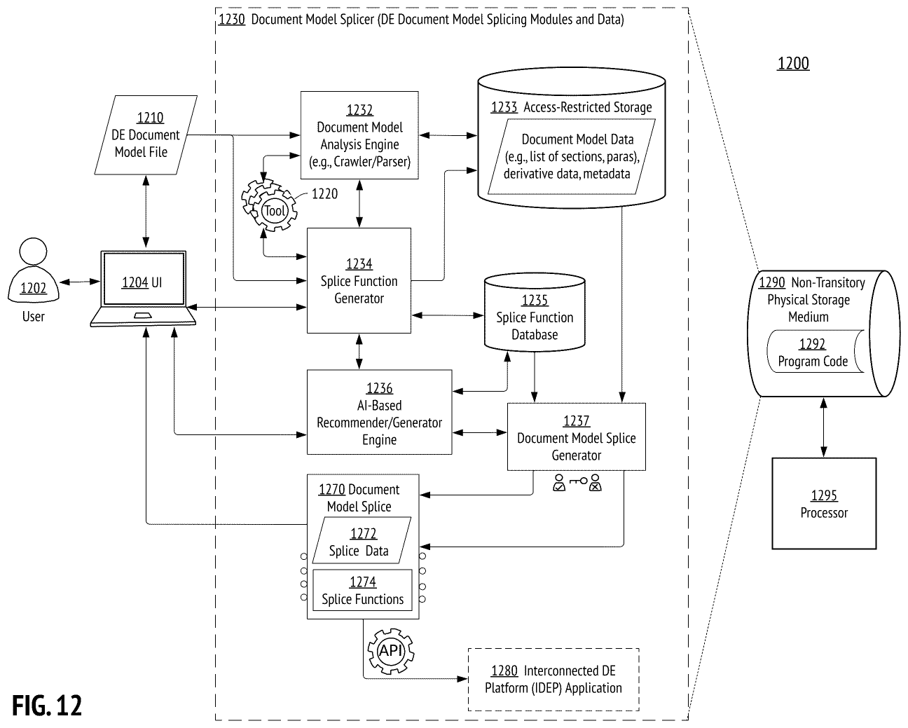

FIG. 12 shows an example system for generating a DE document splice, in accordance with some embodiments of the present invention. This exemplary implementation of a document splicer refers to DE documents as DE document models, for DE documents can be viewed as a specific type of DE models, and methods and systems for DE model splicing are equally applicable to DE documents. DE model splicing applies to DE model data with domain-specific structures, while DE document model splicing applies to human-readable document data with syntactic and semantic rules and structures. For example, while a 3D model of an airplane may be divided into sub-components such as fuselage, engine, wings, propeller, and landing gear, the requirements document for the airplane may be divided into subunits such as chapters, sections, paragraphs, tables, and graphs.

More specifically, in this illustrative example shown in FIG. 12, a non-transitory physical storage medium 1290 is provided to store program code 1292, the program code executable by a hardware processor 1295 to cause the hardware processor to execute computer-implemented processes, including document model splicing or generating a sharable document model splice 1270 from an input DE document model file 1210.

In some embodiments, program code 1292 comprises code to receive DE document model file 1210 in a source file format (e.g., in a native document file format such as .doc). In some embodiments, DE document model file 1210 may be received from a user 1202 through a user interface (UI) 1204. User 1202 may be a human or a computing entity, and UI 1204 may be a graphical UI (GUI), a code interface such as an API/SDK interface, or a multimodal interface as discussed with reference to FIG. 5. For example, user 1202 may represent an artificial intelligence (AI) module that intends to link a generated document model splice 1270 to another DE model splice to update a live DE document as part of a digital thread. The live DE document may be implemented as the document model splice combined with digital thread execution metadata. In some embodiments, user 1202 may provide additional inputs for document model splicing. Exemplary user input include, but are not limited to, requests for specific document artifacts, splice function selections, intents for document model splice usage, access restriction requirements on the generated document model splice, authentication and/or authorization credentials, specific software tools or programming language to be used for crawling or parsing through the input DE document model file and/or for generating the document model splice functions, request for proprietary or open-source tools, proprietary licenses or access codes for using proprietary tools during document model splicing, and the like. In some embodiments, DE document model file 1210 may be received directly from a data source, for example, retrieved from an internal database, a cloud-based storage service, or the world wide web.

A document model analysis engine 1232 analyzes input DE model file 1210 to extract document model data that may be stored in a data storage area 1233, which may be access-restricted, cloud-based, or may be located in customer buckets within customer environments for a zero-trust implementation. In some embodiments, document model analysis engine 1232 may comprise a crawler or parser script that calls upon native functions of native document processing tools 1220 associated with input file 1210 to parse the input DE document model in detail to extract component data, identify metadata associated with the document model file and/or component data, and generate a list of subunits. In some embodiments, document model analysis engine 1232 may generate derivative data or document artifacts from the extracted document model data, with or without the assistance of a splice function generator 1234 and/or AI-assistance. When a derivative datum is generated and stored in storage 1233, associated metadata may be stored as well, for example to identify a time of the derivation, code used for the derivation, user authorizing the derivation, and/or a version of the input document model file at the time of the derivation. Such metadata may be crucial in applications that require near-instantaneous auditability and clear traceability to original sources of truth. In some embodiments, document model analysis engine 1232 may be operated as part of a digital thread, and the aforementioned metadata associated with the derivation of document artifacts may be viewed as digital thread execution metadata.

Splice function generator 1234 generates one or more external, commonly-accessible splice functions that enable external access to one or more document artifacts derived from the document model data. Similar to digital artifacts generated from DE models, document artifacts are functional outputs. Any document model data, derivative data, metadata, or combinations and functions thereof may be viewed as a document artifact, accessed or generated via document model splice output functions. Both document model analysis engine 1232 and splice function generator 1234 may call upon native functions of native tools 1220 associated with the input DE document model or as requested by the user. For example, splice function generator 1234 may generate API function scripts that call upon native tool functions to derive the document artifacts, or to provide functionalities based on user input. The user may specify which tool to use or is preferred. In some embodiments, splice function generator 1234 may interact with user 1202 through UI 1204 to receive user-defined splice functions, to receive user selection from a list of existing splice functions previously defined by other users or previously generated and stored in splice function database 1235, and/to receive user approval or revision to proposed splice functions. In some embodiment, user 1202 may match between the document model data and existing splice functions in splice function database 1235 to identify a selected number of splice functions that may be included in document model splice 1270.

In some embodiments, an artificial intelligence (AI)-based recommender/generator engine 1236 may assist splice function generation. For example, AI-based recommender/generator engine 1236 may have been trained on existing splice functions associated with existing document model splices having similar formats or analogous DE document model types, and may have been further fine-tuned based on user inputs. In some embodiments, AI-based recommender/generator engine 1236 may utilize a large language model (LLM) to write function scripts that call upon APIs of native DE tools 1220. In some embodiments, AI-based recommender/generator engine 1236 may retrieve a list of splice functions from splice function database 1235, based on user input and other data inferred from the input DE document model, such as file format, DE document model type, intended purposes/use/audience, etc. In some embodiments, AI-based recommender/generator engine 1236 may autonomously match document model format or type with existing splice functions to recommend a list of potential splice functions for the user to select from.

While DE documents are discussed in exemplary embodiments of document splicing and live document generation within the present disclosure, the systems and methods as disclosed herein are equally applicable to general documents not traditionally used in digital engineering. For example, such documents may be scientific reports, peer-reviewed academic papers, news articles, legal briefs, business contracts, real estate deeds, living wills, affidavits, or even books, each with specific layouts and formats, and may be viewed as a different document model type. Analogous document models or document model types refer to document models that are similar in some aspects, such as structure or format, but are not identical. For example, peer-reviewed academic papers and news articles can both include citations to external sources of data, but peer-reviewed academic papers typically have specific individual sections such as introductions, methods, results, each with respective section titles. Analogous document models may be identified by analyzing their characteristics and determining shared common features, attributes, components, or fields that are relevant for document model splicing. Analogous document models may be used as reference, baseline, or starting point for document splicing, leveraging the similarities to improve efficiency and to capitalize on validated splice functions. Analogous document models are particularly useful when they follow the same standard guidelines or reuse the same components or document parts. For example, peer-reviewed papers have similar sectional structures, but a literature review paper differs from a multi-experiment paper. Splice functions generated for one type of document may be used as training data for AI-based recommender/generator engine 1236, for generating splice functions of other analogous document types.

The splice functions thus generated provide addressable API or SDK endpoints to document artifacts, making them accessible by third-party applications and users. Such API or SDK endpoints enable access to the document artifacts without access to the entirety of the DE document model file and without requiring direct engagement by the third-party applications and users with native tools 1220 associated with the native document file format. That is, splice functions can mask native tool functions. A user of a generated document model splice is no longer required to have deep knowledge of the associated native tool. Furthermore, different users may access the same API or SDK endpoints that deploy different underlying native tools during document model splicing. For example, a first user having a first input .doc file and access to MICROSOFT WORD, a second user having a second input .ppt file and access to MICROSOFT POWERPOINT, and a third user having a third input .pdf file and access to ADOBE, can all obtain document splices having the same splice functions that are implemented with appropriate tool functions respectively.

A document model splicer generator 1237 may bundle splice data 1272 and splice functions 1274 into sharable document splice 1270, in the form of locators (e.g., links, addresses, pointers, indexes, URLs, etc.) and/or copies of data. Splice data 1272 may be a selective portion of document artifacts obtained from input document model file 1210. This selective portion may be selected based on data access permissions, such as a user input on the access level or security clearance level of another user that the generated document splice will be shared with, or on a need-to-know basis, such as metadata indicating the DE task which the document splice has been generated for. Splice functions 1274 may be selected from those stored in splice function database 1235. While splice functions 1274 are shown as encapsulated within document splice 1274 in FIG. 12, in some embodiments, splice functions may be accessed as part of the IDEP platform API, and not explicitly contained in document model splice 1270.

Sharable document splice 1270 is accessible via API or SDK endpoints by third-party applications and users. These API or SDK endpoints provide a unified programming interface to all sharable document splices. These endpoints may be utilized by applications 1280 within the IDEP to perform specific tasks, optimally under endpoint-specific, zero-trust access control. Thus, document splicing, as a special case of DE model splicing, may be perceived as an use case-specific or application-specific process, as the data and functions of the document splice may be chosen or determined based on the intended use of the document splice.

In various embodiments, generated document model splice 1270 may be shared with another user, who may in turn execute it to access and/or modify the document artifacts and/or the input document model. As discussed in the context of FIG. 7, in some embodiments, splice functions may be classified into input functions or model modification functions, and output functions or data/artifact extraction functions. Inputs into a model splice for execution may be input parameters for such input splice function and output splice functions. Outputs of model splice execution are document artifacts and/or modified DE document models that can be shared, viewed, further modified, linked into digital threads, and used for completing DE tasks. When a document model splice such as 1270 is further modified via digital thread execution and the execution metadata tracked as part of the document model splice, the document model splice becomes a live or magic document that can be presented to a human user on a GUI, with subunit outlines, execution metadata, dynamic data links, and interactivity enabled for document review, comment, and approval.

While document model analysis engine 1232, splice function generator 1234, document model splice generator 1237 and AI-based recommender engine 1236 are shown as separate modules within FIG. 12, in various embodiments of the present invention, these modules may be integrated in any combination to facilitate seamless data exchange and functional collaboration to optimize the overall performance of the document model splicing process. In some embodiments, parts of document model splicer 1230 may be implemented within a customer environment behind a customer firewall and be managed by an IDEP agent, so that customer data within storage 1233 is fully protected under a zero trust setting. Splice function database 1235, which could be independent from specific model data, may be provided by the IDEP and accessed via the IDEP agent.

The discussion of the document model splicing process and the document model splicer in the context of FIGS. 11 and 12 so far has focused on model splicing a single, given DE document model type, where a document model type may refer to a specific file format (e.g., .doc, .ppt, .pdf, .txt), or a specific class or category (e.g., CONOPS, ICD, SDD, ISP, peer-reviewed journal paper in algorithms, peer-reviewed journal paper in medicine, etc.). In some embodiments, document model splicer 1230 may first identify a document type of the input document file, then splice accordingly. For frequently used document model types, splice functions may be written and tested by subject matter experts manually, and stored in splice function database 1235 for use to generate use case-specific document model splices. It would be further advantageous to scale document model splicer 1230 from a few widely used document model types to a large number of document model types. Furthermore, as document model splicing is use case-specific, two different input document model files of the same document model type and intended for the same purpose may lead to similar document model splices having different document model data but identical splice functions.

In some exemplary implementations of the document model splicing process, one or more of the following steps may be performed by the system shown in FIG. 12. First, document model analysis engine 1232 may perform preprocessing steps before an input document model file is received or uploaded. Specifically, document model analysis engine 1232 may interpret file structure and schema for a library of document-model-type files, and build a library of typical use cases for document model splices based on customer interviews and user inputs. Machine learning (ML) or AI-based algorithms may assist in scaling the document model splicer, where exemplary splice functions and file structure details may be used to create archetype for potential splice functions for specific document-model-type files. Here the term “document-model-type” file refers to a document model file of a specific document model type.

In some embodiments, when a document-model-type file is received or uploaded, the document model splicer may translate user instructions for typical use cases into specific functions that link appropriately with the document-model-type file. The document model splicer may provide a selection of splices for common uses (e.g., query the document model or perform specific actions such as data field redaction on document model data). The user may provide specific queries or desired actions to the system, for example to select from a list of document model splices, or optionally input text prompt to an AI-assistance module to obtain a selection of document model splices. Furthermore, in some implementations, endpoint calls to a document model splice and its outputs may be tracked or audited as part of security implementation. Endpoint metadata tracking or auditing may also serve as training data set for user workflows that can be implemented in an automated or AI-assisted manner.

In some embodiments, a document model splice makes available a subset of the document model through a subset of API endpoints or a GUI/web-app. The API endpoints may be accessed directly via code, while the GUI/web-app may offer not only handles to the API endpoints, but also interfaces for user interaction with document model splices. In some instances, one of the API endpoints may still point to the location of the whole document file. In some instances, a document model splice may be used to share a sub-document built from extracted document model data. In other instances, where the splice only provides a limited set of API endpoints, the pointer to the whole document file may be needed for context. For example, a document model splice that is generated from a requirements document with hidden subsections may internally connect with the whole extracted document in order to ensure cross-references are correctly cited.

The aforementioned splice functions allow users to share, modify, and redact the input document with limited exposure to the complete document which could contain proprietary information. This means the document owner may retain control over who has access to which parts of the document, while still allowing others to work with the document collaboratively. Furthermore, the splice may webify the document and abstract its native API, exposing only those aspects of the document the owner intends to share. Document model splicing enables secure and collaborative workflows without the need to duplicate documents or expose sensitive information. It enables efficient sharing, abstraction, and redaction of the documents' data without requiring full transparency to the entire document.

### Document Model Splicing and Slice Function Examples

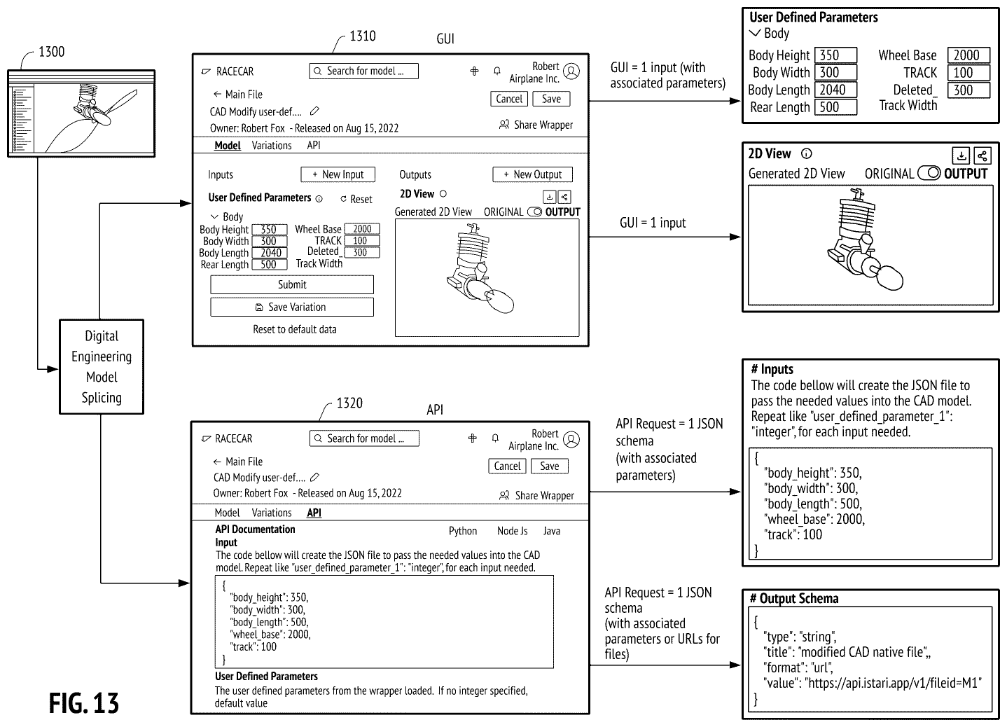

To illustrate the equivalence between DE document splicing and DE model splicing, FIG. 13 shows an illustrative example of CAD model splicing result within the IDEP, according to some embodiments of the present invention. In this example, an input CAD file 1300 for a propeller engine is spliced into model data and splice functions written as scripts that call upon native DE tool APIs. Exemplary model data are shown in an GUI interface 1310 with input parameter fields on the left, and an output visualization on the right. Data schemas and/or API scripts may be accessed via a separate tab 1320 in the GUI, listing input schemas and output schemas for API endpoints to pass needed values into the CAD model, or for providing output locations of modified native files.

By comparison, FIG. 14 shows an illustrative example of document splicing or document model splicing within the IDEP, in accordance with some embodiments of the present invention. FIG. 14 is structured similarly to FIG. 13. During document splicing, an input document file is first parsed into chunks, parts, subunits, or components, with or without hierarchy, and each with at least one API endpoint for access and handling. In this illustrative example shown in FIG. 14, an input document 1400 is written in paragraph form, in text only, and parsed, divided, or segmented into individual paragraphs as delineated by carriage returns and paragraph spacing. In various embodiments, document parts or subunits may be classified according to type, structural form, formatting, spacing, syntax, sectioning, content, theme, or any other predefined or user-defined rules. For example, a subunit may be a structural component such as a title, a chapter, a section, a subsection, a paragraph, a sentence, a word, a sheet, a page, a line, a comment, a hyperlink, a table, a graph, an image, an equation, and sub-parts thereof. In some embodiments, parts or subunits of the same structural form may be of different types, for example, title, version number line, author line and publisher line; table of contents, table of numerical parameters; sections, subsections; header, footers; front cover, back cover; stakeholder name field, signature field, and the like. In some embodiments, an LLM may be deployed to understand user-defined rules for splicing a document. In some embodiments, subunits are non-overlapping; in some embodiments, subunits may overlap (e.g., a word subunit being a part of a paragraph subunit).

In FIG. 14, exemplary document model data are shown in an GUI 1410 with input parameter fields on the left, and an output visualization on the right. Parts of input document 1400 are organized by sections (e.g., 1.0 Intro, 2.0 Background, 3.0 Design Requirements, 4.0 Cost requirements). For illustrative purposes, each section is shown as containing a single paragraph. In practice, each section may contain multiple individual paragraphs as sub-parts, and each paragraph may be identified by a unique paragraph identifier (ID). API 1420 is shown below for the document splice, with a single splice or wrapper ID 1430 and individual paragraph IDs 1440 for document parts in paragraph form. The combination of the wrapper ID and paragraph ID may be viewed as an API endpoint for each paragraph. Alternatively, the paragraph ID alone may be viewed as an API endpoint. A splice function provided by the IDEP platform API or contained in the identified wrapper may be used to access the identified paragraph from the identified wrapper.

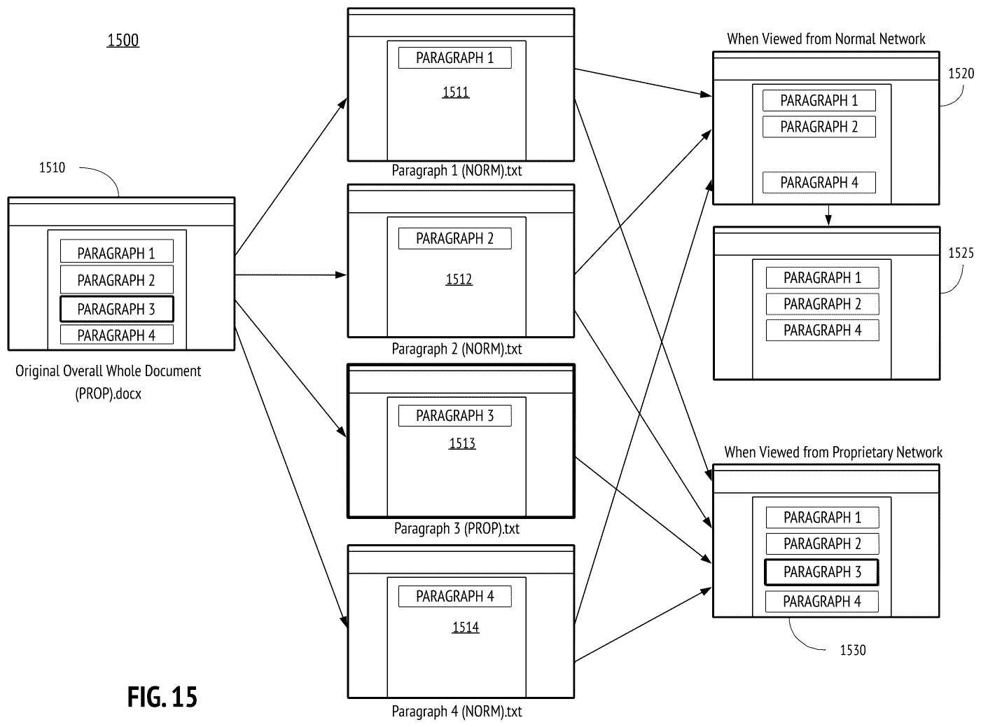

Further in GUI 1410, an API wrapper/script or splice function titled “Hide Paragraphs & Share document” is displayed. The splice function's input parameter fields are listed on the GUI's left side, where each document part or sub-part is represented by a label and arranged in a tree-shaped hierarchy similar to a CAD model with components and subcomponents. A creator of the document splice has the option to choose which part(s) to hide or conceal from viewing by users with whom the document splice is shared, and the result of this action is visualized on the right side of the GUI, with selected paragraphs “hidden” or blurred from view. In this particular example. “hidden text” appears as crossed-out. Conversely, users of the document splice can propose changes or suggest modifications only to the parts or sections they have access to. Alternatively, in some embodiments, the selected paragraphs may be redacted in black or white; in some embodiments, the redaction may be indicated by an in-line symbol. In some embodiments, an additional editor window may be used, and non-hidden paragraphs may be displayed to and edited directed by a user. In some embodiments, the redacted paragraphs may not be shown in the document view. For example, the recipient may only see document data that they are authorized to view, with no additional context for other document data they are not authorized to view. FIG. 15 provides a graphical illustration 1525 of such a setup.

Specially, FIG. 15 shows an illustrative example 1500 of viewing a document with component-level access control via document splicing, in accordance with some embodiments of the present invention. In this example, an original, proprietary whole document 1510 comprises four paragraphs 1511, 1512, 1513, and 1514. Paragraph 1513 contains proprietary information. When viewed from a normal network, a redacted version 1520 is shown to the user, with paragraph 1513 hidden from view. When viewed from a proprietary network, the full version 1530 is shown to the user. This is an example of “classification by compilation,” which refers to the act of processing a digital thread with various document splices having different information security level authorizations, such that for a specific authorized user, the digital thread script compiles the appropriate document parts to prepare a view appropriate for their information security classification. In this particular example, view 1520 contains a gap where paragraph 1513 is, thus reminding the user that proprietary information has been hidden. An alternative view 1525 removes the gap so the user would be unaware of any hidden document components

To achieve the document splicing result shown in FIG. 14, in one exemplary implementation of the document model splicing process, a document splicer crawls through the input document file and extracts document data, based on factors such as formatting, spacing, punctuation, sectioning, content, semantics, syntax, and so on. As the document model splicer crawls through the document file, it determines how document data may be organized and accessed, as fundamentally defined by the document file's formatting and/or semantics, as well as the document processing tool used in splicing the document, for example to establish a document data schema. This document schema may describe the structure and formatting of the document data, some of which are translated into, or used to create input/output API endpoints with corresponding input/output schemas.

An exemplary set of input and output types/schemas is shown in Table 1.

TABLE 1
Exemplary Set of Input and Output Types/Schemas

```
{
“inputs”: [
  {
  “id”: 1,
  “type”: “Dropdown”,
  “name”: “Paragraph Selection”,
  “options”: “List of available paragraphs”
  },
  {
  “id”: 2,
  “type”: “Number”,
  “name”: “Paragraph ID”,
  “unit”: “integer”
  },
  {
  “id”: 3,
  “type”: “Text”,
  “name”: “Paragraph Content”,
  “unit”: “string”
  },
  {
  “id”: 4,
  “type”: “Checkbox”,
  “name”: “Add New Paragraph”
  },
  {
  “id”: 5,
  “type”: “Checkbox”,
  “name”: “Delete Paragraph”
  }
]
{
{
“outputs”: [
  {
  “id”: 1,
  “type”: “Text”,
  “name”: “Paragraph Content”,
  “unit”: “string”
  },
  {
  “id”: 2,
  “type”: “JSON”,
  “name”: “Document Structure”,
  “unit”: “JSON object representing the document's hierarchical
  structure”
  },
  {
  “id”: 3,
  “type”: “Number”,
  “name”: “Total Paragraph Count”,
  “unit”: “integer”
  },
  {
  “id”: 4,
  “type”: “File”,
  “name”: “Download .docx File”
  },
  {
  “id”: 5,
  “type”: “Array”,
  “name”: “Extracted Numeric Variables”,
  “unit”: “Array of numeric variables found in the document”
  },
  {
  “id”: 6,
  “type”: “File”,
  “name”: “Export as .txt”,
  “unit”: “Text file (.txt) version of the document”
  },
  {
  “id”: 7,
  “type”: “File”,
  “name”: “Export as .pdf”,
  “unit”: “PDF file (.pdf) version of the document”
  }
]
}
```

In one exemplary embodiment, once document splicing is completed, a “Hide Paragraph” document splice such as shown in FIG. 14 may comprise the following:
1. An instantiation of document data structure: a set of parts, possibly in an hierarchical order, saved in one or more files, including one or more of the following:
   a metadata (e.g. in JSON format) file, for example, comprising part names/titles, and/or API endpoints written according to document model splicer input/output schemas
   an extracted data file having a unified data structure (e.g. can be JSON or text format file, with pointers to hyperlinks)
   an open source file (e.g. JPG for a graph, OpenDocument for text), and
   other files (e.g. PDF files, RAR files).
2. Splice functions written as API Scripts, which are code executable on 1 above to achieve desired functionalities (e.g., hiding paragraphs). Splice function creation may comprise one or more of the following steps:
   In some embodiments, some splice functions may already exist (e.g., if the document has been uploaded and analyzed before). During splicing, a user may select a specific subset of splice functions or API scripts for use within a splice.
   In some embodiments, the platform may automatically generate business process-specific splice functions for document splices. For example, a collection of business process-specific splice functions such as HideParagraphs (ParagraphsList) may be created for an input requirements verification report file; in some cases, one splice may be created and the user may add or remove splice functions to update the splice.
   Some splice functions may be called upon by IDEP platform scripts to implement API endpoint creation and/or linkages
   Splice functions may be executed through API endpoints. API endpoints function as URLs or address pointers. Each API endpoint may correspond to a specific function or resource, such as retrieving document data, updating document data, or deleting document data.
3. Optionally, the original document file may be included in the document splice as a separate entry. In the Hide Paragraphs example shown in FIG. 14, only a modified document (after the “hide” function) may be shared, not the original full document (with all the parts or sub-parts).

It is important to note that document splicing may involve not only human-readable data extraction but also programming code generation. Once spliced, subsequent processing for new document splices may involve text search of specific metadata (e.g. API endpoints of part that must be linked to a subsequent DE model or document splice for a digital thread). That is, text search is a component within the data processing of the document file, or new documents created. However, the search operation is accompanied by implementation of logic through API scripts or context-specific insights (e.g. What is the likely document file to link to? What API endpoints are needing links?).

As another example, FIG. 16 shows an “Extract Parameters and Share” document splice function in a document model splice, in accordance with some embodiments of the present invention. In particular, this splice function may extract different types of parameters from an input document, with exemplary parameter types ranging from numeric, boolean, dates (e.g., deadlines), and monetary costs (e.g., unit prices, total costs). A user can choose which parts of the document to extract parameters from, and type(s) of parameters to extract. In this particular example, numeric parameters are selected to be extracted from the design requirements section and listed in a table 1610 with corresponding units. Another similar exemplary document splice function may be a “Mask Parameters” splice function. When executed on the same input file, numeric parameters may be masked from the design requirements section using variable names or redaction characters. In some embodiments, a “Mask Numeric Parameters” splice function may further provide user interactivity capabilities, for example in the form of an added column 1620 that allows a user to select individual extracted numeric parameters in the table to mask or redact from the document splice as desired.

In addition to the document data view and user option interface shown in FIG. 16, in some embodiments, additional hyperlinks or tabs 1630 may be provided. For example, an “API” tab may provide access to the functionalities shown on the GUI through a list of APIs available, e.g. list input options, select input option, list output options, select output option etc. An “Access log” tab may list a time-stamped access log, providing an auditable log of the document splice functions executed. An “Variations” tab may provide a list of variations of the document model created by executing specific selections of inputs.

### Additional Exemplary Use Cases for Document Splicing

Below is an exemplary and non-exhaustive list of additional use cases for document splicing:
1. Content Management Systems (CMS): a custom CMS may be built where content is organized at the paragraph level. This makes it easy to update specific sections of a document without modifying the whole system. For example, a DE team may revise the materials used in a wing construction. Using the CMS, the team may find and update relevant paragraphs in the “Wing Design” document without touching other sections related to wing shape, dimensions, or aerodynamics.
2. Custom Search Engines: a search engine that indexes at the paragraph level may use API endpoints to provide results that are more granular and specific. Users could get a list of paragraphs that match their search query.
3. AI Services: for an application that uses AI to manipulate or analyze text (e.g., a grammar corrector or sentiment analyzer), having paragraphs exposed as individual API endpoints makes it easier to process the text in chunks, rather than having to handle an entire document at once. Additionally, document splicing on the glandular level (e.g., at a paragraph level) may assist the pre-filtering of the document for AI services. For example, only a selected set of paragraphs may be assessed via a document splice for AI fine-tuning, rather than using an entire document.
4. Distributed Editing and Collaboration: document splicing allows multiple users to work on different parts of a document simultaneously without running into conflicts. Each user could retrieve, edit, and save changes to individual paragraphs without interfering with others.
5. Dynamic Content Rendering: a website or application may be built to pull in content dynamically from API endpoints. For example, a learning platform could provide users with a customized study guide composed of paragraphs pulled from multiple documents.
6. Document Versioning: By allowing updates at the paragraph level, a more granular version history of a document may be created, tracking changes paragraph by paragraph instead of for the whole document.
7. Microservices Architecture: for a larger system where different microservices need to access or update different parts of the content, breaking the document down into paragraph-level endpoints could fit well with a microservices architecture.
8. Sharing: only sharing a specific portion of a document with specific people

### DE Model Splice and Document Model Splice Linking

Once spliced, a document may be linked to other document model splices and/or DE model splices via digital threading through API endpoints, enabling the propagation of data from one splice to another in real-time or on-demand. The terms “document splice” and “document model splice” are used interchangeably in the present disclosure. A document splice with subunits linked to DE model splices to reflect changes in the DE model splices becomes a live or magic document. Granular linking at the document subunit or component (e.g., paragraph) level further makes live updates more computationally efficient, aids in the prefiltering of document components for use in DE tasks, and enables the aggregation and summarization of model data independently of the native DE tool or development platform used to generate the input DE model or DE model splice.

Next, several configurations for model splice linking are described in detail. These are provided as illustrative examples only, and are not intended to limit the scope of the present invention.

### DE Model-to-Document Model Linking for Data Update and Parameter Substitution

In a first configuration, one or more DE model splices and one or more document model splices may be linked for unidirectional or bi-directional data updates. For example, a report document may be spliced and updated by auto-populating selected fields with design revisions. Similarly, data field labels in a document template may be substituted or filled in with data extracted from a linked DE model, to generate a new document. In this case, the document template is a static document with fixed content; the new document may be a one-time static document as well, or may be configured into a live document with dynamic data updates. In a converse example, a design model may be updated with new revised requirements as written in a requirements document.

FIG. 17 shows an illustrative example 1700 for linking a DE model splice and a document model splice to generate a design requirement document by parameter substitution, in accordance with some embodiments of the present invention. This illustrative example is a three-step process: first adding DE models to the IDEP to create DE model splices accessible via GUI and APIs, then adding documents to the IDEP to create document model splices, where individual sections or paragraphs of the document are accessible via GUI and APIs, and linking the DE model splices and document model splices, possibly via python scripts that utilize the DE model splice APIs and document splice APIs, to generate an updated design requirements section populated by design parameters extracted from the input DE model.

In the specific example shown in FIG. 17, an API 1710 to a document splice provides a wrapper ID identifying the document splice, and a paragraph ID identifying the paragraph to be updated, in this case a “DESIGN REQUIREMENTS” paragraph 1730. On the other hand, an API 1720 to the DE model splice provides or shows parameter values for a modified design. A python script module 1740 that implements a digital thread is used to substitute the correct parameter values into the ID′ed paragraph.

While FIG. 17 illustrates document data update for a single paragraph, a full document may be updated iteratively using the same approach. For example, the python digital thread script may step through the entire document one part at a time, retrieve DE model data relevant to the document part of interest via model splice API endpoints, and update the document part accordingly.

It is important to note that good individual paragraphs, even if well-written, may not necessarily form coherent sections or documents when combined. It is also inefficient to make API calls to the DE model for each single paragraph, when the same data has already been retrieved for other paragraphs. Therefore, when a linked DE model undergoes changes, all associated elements within the same document, such as titles, subtitles, paragraphs, sections, and subsections, may be updated to reflect those changes. An iterative approach may be employed to update from the bottom-up, starting with a specific target paragraph, then its related sections, and finally the entire document. In the subsequent iteration, updates to paragraphs, sections, and the whole document may be carried out in sequence. For a generated document to be easily comprehensible, at least two iterations may be implemented.

In addition to the example shown in FIG. 17, another example of DE model and document model linking involves the use of AI assistance, specifically the use of a large language model (LLM) for AI-assisted model linking and parameter substitution. An SME may provide a prompt to a LLM, including JSON parameters extracted from a DE model via DE model splicing and a design requirement paragraph extracted from an input document via document splicing. Instructions may be further provided in natural language to update the paragraph with the updated parameters. In the exemplary process shown in FIG. 11, a digital artifact (e.g., a parameter) may be derived or extracted from the input digital model representation, and a prompt to a LLM-based AI module may be built based on a document subunit (e.g., design requirement paragraph) and the digital artifact, for example via execution of the digital thread script. The LLM-based AI module may in turn generate a new document part (e.g., a new paragraph) or update the input paragraph in response to the prompt. In some embodiments, a user feedback on the generated document part may be received, and the generated document part may be further updated based on the user feedback. The input paragraph, the digital artifact, and the updated document part makes up a 3-tuples that can then be used as training data for the LLM-based AI module.

In yet another example, a design report may be generated from linking a DE model splice of an input DE model with a document splice of a template document. Specifically, such a design brief may first be created from the supplied template document, then auto-populated and revised based on new design revisions from the input DE model. First, the input DE model file (e.g., CAD model of a Formula 1 racing wheel) and a design brief document template related to the DE model file may be received. Next, a document splice of the design brief document template may be created, by segmenting the document into individual sections. Fields within the document template may be labeled as requiring considerations. Next, a model splice of the input DE model file may be generated, possibly based on the document splice. For example, an LLM-based AI module may analyze each field to decide if it is quantitative or qualitative, and a python script module such as 1740 in FIG. 17 may further determine DE model parameters and characteristics that are needed to either directly fill in, or be used to compute, individual fields identified in the document splice. Next, individual sections spliced from the document template and associated DE model splice data may be passed as input into the python script module, or as prompt into an LLM for data update or parameter substitution. The complete design document can then be compiled from the individual sections. In some embodiments, a user prompt may be received at the beginning to indicate additional constraints for the splicing process.

As yet another example, FIG. 18 is an illustrative flow diagram 1800 for a process to generate an expense report from a document template, in accordance with some embodiments of the present invention. In this exemplary process, one or more of the following process steps are performed by the IDEP:
1. (Step 1805) A user launches an IDEP application, such as an expense report generator implemented as a python script for linking an expense model and an expense report template.
2. (Step 1810) The system prompts the user to:
   a. Choose a model (e.g., an expense model in the form of an EXCEL spreadsheet).
   b. Choose a template (e.g., an expense report template in the form of a WORD document).
3. (Step 1815) User selects an expense model:
   a. If the model has already been uploaded and spliced, the model splice may be selected.
   b. Alternatively, the user can upload a new model for splicing.
   c. During the splicing/wrapping process, metadata or filename may be parsed for version information and added to wrapper metadata. This version information may be displayed on a GUI wrapper page.
   d. A unique identifier may be assigned to the splice/wrapper for the system to track.
4. (Step 1820) User selects a document template:
   a. If the document has already been uploaded and spliced, the document splice may be selected.
   b. Alternatively, the user may upload a new document as a template.
   c. Similar to the DE model, the document may also have version tracking, and the user may enter a version identifier if desired.
5. (Step 1825) The system verifies the uploaded document template's relevance to an expense report. If not verified:
   a. The system may throw an error and offer the following alternatives:
      i. Requesting a different document.
      ii. Suggesting a pre-loaded template.
      iii. Asking if the user wants to use a different application or digital model.
6. (Step 1830) The system then analyzes the document template and converts it into a document model splice. If uploaded previously, this process might have already been done.
   a. The system divides the document template into parts, chunks or sub-units (e.g., paragraphs, sections).
   b. The system identifies any variables that might be updatable.
   c. The system analyzes the document parts and creates a JSON representation accordingly, including summaries, lengths, etc.
   d. The system creates a version history where the user may see any changes in the document splice or new uploads. Such a version history may be viewed as document splice metadata or a document artifact.
7. (Step 1835) The system analyzes the expense model to check for needed data. If data is missing, the system may:
   a. Request a different model.
   b. Ask the user to input specific values via web-forms.
8. (Step 1840) The system links data from the expense model to the document template. That is, a digital thread may be executed to update a subunit in the document splice with a digital artifact derived from the expense model.
9. (Step 1845) The system generates a new expense report document using APIs from both the spliced expense model and the spliced document template.
10. (Step 1850) The user can download the new expense report document (e.g., in a WORD format) and the generated Python code implementing automatic document creation using IDEP platform APIs.
11. (Step 1855) The user may revise the expense model when noticing a missing expense in the model.
   a. The user may upload a new version of the expense model.
   b. The IDEP may update the newly uploaded file's version, and a new unique identifier may be assigned.
   c. The expense report generation application may be re-run to automatically generate a new expense report document. This application may be set to re-run automatically upon each model update. Alternatively, the application may be configured to update only relevant portions of the previously generated expense report upon each model update.

FIG. 18 depicts an exemplary use of DE model and document model splicing tailored for enhancing the efficiency and accuracy of financial audits concerning expense reports. Specifically, a relevant compliance document or project contract document may be identified as the document template, from which compliance criteria may be extracted via document splicing, and may be aligned with each expense line item extracted from an expense report DE model. Additionally, FIG. 18 illustrates how the IDEP platform supports a streamlined audit process, applicable to both human auditors and automated checking mechanisms. The method of document model and DE model splicing and linking shown in FIG. 18 substantially mitigates the labor-intensive and error-prone nature of manual audits by providing an immediate reference framework, which aids auditors in efficiently verifying the legitimacy and necessity of expenditures. Furthermore, this system may be used to improve the effectiveness of assurance reviews by providing reviewers a direct link to the relevant compliance criterion for each expense, thus eliminating the need for random sampling, thereby ensuring a more thorough and consistent audit and assurance process.

As additional illustrative examples, the following setups for DE model splice and document splice linking may be implemented in various embodiments of the present invention. These examples are for illustrative purposes only and do not limit the scope of the invention. In various embodiments, DE model splices and document splices may be linked in appropriate combinations and/or permutations, depending on the user case and/or user input.

In a first setup, an expense report model in EXCEL is spliced and linked or combined with an expense report template document splice to generate an expense report splice with associated API endpoints and splice function scripts. These scripts may be written as python code that uses API scripts from the EXCEL model and the document splice. When viewed through a GUI on the IDEP, the expense report splice may be displayed as a live document or magic document, discussed in more detail in the context of FIG. 19.

In a second setup, an input DE model (e.g., CAD model for airplane wing design) may be spliced and linked to a design report template splice, to generate a wing design report splice with additional API endpoints and scripts written in Python for further access and handling of the wing design report data.

In a third setup, multiple DE models may be spliced and linked with a single document template splice.

In a fourth setup, multiple DE models and multiple document templates may be spliced and used to generate multiple output document splices with associated API endpoints and splice function scripts.

In various embodiments, any number of DE model splices and document splices may be linked in appropriate combinations and/or permutations, depending on the user case and/or user input, and used for generating static updated documents or live magic documents.

### Exemplary GUI for a Live Document

FIG. 19 shows a screenshot of an exemplary graphical user interface (GUI) 1900 for viewing and interacting with a live document in a digital documentation system, in accordance with some embodiments of the present invention. Specifically, a live Interface Control Document (ICD) is shown, with data fields filled using DE model data extracted via digital thread and splice function execution. This live document is built as a document splice linked to one or more DE model splices.

GUI 1900 includes a browser window header 1902 which includes a document link for easy navigation. Below the header, a domain and security level banner 1904 displays the domain, platform software version, and security level, ensuring that users are aware of the domain they are operating in and the security protocols in place. The security level indicator 1906 displays the user's maximum security access level within the platform (e.g., “Level 1”).

The interface also includes a search bar 1912, allowing the user to carry out comprehensive cross-platform searches through the IDEP for DE models, files, and documents, thus facilitating efficient retrieval of information across the platform. Next to the search bar, a user and domain field 1910 provides information on the user's domain (e.g., client name). User and domain field 1910 may allow the user to login and to access user profile and subscription information.

The top menu of GUI 1900 offers additional functionalities. For example, a document name field 1920 displays the document's name, and may include its version. A document security level indicator 1922 displays a security level (e.g., “Level 1”) of document 1920. In one embodiment, using an expandable security level menu adjacent to document security level indicator 1922, the user may select the document's target security access level “view”, thus filtering only the parts of the document accessible through a given security level. In other embodiments, the user may also use document security level indicator 1922 to down-select the security level while sharing the document, thus sharing portions of the document that correspond to the specified security level. Only security access levels below the user's security level (e.g., “Level 1” in FIG. 19) would be available for the user to view and share. Furthermore, user interface buttons 1924 include options to request access to all models related to this document, or email review information to a stakeholder.

Granular dynamic info security tags (e.g., 1906 and 1922, and the like) are an important but optional element of a digital documentation system and its associated GUI. Model splicing and the IDEP system enable such granular dynamic information security tags. In some embodiments, the IDEP may use metadata of DE models or documents to cross-reference against authorizations, licenses, or regulations to update. In some embodiments, such granular dynamic information security tags (e.g., 1906 and 1922) are dynamic, and are refreshed ahead of any document updates to confirm the right authenticated user has the right authorized access to the digital artifacts and data to perform or view the updates.

For document organization and navigation, GUI 1900 features a document outline viewer 1930 on the left of FIG. 19, providing hyperlinked access to the document's headers and paragraphs and/or sections. Such document parts or subunits are obtained via document splicing. Within outline viewer 1930 and under a selected document part (e.g., section 1.1 Purpose), an expanded mini viewer 1932 shows additional metadata on this document part, including but not limited to, documentation part locator (e.g., file name “Heading_1_Purpose.xml:), linked DE model(s) (e.g., “Derived from 1.4-InterfaceControl . . . ”), a source IT domain (e.g., “defense.airplane.istari.app”), and the last update timestamp (e.g., “Last Update Jan. 28, 2024, 9:45 AM”), some tagged with an appropriate security level (e.g., “L1”). In some examples, if sections of a document contain content requiring a higher security level for viewing, the user may be presented with an option to request access. Were the user to request such access, an authorized user with access at a higher security level may be notified for their review. In other examples, if sections of a document contain content requiring a higher security level for viewing, such sections may not be shown for display, nor provide the user with any prompt for requesting access.

At the center of FIG. 19, a viewer panel 1940 displays the content of the ICD (e.g., a “clean” or “ready-to-print” version). Citation references or hyperlinks (e.g. superscript 1945, “[2]”) are provided to reference individual data fields (e.g., 1946, “149.6 kg”) with digital thread execution and transaction information or metadata (e.g., 1955, “Digital Thread Info List”) shown in a digital thread metadata pane 1950 on the right of GUI 1900. As indicated by item 1952 in digital thread metadata pane 1950, a digital thread “Link” is utilized to generate and/or update the live ICD document shown in viewer pane 1940, by linking a document model “requirements.mdzip” and a DE model Airplane.CATPART. Data field 1946 refers to the weight of a drone under a current design, and was last updated on Aug. 8, 2023 at 10:26 AM by executing the digital thread, with the weight value originating from DE part model Airplane.CATPART, owned by Orville Wright, with version ID s98jn9vbc9jns. Data field 1947 refers to a current cost of the drone, redacted from view. The user may request access via a request 1957 to link, access, or execute a relevant cost model.

As discussed in the context of FIGS. 11 and 12, the live ICD shown in FIG. 19 is enabled by DE model splicing, document model splicing, and model splice linking via digital thread script execution. The text shown in viewer panel 1940 is a snapshot view of the document's splice, which also provides the document outline and metadata shown in outline viewer 1930. Digital thread execution updates data fields in the live document or the document splice, to ensure that every document part is updated based on linked DE models with minimal manual intervention. Digital thread metadata as shown in metadata pane 1950 are added to the live document or the document splice to ensure the validity, legitimacy, or authenticity of the data values.

Although not shown explicitly in FIG. 19, in various embodiments, live document updates may be completed in real-time, within a maximum delay threshold, or on-demand, in a push or a pull configuration. In a push configuration, a model splice may send any occurring relevant updates to trigger the digital thread script to update the linked document splice or live document immediately or within a specified maximum time delay. In a pull configuration, a model splice may flag recent modifications until the digital thread script queries relevant DE models (via the model splice) or other associated digital threads for flagged modification, periodically or upon user-request. The digital thread script may regularly check relevant DE models (via their model splices) or associated digital threads, for modified data fields, by comparing the data found in the live DE document with regularly extracted model and digital thread data. If a discrepancy is found, the digital thread script may use the modified data to update the live DE document.

### Exemplary View of an Artifact

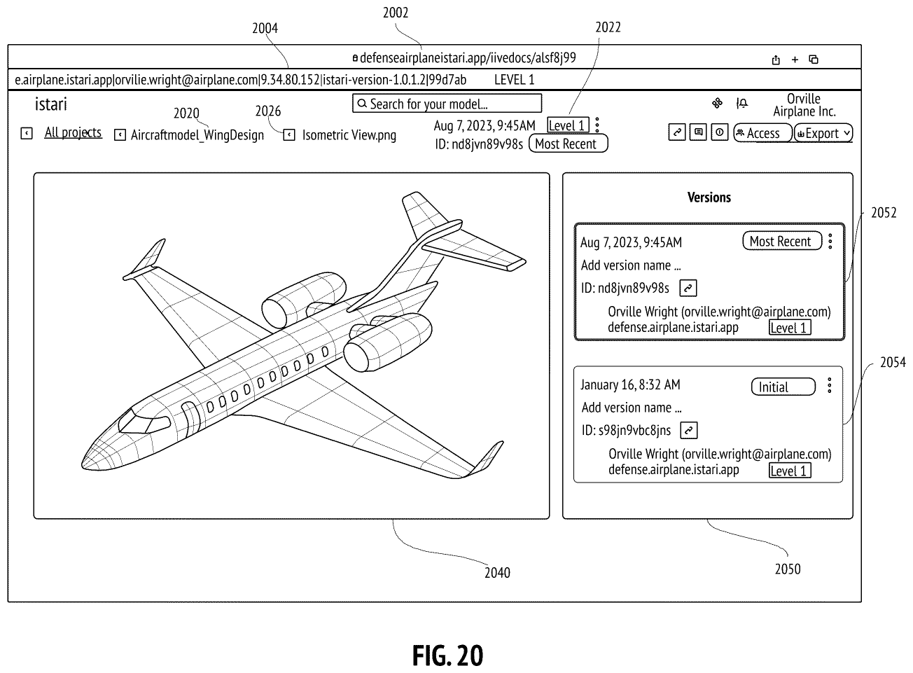

FIG. 20 shows a screenshot of GUI 1900 displaying a digital artifact with versioning information, in accordance with some embodiments of the present invention. Specifically, GUI 1900 provides the user of the IDEP with the ability to select a hyperlink (e.g., a hypertext, an icon, a low resolution view, etc.) in a live document and view in detail, linked digital artifacts that the user is authorized to access, with versioning information including an initial version, most recent version, and any intermediate versions. The artifact shown in FIG. 20 is a wireframe view of an airplane in .png format.

FIG. 20 shows a browser window header 2002 which includes a digital thread link for easy navigation. Below the header, a domain and security level banner 2004 displays the domain, platform software version, and security level, ensuring that users are aware of the domain they are operating in and the security protocols in place. A security level indicator displays the user's maximum security access level within the platform (e.g., “Level 1”). The security level indicator is interchangeably referred to as “info security tag”, “infosec tag” or “info sec tag”, herein.

The top menu of the GUI offers additional functionalities. A digital artifact name field 2020 displays the digital model or document's name, and may include its version. A digital artifact field 2026 displays the digital artifact's name. A digital artifact security level indicator 2022 displays a security level (e.g., “Level 1”) of the digital artifact being accessed. As discussed in the context of FIG. 19, an expandable security level menu may be provided for the user to select the digital artifact's target security access level (e.g., “view”), thus filtering only the parts of the digital artifact accessible through a given security level. In some embodiments, the user may use the digital artifact security level indicator 2022 to down-select the security level while sharing the digital artifact, thus sharing portions of the digital artifact that correspond to the specified security level. Only security access levels below the user's security level (e.g., “Level 1” in FIG. 20) would be available for the user to view and share.

In some embodiments, granular dynamic info security tags (e.g., 2022) are important elements enabled by model splicing within the IDEP. In some embodiments, the digital thread system in the IDEP uses metadata of DE models and/or DE documents to cross-reference against authorizations, licenses, or regulations to update. In some embodiments, the granular dynamic information security tags (e.g., 2022) are dynamic, and are refreshed ahead of any digital thread updates to confirm the right authenticated user has the right authorized access to the digital artifacts and data to perform or view the updates.

At the center of FIG. 20, a digital artifact viewer 2040 displays the digital artifact that the user is authorized to access at the right information security level. On the right of FIG. 20, a version pane 2050 exhibits the versioning history of the digital artifact within the digital thread. In this exemplary GUI shown in FIG. 20, a version card 2052 shows that the user is viewing the “Most Recent” version of a digital artifact (e.g., a wireframe view of an airplane). A version card 2054 shows an option to select an “Initial” version of the digital artifact. In some embodiments, all versions of an artifact that the user is allowed to view at his infosec level are accessible through a versions menu in the version pane 2050.

Revisions of digital artifacts are highly likely during the course of execution of a digital thread associated with complex DE tasks. The versioning GUI illustrated in FIG. 20 presents an example of how the IDEP can provide users with the ability to visualize linked digital artifacts and track versions with the right security controls and access controls.

Exemplary View of a Live Document Associated with a Digital Thread

FIG. 21 shows a screenshot 2100 of a live document associated with a digital thread within the IDEP, in accordance with some embodiments of the present invention. In various embodiments, a software-code-defined digital thread may be associated with a companion live document or magic document that provides explainability for the digital thread and allows an audit trail for the digital thread itself. That is, the magic document is linked to a “model splice” of the digital thread, and reflects changes to and actions on the digital thread. This magic document may be generated with the help of AI, elucidating the process through which the digital thread efficiently converts a user's intent into IDEP orchestration scripts that include relevant model splices, document splices, and splice functions. Specifically, a magic document associated with or accompanying a digital thread may explain how the digital thread implements a user intent, how the digital thread completes a DE tasks to achieve a specific objective, and may comprise pseudocode, scripts, data fields, natural language-based descriptions, and the like. When a digital thread script is executed to perform a DE task, the companion magic document may record the task completion for auditability. A digital thread script may comprise orchestration scripts in sequence. One or more corresponding magic documents for a digital thread may invoke a subset of data points and orchestration script examples as needed. In some embodiments, a script-generating ML model receiving as input pseudocode or detailed user instructions derived from a user's intent, may be trained on prior IDEP digital threads, models, documents, and optionally the IDEP platform API documentation. In addition to generating a digital thread (with orchestration scripts and comments), the script-generating ML model may also be configured to generate a magic doc that explains how the generated digital thread addresses the user intent.

In FIG. 21, similar to FIG. 19, a browser window header 2102 provides a document link for easy navigation. Correspondingly, a digital thread name field 2120 displays the associated digital thread's name, and may include its version. A digital thread security level indicator 2122 displays a security level (e.g., “Level 1”) of the digital thread being accessed. In one embodiment, using an expandable security level menu adjacent to the digital thread security level indicator 2122, the user may select the digital thread's target security access level “view”, thus filtering only the parts of the digital thread accessible through a given security level. In other embodiments, the user may use the digital thread security level indicator 2122 to down-select the security level while sharing the digital thread or an associated magic document for the digital thread, thus sharing portions of the digital thread that correspond to the specified security level. Only security access levels below the user's security level (e.g., “Level 1” in FIG. 21) would be available for the user to view and share. The user interface buttons 2124 include options to copy the digital thread link, open a comment section, access digital thread information, manage sharing access, and export the digital thread.

As discussed previously, digital threads are orchestration scripts that facilitate the selective exchange of data among documents and DE model files. A magic document associated with a digital thread records all the resources relevant to accomplishing a given DE task, including relevant sections of the orchestration script, relevant DE models and documents, as well as relevant context information and metadata.

For secure digital thread organization and navigation, the illustrative GUI of FIG. 21 features a digital thread outline viewer 2130 on the left, providing links to the digital thread's individual sections. At the center of FIG. 21, a section viewer 2140 displays the content of each secure digital thread section, including but not limited to, code blocks that may carry out individual subtasks within the orchestration script (e.g., Code Block 1), and text blocks that provide contextual and/or parametric information on linked DE models (e.g., Text Block 1). On the right of FIG. 21, a comment pane 2150 exhibits relevant comments from past viewers of the digital thread and the magic document, and may include functionalities for comment sharing and resolution.

Within section viewer 2140, exemplary code blocks are shown to list portions of the associated digital thread script and latest execution metadata including time stamps, user IDs, and execution status statements (e.g., “executed by Orville Wright at 6:06 am in 0.003 sec”, “executed by Orville Wright at 6:07 AM in 0.013 sec”, “The code was successfully executed”). A code block may be added to the magic document upon each user-requested execution of a portion of the digital thread. Similarly, an exemplary text block “Text Block 1” is also shown in FIG. 21, explaining, identifying, and listing DE models and documents that are interconnected by the underlying digital thread. Such a text block may be added to the magic document when a user uploads these DE models and documents, through manual selection or with AI-assistance in identifying relevant DE models and documents given an intended purpose for the digital thread. In FIG. 21, all blocks including code blocks and text blocks are ordered chronologically in execution time. In some embodiments, when a code section of the digital thread script is executed a second time, the magic document shown may include yet another corresponding code block, or update an existing code block with new execution metadata.

Within digital thread outline viewer 2130, a code or text block may be expanded in view. For example, expanded view 2132 of Text Block 1 shows linked DE models, related magic documents, and source IT domains, each tagged with an appropriate information security level (e.g., “L1” or “Level 1”). In some embodiments, the information security tag on a code block indicates a restriction on executing the code block. That is, a code block may only be run by an user entity with an equal or higher information security level. In some embodiments, the information security tag may indicate a viewing privilege, so the code block is only presented and viewable by an user entity with an equal or higher information security level.

In some embodiments, if sections of a secure digital thread contain content requiring a higher security level for viewing, the user may be presented with an option to request access. Were the user to request such access, an authorized user with access at a higher security level may be notified for their review. In other embodiments, if sections of a digital thread contain content requiring a higher security level for viewing, such sections may not be shown for display, nor will the user be provided with any prompt for requesting access.

### DE Model Splice and Document Splice Versioning

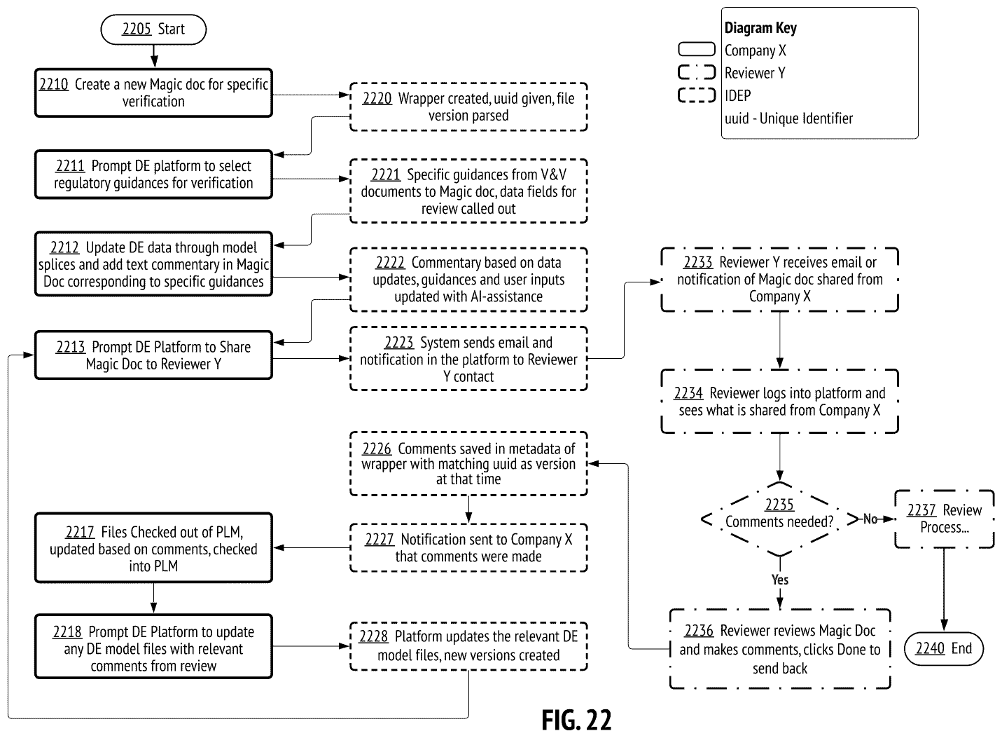

As another illustrative example, FIG. 22 is a flow diagram 2200 for an exemplary use case for DE model-to-document model linking and magic docs in a preliminary design review (PDR) process, according to some embodiments of the present invention. In systems engineering, the PDR establishes the allocated baseline (hardware, software, human/support systems) and underlying architectures to ensure that the system under review has a reasonable expectation of satisfying the requirements within the currently allocated budget and schedule.

In this illustrative implementation, a Company X utilizes the IDEP to facilitate PDR and collect feedback from a Reviewer Y. Upon initiation at step 2205, Company X creates a baseline magic document (“magic doc”) at a step 2210. Such a baseline magic document may be in the form of a document splice of a document template, to be further spliced with metadata and/or text commentary. This action leads to the assignment of a unique identifier (uuid) to the document splice by the IDEP at a step 2220. A file version may be further parsed during this initialization at the IDEP. Subsequently, the IDEP platform is prompted at step 2211 by Company X to select applicable regulatory guidance for verification from Verification and Validation (V&V) documents at step 2211. The specific guidelines are then integrated into the magic doc. Key data fields required for review may be called out or highlighted within this magic document.

In some embodiments, instead of having Company X creating the baseline magic doc directly, a collaboration board may be implemented by the IDEP, enabling users to add a list of artifacts that they wish to combine with a static document. The IDEP may then create the magic doc based on such user input data. Alternatively, the user may provide an intent for the IDEP to analyze with AI-assistance. The IDEP may recommend artifacts and/or static documents, which the user selects and accepts to create the magic doc with AI-assistance.

Next, for document preparation, the magic doc is updated at a step 2212 by splicing in DE data and adding textual commentary corresponding to these specific guidance, which may be further refined through AI-assisted updates at a step 2222 based on data changes, guidance, and user inputs received by the IDEP.

To initiate the review process, Company X prompts the IDEP at step 2213 to share the magic doc with Reviewer Y. The IDEP notifies Reviewer Y at step 2223 via email and platform notification about the availability of the magic doc for review. Reviewer Y receives the email or the notification of the shared magic doc at step 2233. In response, at a step 2234, Reviewer Y logs into the platform, accesses the shared magic doc, and begins the review process by adding comments directly within the magic doc at a step 2236, such comments are saved at a step 2226 in the metadata of the magic doc wrapper with a matching uuid, reflecting the version at that time. The IDEP then notifies Company X that comments were made at step 2227. Alternatively, if Reviewer Y is satisfied with the design and indicates no comments are needed for the underlying DE models at step 2235, the review process proceeds to the next phase at step 2237 and terminates at step 2240.

Post-review actions by Company X involve checking the DE model files out of the Product Lifecycle Management (PLM) system at a step 2217, updating them based on the comments, and checking them back in. In addition, the DE platform may be prompted at a step 2218 to update previously loaded DE model files or update/recreate existing DE model splices with relevant comments from the review, leading to the creation of new file versions on the platform at a step 2228. This structured process ensures that design verifications are thoroughly assessed against regulatory guidelines, incorporating feedback directly into the design model through a collaborative and traceable system.

In some embodiments, both Company X and Reviewer Y have direct access to the DE platform. The magic doc may be accessible by a user at Reviewer Y who is authenticated at the platform, and the magic doc may link the authenticated user to specific DE model files behind Company X's firewall.

In some embodiments, once a magic doc is created, it can be shared with stakeholders who do not have full access to the IDEP, but may have access to its GUI, or splice function scripts directly. It is important to note that DE model and document linking may be performed on the DE platform, or via other tools with a programming interface such as GOOGLE COLAB, which allows users to write and execute specific python codes through a browser.

### Documenting Digital Threads in a Technical Review Process

Yet another exemplary use case for DE model-to-document model linking via model splicing and document splicing is in major program review processes. The IDEP is designed to facilitate user interfaces that aid in decision-making based on dynamic data updates. This platform is particularly useful in contexts where users are tasked with making decisions based on rapidly changing data, for example, in multidisciplinary technical reviews.

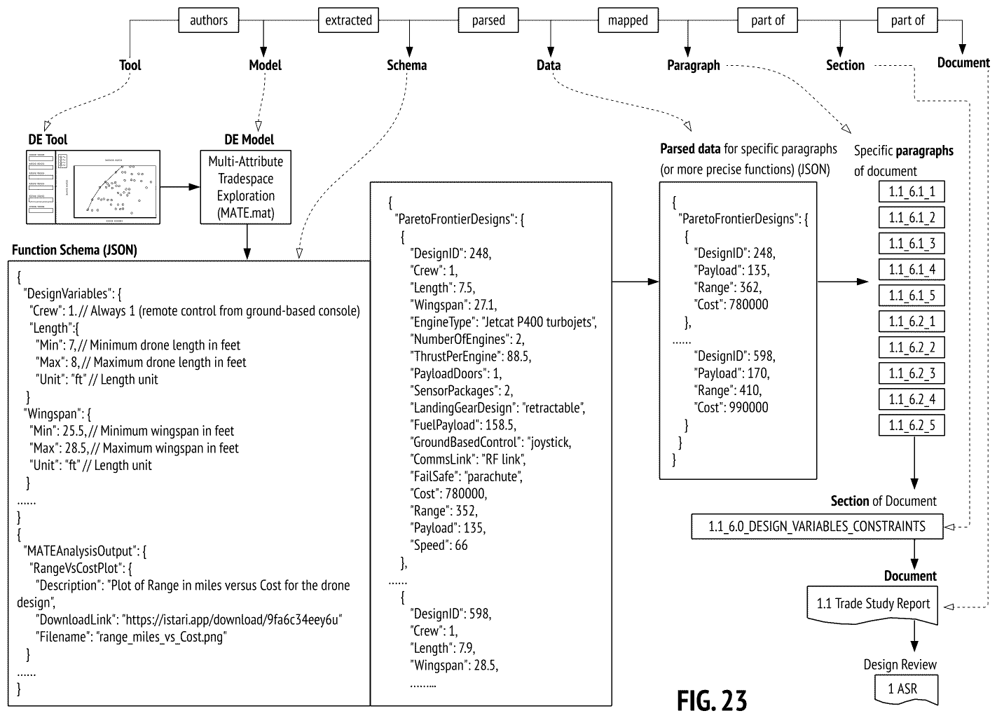

In particular, FIG. 23 illustrates the complex process of documenting digital threads in a technical review, in accordance with example embodiments of the present invention. The top portion of FIG. 23 illustrates the overall process beginning with various digital tools and digital model-type files. Each file may have its own related schema and contain data specific to the process under review. These files are then evaluated and properly connected to the specific paragraphs, sections, and documents that are requisite for technical review. That is, DE tools are used to author DE models, which may be spliced to extract input and output schemas. Model data parsed from the DE models according to the schemas may be mapped to paragraphs that make up sections of a DE review document.

The bottom portion of FIG. 23 zooms into the top portion, showing exemplary data generated in each step of the digital thread documentation process for an Alternative Systems Review (ASR). The ASR produces a draft performance specification for the preferred material solution, and typically takes place during a Materiel Solution Analysis phase of the DE lifecycle. The ASR aims to evaluate the technical maturity, feasibility, and risk of the preferred material solution, ensuring it meets the operational capability requirements outlined in an Initial Capabilities Document (ICD).

In FIG. 23, a DE tool is used to generated a DE model file, for example, a multi-attribute tradespace exploration (MATE) file (MATE.mat) that evaluates and compares different options or alternatives based on multiple attributes or criteria to identify the best possible solution that balances various factors or objectives. Model splicing the DE model file provides specific model data in a standardized function schema, from which specific data may be parsed, for use in specific paragraph(s) or in more precise functions in a trade study report. Such model data are then linked to a trade study report document splice to either parameter substitute in specific paragraphs of the document, or to generate such paragraphs or parts of paragraphs with AI-assistance. This can be done for more than direct variable/parameter substitution, but can also be done for more qualitative aspects. For example, while sections and paragraphs of a document may inherently form a hierarchical structure within a document splice, certain paragraphs may be grouped together based on specific contexts and/or their dependencies on the same or related DE models, such that paragraph updates in response to model data changes may occur for paragraphs within a group, in parallel, sequentially, or in any appropriate combination thereof.

Paragraphs are in turn combined into sections of the trade study report document, to be used in the ASR review. In this specific example, the final MATE report document comprises multiple sections, with section 6 being “Design Variables & Constraints”, subsection 6.1 being “Design Variables”, and subsection 6.2 being “Constraints.” As discussed in the context of FIG. 17, even well-written individual paragraphs may not necessarily form coherent sections or documents when combined. It is also inefficient to make API calls to the DE model for each single paragraph, when the same data has already been retrieved for other paragraphs. Therefore, when a DE model undergoes changes, all associated elements within the same document, such as titles, subtitles, paragraphs, sections, and subsections, need to be updated to reflect those changes. An iterative approach can be employed to update from the bottom-up, starting with a specific target paragraph, then its related sections, and finally the entire document. In the subsequent iteration, updates to paragraphs, sections, and the whole document may be carried out in sequence. For a generated document to be easily comprehensible, at least two iterations may be necessary.

AI-Assisted Document Generation from Linked DE Models

In this section, exemplary use cases of AI-assistance are discussed in generating DE documents from linked DE models.

In one example, an entirely new human-readable document (e.g., a design summary written in natural language) may be generated from a DE model, without a template, but under the assistance of a natural-language-processing AI module. For example, a CAD file of an airline seat design may be used to generate a design brief or a summary document describing different aspects of the airline seat design. This allows a human to easily understand the design without needing to interpret the CAD file directly, a significant advantage over the typical scenario where SMEs manually generate or type up documents from model files. Once the new document is created, it may be updated automatically and dynamically based on revisions to the linked DE model.

Specifically, one or more of the following process steps may be carried out to generate a DE document using AI-assistance:
LLM Training/Fine-Tuning: an AI model LLM-SRD may be trained based on few-shot learning of a generic LLM such as GPT4 or LLama2, and fine-tuned on examples of Systems Reference Documents (SRD).
Model Splicing: an input DE model (e.g., SysML model) may be spliced, and resulting API endpoints may be access via product function API calls (e.g., export requirement parameters in the SysML model).
Outline Generation via LLM: the API response may be added to a prompt for generating an outline of a System Requirements Document. In some embodiments, functional and non-functional requirements may be separated into different sections by the LLM.
Document Part Generation via LLM: the LLM-SRC fine-tuned previously may be prompted on a per-document-part basis, one section of the outline at a time, until all parts of the document have been drafted. A motivation behind this progressive approach is that LLMs typically have token limits on their input sequences, and prompt generation needs to take this limitation into account, but aggregating only subsets of DE model data that are relevant to a single document part.
Document Compilation: all parts are compiled into a complete draft.

Another example is AI-driven 1-click design summary generation, where an interesting summary of design files (e.g., STEP) may be generated to help a stakeholder or collaborator understand the design. In some embodiments, this design summary may be generated based on a design summary template via parameter substitution. In some embodiments, this design summary may be generated directly via an LLM trained on a set of models and their associated design summaries. For example, steps listed in bullet points above may be combined into 1-click execution. Alternatively, a design brief may be generated with AI-assistance via interactive questioning and answering. That is, juman-in-the-loop feedback can be used to refine an AI-generated document.

Some other exemplary use cases for DE model-to-document linking for new document generation include, but are not limited to, 1-click-model-to-patent-disclosure, 1-click-model-to-patent-draft, 1-click-model-to-claims, and 1-click-press-release, streamlining the processes of drafting patents or press releases regarding the modeled designs or systems.

LLM-based AI assistance has been discussed herein with reference to multiple examples. In various embodiments of the present invention, AI-assistance may be provided by individual software modules to perform one or more of the following functions. “AI-assistance” broadly refers to the use of any ML and/or AI algorithms, models, and techniques to assist in the completion of DE tasks. This list is non-exhaustive and non-limiting in nature.
Reviewing text-based documents (e.g., requirement documents) to identify and/or extract document data (e.g., identify design constraints and extract numeric parameters)
Updating a document or one or more parts of a document by data substitution
Generating a document or one or more parts of a document from a template by parameter substitution
Generating a natural-language-based document part from a prompt comprising DE model data
Reviewing DE model type and/or tool-specific documentations such as API libraries
Generating API scripts/function wrappers
Generating cross-tool orchestration or coordination scripts for use in digital threading and digital twinning of DE model splices and document splices
Enabling user-prompted customization and execution of the above functions. For example, generating user-defined API function wrappers, API scripts, or orchestration scripts, and re-formatting a generated document splice based on iterative user prompts
Generating digital threads (e.g., in an Directed Acyclic Graph (DAG) architecture) that link DE model splices and document splices in different configurations, using associated API and orchestration scripts created by the above functions
Suggesting DE models and document models for linking with an existing DE model, into a digital thread

Several generative AI models are within the scope of the present invention with an illustrative example being transformer-based Large Language Models (LLMs), such as Generative Pre-Trained (GPT) language models. In this disclosure, LLMs are considered as an illustrative example of generative AI models for implementing AI-assisted DE model and document model splicing and linking, but are not intended to be limiting in scope. Similarly, while there has been a recent explosion in LLM implementations and applications including BERT, ChatGPT (GPT-4), Claude, LaMDA, and LlaMA, with either proprietary or public licenses, discussion of any specific generative AI models in this present disclosure is for illustrative purposes only and is not intended to limit the scope of the invention.

Next, specific AI architecture design, training, fine-tune, and deployment approaches are discussed, for implementing AI-assisted document splice function generation and document generation from linked data sources.

### Machine Learning (ML) and Neural Networks

Machine learning (ML) algorithms are characterized by the ability to improve their performance at a task over time without being explicitly programmed with the rules to perform that task (i.e., learn). An ML model is the output generated when a ML algorithm is trained on data. As described herein, embodiments of the present invention use one or more artificial intelligence (AI) and ML algorithms to perform splice function generation, document updating, and/or document generation. Various exemplary ML algorithms are within the scope of the present invention. The following description describes illustrative ML techniques for implementing various embodiments of the present invention.

### Neural Networks

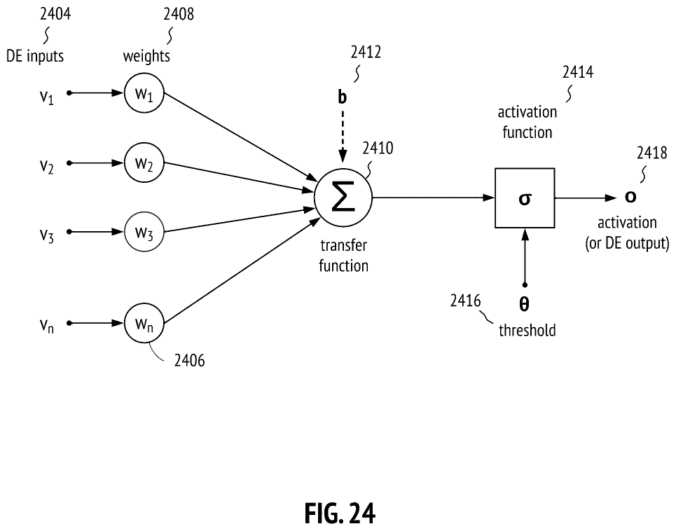

A neural network is a computational model comprising interconnected units called “neurons” that work together to process information. It is a type of ML algorithm that is particularly effective for recognizing patterns and making predictions based on complex data. Neural networks are widely used in various applications such as image and speech recognition and natural language processing, due to their ability to learn from large amounts of data and improve their performance over time. FIG. 24 describes neural network operation fundamentals, according to exemplary embodiments of the present invention.

FIG. 24 shows a single-layered neural network, also known as a single-layer perceptron. The operation of a single-layered neural network involves the following steps:
1. Input: Receiving a DE input vector v 2404 with elements vⱼ, with j∈[1, n] representing the j^{th} DE input, and where each element of the vector corresponds to an element 2406 in the input layer. For an exemplary neural network model (e.g., to implement a recommender engine 1236 in FIG. 12) trained to determine whether a splice function is to be recommended based on user input, the DE input vector v 2404 may take the form of a user prompt. A DE input can be a user prompt, a DE document, a DE model, DE program code, system data from the IDEP, and/or any useful form of data in digital engineering.
2. Transfer Function: Multiplying each element of the DE input vector by a corresponding weight wⱼ 2408. These weighted inputs are then summed together as the transfer function, yielding the net input to the activation function

$${\sum }_{j = 1}^{n} {v}_{j} \cdot {w}_{j} 2410.$$

Each neuron in a neural network may have a bias value 2412, which is added to the weighted sum of the inputs to that neuron. Both the weights and bias values are learned during the training process. The purpose of the bias is to provide every neuron with a trainable constant value that can help the model fit the data better. With biases, the net input to the activation function

$${\sum }_{j = 1}^{n} \{ {v}_{j} \cdot {w}_{j} \} + b .$$

In the exemplary neural network model described above (e.g., to implement a recommender engine 1236), the value of the transfer function 2410 may represent the probability that the target splice function will be recommended.
3. Activation Function: Passing the net input through an activation function 2414. The activation function σ determines the activation value o 2418, which is the output of the neuron. It is typically a non-linear function such as a sigmoid or ReLU (Rectified Linear Unit) function. The threshold θ 2416 of the activation function is a value that determines whether a neuron is activated or not. In some activation functions, such as the step function, the threshold is a specific value. If the net input is above the threshold, the neuron outputs a constant value, and if it's below the threshold, it outputs a zero value. In other activation functions, such as the sigmoid or ReLU (Rectified Linear Unit) functions, the threshold is not a specific value but rather a point of transition in the function's curve.
   In the exemplary neural network model described above (e.g., to implement a recommender engine 1236), the activation function σ 2414 may be a ReLU that is activated at a threshold θ 2416 representing the minimum probability for the target splice function to be recommended. Hence, the activation function 2414 will yield a positive recommendation when the recommendation likelihood exceeds the threshold θ 2416.
4. Output: The activation value o 2418 is the output of the activation function. This value is what gets passed on to the next layer in the network or becomes the final DE output in the case of the last layer. In the exemplary neural network model described above (e.g., to implement a recommender engine 1236), the activation value o 2418 is a DE output that is a boolean or binary parameter taking a positive value when the target splice function is to be recommended and a negative value otherwise. A DE output can be a DE document, a DE model, DE program code, or any useful form of data in digital engineering.

In the exemplary neural network discussions of FIG. 24, examples are provided with respect to a particular recommender engine implementation using neural networks. Analogous approaches can be used to implement the generator engine and any other NN-based components of the systems and subsystems described herein.

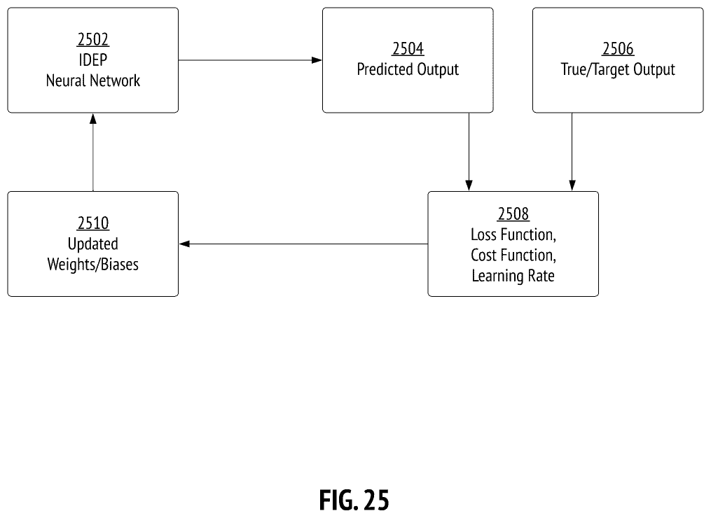

FIG. 25 shows an overview of an IDEP neural network training process, according to exemplary embodiments of the present invention.

The training of the IDEP neural network involves repeatedly updating the weights and biases 2510 of the network to minimize the difference between the predicted output 2504 and the true or target output 2506, where the predicted output 2504 is the result produced by the network when a set of inputs from a dataset is passed through it. The predicted output 2504 of an IDEP neural network 2502 corresponds to the DE output 2418 of the final layer of the neural network. The true or target output 2506 is the true desired result. The difference between the predicted output and the true output is calculated using a loss function 2508, which quantifies the error made by the network in its predictions.

The loss function is a part of the cost function 2508, which is a measure of how well the network is performing over the whole dataset. The goal of training is to minimize the cost function 2508. This is achieved by iteratively adjusting the weights and biases 2510 of the network in the direction that leads to the steepest descent in the cost function. The size of these adjustments is determined by the learning rate 2508, a hyperparameter that controls how much the weights and biases change in each iteration. A smaller learning rate means smaller changes and a slower convergence towards the minimum of the cost function, while a larger learning rate means larger changes and a faster convergence, but with the risk of overshooting the minimum.

For an IDEP neural network model 2502 based on the exemplary neural network model (e.g., to implement a recommender engine 1236) discussed above in the context of FIG. 24, and trained to determine whether a target splice function is to be recommended based on user instructions:
the weights and biases 2510 are the IDEP neural network's hyperparameters that get updated at each iteration of the training process, as discussed in the context of FIG. 24,
the predicted output 2504 is the binary prediction on whether the target splice function is to be recommended based on a sample user prompt, (or a normalized score ranking prioritizing the order of splice functions to be displayed to the user),
the true/target output 2506 is the correct decision (i.e., sample ground truth output) on whether to recommend the target data based on the sample user prompt,
the loss function 2508 is the difference between the evaluation and the true output (e.g., a binary error indicating whether the IDEP neural network's decision was correct),
the cost function 2508 is the average of all errors over a training dataset including sample user prompts and corresponding binary recommendations on the target splice function, and
the learning rate 2508 is the rate at which the cost function 2508 in consecutive training epochs approaches a pre-specified tolerable cost function.

Neural network training combines the processes of forward propagation and backpropagation. Forward propagation is the process where the input data is passed through the network from the input layer to the output layer. During forward propagation, the weights and biases of the network are used to calculate the output for a given input. Backpropagation, on the other hand, is the process used to update the weights and biases 2510 of the network based on the error (e.g., cost function) 2508 of the output. After forward propagation through the IDEP neural network 2502, the output 2504 of the network is compared with true output 2506, and the error 2508 is calculated. This error is then propagated back through the network, starting from the output layer and moving towards the input layer. The weights and biases 2510 are adjusted in a way that minimizes this error. This process is repeated for multiple iterations or epochs until the network is able to make accurate predictions.

The neural network training method described above, in which the network is trained on a labeled dataset (e.g., sample pairs of input user prompts and corresponding output recommendations), where the true outputs are known, is called supervised learning. In unsupervised learning, the network is trained on an unlabeled dataset, and the goal is to discover hidden patterns or structures in the data. The network is not provided with the true outputs, and the training is based on the intrinsic properties of the data. Furthermore, reinforcement learning is a type of learning where an agent learns to make decisions from the rewards or punishments it receives based on its actions. Although reinforcement learning does not typically rely on a pre-existing dataset, some forms of reinforcement learning can use a database of past actions, states, and rewards during the learning process. Any neural network training method that uses a labeled dataset is within the scope of the methods and systems described herein, as is clear from the overview below.

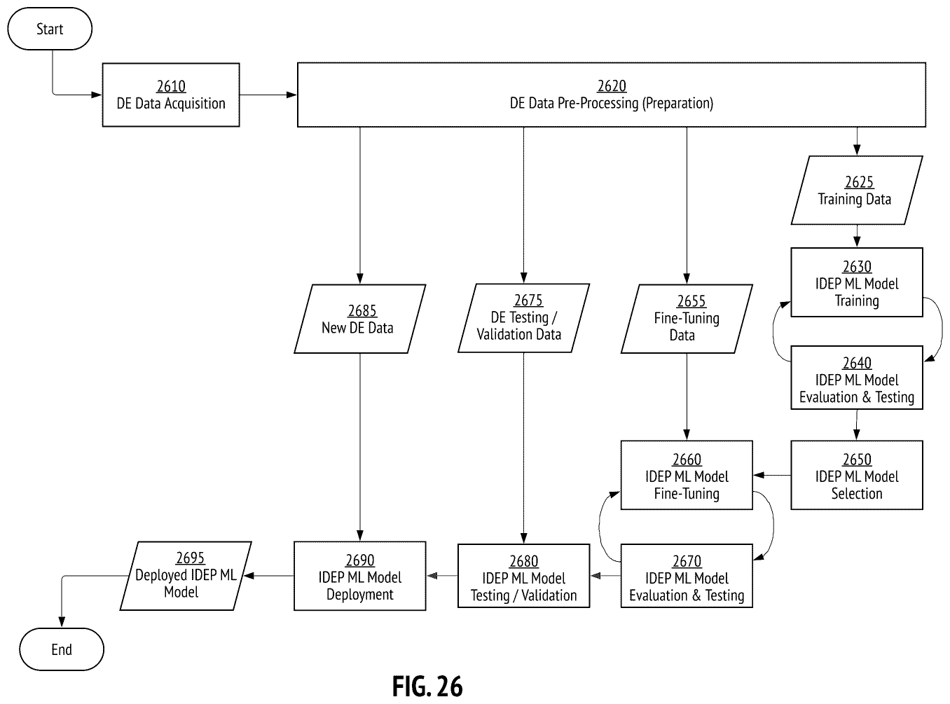

FIG. 26 provides additional details on the training process or an IDEP machine learning model, according to exemplary embodiments of the present invention.

### Transformer Model Architecture

The transformer architecture is a neural network design that was introduced in the paper “Attention is All You Need” by Vaswani et al. published in June 2017 (available at arxiv (dot) org), and incorporated herein by reference as if fully set forth herein. Large Language Models (LLMs) heavily rely on the transformer architecture.

The architecture (see FIG. 1 in Vaswani et al.) is based on the concept of “attention”, allowing the model to focus on different parts of the input sequence when producing an output. Transformers consist of an encoder and a decoder. The encoder processes the input data and the decoder generates the output. Each of these components is made up of multiple layers of self-attention and point-wise, fully connected layers.

The layers of self-attention in the transformer model allow it to weigh the relevance of different parts of the input sequence when generating an output, thereby enabling it to capture long-range dependencies in the data. On the other hand, the fully connected layers are used for transforming the output of the self-attention layers, adding complexity and depth to the model's learning capability.

The transformer model is known for its ability to handle long sequences of data, making it particularly effective for tasks such as machine translation and text summarization. In the transformer architecture, positional encoding is used to give the model information about the relative positions of the words in the input sequence. Since the model itself does not have any inherent sense of order or sequence, positional encoding is a way to inject some order information into the otherwise order-agnostic attention mechanism.

### The Embeddings Vector Space

In the context of neural networks, tokenization refers to the process of converting the input and output spaces, such as natural language text or programming code, into discrete units or “tokens”. This process allows the network to effectively process and understand the data, as it transforms complex structures into manageable, individual elements that the model can learn from and generate.

In the training of neural networks, embeddings serve as a form of distributed word representation that converts discrete categorical variables (i.e., tokens) into a continuous vector space (i.e., embedding vectors). This conversion process captures the semantic properties of tokens, enabling tokens with similar meanings to have similar embeddings. These embeddings provide a dense representation of tokens and their semantic relationships. Embeddings are typically represented as vectors, but may also be represented as matrices or tensors.

The input of a transformer typically requires conversion from an input space (e.g., the natural language token space) to an embeddings space. This process, referred to as “encoding”, transforms discrete inputs (tokens) into continuous vector representations (embeddings). This conversion is a prerequisite for the transformer model to process the input data and understand the semantic relationships between tokens (e.g., words). Similarly, the output of a transformer typically requires conversion from the embeddings space to an output space (e.g., natural language tokens, programming code tokens, etc.), in a process referred to as “decoding”. Therefore, the training of a neural network and its evaluation (i.e., its use upon deployment) both occur within the embeddings space.

In this document, the processes of tokenization, encoding, decoding, and de-tokenization may be assumed. In other words, the processes described below occur in the “embeddings space”. Hence, while the tokenization and encoding of training data and input prompts may not be represented or discussed explicitly, they may nevertheless be implied. Similarly, the decoding and de-tokenization of neural network outputs may also be implied.

### Training and Fine-Tuning Machine Learning (ML) Modules

FIG. 26 is an illustrative flow diagram showing the different phases and datasets involved in training an IDEP ML model, according to exemplary embodiments of the present invention.

The training process starts at step 2610 with DE data acquisition, retrieval, assimilation, or generation. At step 2620, acquired DE data are pre-processed, or prepared. At step 2630, the IDEP ML model is trained using training data 2625. At step 2640, the IDEP ML model is evaluated, validated, and tested, and further refinements to the IDEP ML model are fed back into step 2630 for additional training. Once its performance is acceptable, at step 2650, optimal IDEP ML parameters are selected.

Training data 2625 is a dataset containing multiple instances of system inputs (e.g., user inputs, user prompts, input DE documents and/or templates, etc.) and correct outcomes (e.g., data fields, document sections, documents, specific splice function scripts etc.). It trains the IDEP ML model to optimize the performance for a specific target task, such as the prediction of a specific target output data field within a specific target document. In FIG. 26, training data 2625 may also include subsets for validating and testing the IDEP ML model, as part of the training iterations 2630 and 2640. For an NN-based ML model, the quality of the output may depend on (a) NN architecture design and hyperparameter configurations, (b) NN coefficient or parameter optimization, and (c) quality of the training data set. These components may be refined and optimized using various methods. For example, training data 2625 may be expanded via a document database augmentation process.

In some embodiments, an additional fine-tuning 2660 phase including iterative fine-tuning 2660 and evaluation, validation, and testing 2670 steps, is carried out using fine-tuning data 2655. Fine-tuning in machine learning is a process that involves taking a selected 2650 pre-trained model and further adjusting or “tuning” its parameters to better suit a specific task or fine-tuning dataset 2655. This technique is particularly useful when dealing with deep learning models that have been trained on large, general training datasets 2625 and are intended to be applied to more specialized tasks or smaller datasets. The objective is to leverage the knowledge the model has already acquired during its initial training (often referred to as transfer learning) and refine it so that the model performs better on a more specific task at hand.

The fine-tuning process typically starts with a model that has already been trained on a large benchmark training dataset 2625, such as ImageNet (available at image-net (dot) org) for image recognition tasks. The model's existing weights, which have been learned from the original training, serve as the starting point. During fine-tuning, the model is trained further on a new fine-tuning dataset 2655, which may contain different classes or types of data than the original training set. This additional training phase allows the model to adjust its weights to better capture the characteristics of the new fine-tuning dataset 2655, thereby improving its performance on the specific task it is being fine-tuned for.

In some embodiments, additional test and validation 2680 phases are carried out using DE test and validation data 2675. Testing and validation of a ML model both refer to the process of evaluating the model's performance on a separate dataset 2675 that was not used during training, to ensure that it generalizes well to new unseen data. Validation of a ML model helps to prevent overfitting by ensuring that the model's performance generalizes beyond the training data.

While the validation phase is considered part of ML model development and may lead to further rounds of fine-tuning, the testing phase is the final evaluation of the model's performance after the model has been trained and validated. The testing phase provides an unbiased assessment of the final model's performance that reflects how well the model is expected to perform on unseen data, and is usually carried out after the model has been finalized to ensure the evaluation is unbiased.

Once the IDEP ML model is trained 2630, selected 2650, and optionally fine-tuned 2660 and validated/tested 2680, the process ends with the deployment 2690 of the IDEP ML model. Deployed IDEP ML models 2695 usually receive new DE data 2685 that was pre-processed 2680.

In machine learning, data pre-processing 2620 is tailored to the phase of model development. During model training 2630, pre-processing involves cleaning, normalizing, and transforming raw data into a format suitable for learning patterns. For fine-tuning 2660, pre-processing adapts the data to align with the distribution of the specific targeted task, ensuring the pre-trained model can effectively transfer its knowledge. Validation 2680 pre-processing mirrors that of training to accurately assess model generalization without leakage of information from the training set. Finally, in deployment 2690, pre-processing ensures real-world data matches the trained model's expectations, often involving dynamic adjustments to maintain consistency with the training and validation stages.

### Machine Learning Algorithms

Various exemplary ML algorithms are within the scope of the present invention. Such machine learning algorithms include, but are not limited to, random forest, nearest neighbor, decision trees, support vector machines (SVM), Adaboost, gradient boosting, Bayesian networks, evolutionary algorithms, various neural networks (including deep learning networks (DLN), convolutional neural networks (CNN), and recurrent neural networks (RNN)), etc.

ML modules based on transformers and Large Language Models (LLMs) are particularly well suited for the tasks described herein. The online article “Understanding Large Language Models—A Transformative Reading List”, by S. Raschka (posted Feb. 7, 2023, available at sebastianraschka(dot)com), describes various LLM architectures that are within the scope of the methods and systems described herein, and is hereby incorporated by reference in its entirety herein as if fully set forth herein.

The input to each of the listed ML modules is a feature vector comprising the input data described above for each ML module. The output of the ML module is a feature vector comprising the corresponding output data described above for each ML module.

Prior to deployment, each of the ML modules listed above may be trained on one or more respective sample input datasets and on one or more corresponding sample output datasets. The input and output training datasets may be generated from a database containing a history of input instances and output instances or may be generated synthetically by subject matter experts.

### ALTERNATIVE EMBODIMENTS

Various alternative embodiments are envisioned to be within the scope of the present invention, as would be apparent from reading the disclosure.

For example, other embodiments include “splicing” of digital documents without incorporating data from model splices. For example, embodiments include enabling API or SDK endpoint access to subcomponents of documents for purposes other than splicing with model data, such as for document sharing, document collaborating, and the like. Yet other embodiments include model splicing of digital model files without incorporating the data into document splices.

Other embodiments and sub-combinations are also envisioned to be within the scope of the present invention. Features as set out for other embodiments or aspects may apply equally to the various embodiments and aspects described herein.

According to another aspect or in one embodiment, a non-transitory physical storage medium storing program code is provided. The program code is executable by a hardware processor. The hardware processor when executing the program code causes the hardware processor to execute a computer-implemented process for generating a sharable digital document. The program code includes code that may receive a static document file comprising human-readable data. The program code may comprise code to parse the static document file into a plurality of subunits. The program code may comprise code to generate a sharable document splice of the static document file. The sharable document splice may comprise access to a subset of the plurality of subunits. The access may be provided through an Application Programming Interface (API) or Software Development Kit (SDK) endpoint for each subunit in the subset.

One embodiment may further include program code to update a given subunit of the sharable document splice based on a digital artifact from an input digital model representation.

One embodiment may further include program code to receive a user feedback on a generated document part and to update the generated document part based on the user feedback.

In one embodiment, the program code to generate a sharable document splice may further comprise code to generate at least one external, commonly-accessible document splice function that enables external access to a given subunit in the subset through the given subunit's API or SDK endpoint. The at least one external, commonly-accessible document splice function may provide a unified programming interface to sharable document splices.

In one embodiment, the static digital document may be machine-readable. The sharable digital document may be human-readable. Finally, the human-readable data may comprise at least one of textual data, tabular data, graphical data, image data, and hypertext data.

One embodiment may further include program code to determine whether an information security tag that indicates a level of access to the subunit is met or exceeded by a user for each subunit in the subset of the plurality of subunits. One embodiment may further include program code to add the subunit's API or SDK endpoint to the sharable digital document in response to determining that the information security tag is met or exceeded.

One embodiment may further include program code to provide a prompt to the user for accessing the subunit in response to determining that the information security tag is not met or exceeded.

In one embodiment, the static document file may be a document template.

In one embodiment, each of the plurality of subunits may be selected from the group consisting of a title, a table of contents, an index, a chapter, a subsection, a paragraph, a sentence, a word, a sheet, a page, a table, a chart, a graph, an image, a hypertext link, and sub-parts thereof.

One embodiment may further include program code to update the sharable digital document based on another sharable document splice or another live digital document.

### Exemplary System Architecture

An exemplary embodiment of the present disclosure may include one or more servers (management computing entities), one or more networks, and one or more clients (user computing entities). Each of these components, entities, devices, and systems (similar terms used herein interchangeably) may be cloud-based, and in direct or indirect communication with, for example, one another over the same or different wired or wireless networks. All of these devices, including servers, clients, and other computing entities or nodes may be run internally by a customer (in various architecture configurations including private cloud), internally by the provider of the IDEP (in various architecture configurations including private cloud), and/or on the public cloud.

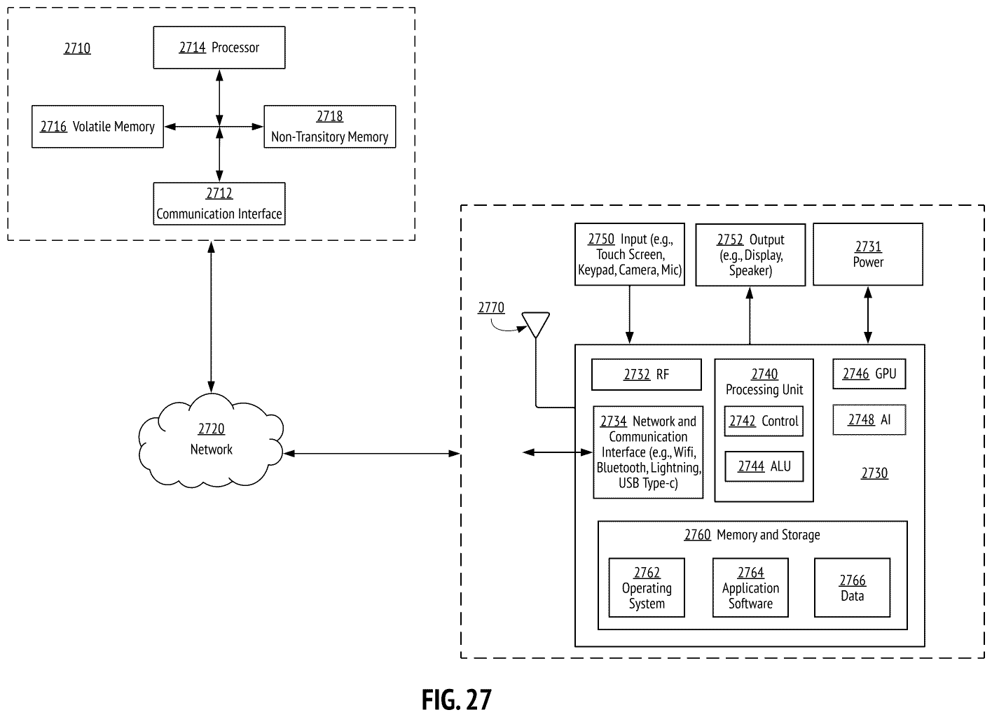

FIG. 27 provides illustrative schematics of a server (management computing entity) 2710 connected via a network 2720 to a client (user computing entity) 2730 used for documentation within an interconnected digital engineering platform (IDEP), according to some embodiments of the present invention. While FIG. 27 illustrates the various system entities as separate, standalone entities, the various embodiments are not limited to this particular architecture. Additionally, the terms “client device”, “client computing entity”, “edge device”, and “edge computing system” are equivalent and are used interchangeably herein.

### Exemplary Management Computing Entity

An illustrative schematic is provided in FIG. 27 for a server or management computing entity 2710. In general, the terms computing entity, computer, entity, device, system, and/or similar words used herein interchangeably may refer to, for example, one or more cloud servers, computers, computing entities, desktop computers, mobile phones, tablets, phablets, notebooks, laptops, distributed systems, gaming consoles, watches, glasses, iBeacons, proximity beacons, key fobs, radio frequency identification (RFID) tags, earpieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, crawling, displaying, storing, determining, creating/generating, monitoring, evaluating, and/or comparing (similar terms used herein interchangeably). In one embodiment, these functions, operations, and/or processes can be performed on data, content, and/or information (similar terms used herein interchangeably), as they are used in a digital engineering process.

In one embodiment, management computing entity 2710 may be equipped with one or more communication interfaces 2712 for communicating with various computing entities, such as by exchanging data, content, and/or information (similar terms used herein interchangeably) that can be transmitted, received, operated on, processed, displayed, stored, and/or the like. For instance, management computing entity 2710 may communicate with one or more client computing devices such as 2730 and/or a variety of other computing entities. Network or communications interface 2712 may support various wired data transmission protocols including, but not limited to, Fiber Distributed Data Interface (FDDI), Digital Subscriber Line (DSL), Ethernet, Asynchronous Transfer Mode (ATM), frame relay, and data over cable service interface specification (DOCSIS). In addition, management computing entity 2710 may be capable of wireless communication with external networks, employing any of a range of standards and protocols, including but not limited to, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High-Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

As shown in FIG. 27, in one embodiment, management computing entity 2710 may include or be in communication with one or more processors 2714 (also referred to as processors and/or processing circuitry, processing elements, and/or similar terms used herein interchangeably) that communicate with other elements within management computing entity 2710, for example, via a bus. As will be understood, processor 2714 may be embodied in a number of different ways. For example, processor 2714 may be embodied as one or more complex programmable logic devices (CPLDs), microprocessors, multi-core processors, co-processing entities, application-specific instruction-set processors (ASIPs), graphical processing units (GPUs), microcontrollers, and/or controllers. The term circuitry may refer to an entire hardware embodiment or a combination of hardware and computer program products. Thus, processor 2714 may be embodied as integrated circuits (ICs), application-specific integrated circuits (ASICs), field-programmable gate arrays (FPGAs), programmable logic arrays (PLAs), hardware accelerators, other circuitry, and/or the like. As will therefore be understood, processor 2714 may be configured for a particular use or configured to execute instructions stored in volatile or non-volatile (or non-transitory) media 2716 and 2718, or otherwise accessible to processor 2714. As such, whether configured by hardware or computer program products, or by a combination thereof, processor 2714 may be capable of performing steps or operations according to embodiments of the present disclosure when configured accordingly.

In one embodiment, management computing entity 2710 may further include or be in communication with non-transitory memory 2718 (also referred to as non-volatile media, non-volatile storage, non-transitory storage, physical storage media, memory, memory storage, and/or memory circuitry—similar terms used herein interchangeably). In one embodiment, the non-transitory memory or storage may include one or more non-transitory memory or storage media, including but not limited to hard disks, ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like. As will be recognized, the non-volatile (or non-transitory) storage or memory media may store cloud storage buckets, databases, database instances, database management systems, data, applications, programs, program modules, scripts, source code, object code, byte code, compiled code, interpreted code, machine code, executable instructions, and/or the like. The term database, database instance, and/or database management system (similar terms used herein interchangeably) may refer to a collection of records or data that is stored in a computer-readable storage medium using one or more database models, such as a hierarchical database model, network model, relational model, entity-relationship model, object model, document model, semantic model, graph model, and/or the like.

In one embodiment, management computing entity 2710 may further include or be in communication with volatile memory 2716 (also referred to as volatile storage, memory, memory storage, memory and/or circuitry-similar terms used herein interchangeably). In one embodiment, the volatile storage or memory may also include one or more volatile storage or memory media, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, processor 2714. Thus, the cloud storage buckets, databases, database instances, database management systems, data, applications, programs, program modules, scripts, source code, object code, byte code, compiled code, interpreted code, machine code, executable instructions, and/or the like may be used to control certain aspects of the operation of management computing entity 2710 with the assistance of processor 2714 and an operating system.

Although not shown, management computing entity 2710 may include or be in communication with one or more input elements, such as a keyboard input, a mouse input, a touch screen/display input, motion input, movement input, audio input, pointing device input, joystick input, keypad input, and/or the like. Management computing entity 2710 may also include or be in communication with one or more output elements, also not shown, such as audio output, visual output, screen/display output, motion output, movement output, spatial computing output (e.g., virtual reality or augmented reality), and/or the like.

As will be appreciated, one or more of the components of management computing entity 2710 may be located remotely from other management computing entity components, such as in a distributed system. Furthermore, one or more of the components may be combined and additional components performing functions described herein may be included in management computing entity 2710. Thus, management computing entity 2710 can be adapted to accommodate a variety of needs and circumstances. As will be recognized, these architectures and descriptions are provided for exemplary purposes only and are not limited to the various embodiments.

### Exemplary User Computing Entity

A user may be a human individual, a company, an organization, an entity, a department within an organization, a representative of an organization and/or person, an artificial user such as algorithms, artificial intelligence, or other software that interfaces, and/or the like. FIG. 27 further provides an illustrative schematic representation of a client user computing entity 2730 that may be used in conjunction with embodiments of the present disclosure. In various embodiments, computing device 2730 may be a general-purpose computing device with dedicated modules for performing digital engineering-related tasks. It may alternatively be implemented in the cloud, with logically and/or physically distributed architectures.

As shown in FIG. 27, user computing entity 2730 may include a power source 2731, an antenna 2770, a radio transceiver 2732, a network and communication interface 2734, and a processor unit 2740 that provides signals to and receives signals from the network and communication interface. The signals provided to and received may include signaling information in accordance with air interface standards of applicable wireless systems. In this regard, user computing entity 2730 may be capable of operating with one or more air interface standards, communication protocols, modulation types, and access types. More particularly, user computing entity 2730 may operate in accordance with any of a number of wireless communication standards and protocols, such as those described above with regard to management computing entity 2710. Similarly, user computing entity 2730 may operate in accordance with multiple wired communication standards and protocols, such as those described above with regard to management computing entity 2710.

Via these communication standards and protocols, user computing entity 2730 may communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). User computing entity 2730 may also download changes, add-ons, and updates, for instance, to its firmware, software (e.g., including executable instructions, applications, program modules), and operating system.

In some implementations, processing unit 2740 may be embodied in several different ways. For example, processing unit 2740 may be embodied as one or more complex programmable logic devices (CPLDs), microprocessors, multi-core processors, co-processing entities, application-specific instruction-set processors (ASIPs), graphical processing units (GPUs), microcontrollers, and/or controllers. Further, processing unit 2740 may be embodied as one or more other processing devices or circuitry. The term circuitry may refer to an entirely hardware embodiment or a combination of hardware and computer program products. Thus, processing unit 2740 may be embodied as integrated circuits, application specific integrated circuits (ASICs), field programmable gate arrays (FPGAs), programmable logic arrays (PLAs), hardware accelerators, other circuitry, and/or the like. As will therefore be understood, processing unit 2740 may be configured for a particular use or configured to execute instructions stored in volatile or non-volatile media or otherwise accessible to the processing unit. As such, whether configured by hardware or computer program products, or by a combination thereof, processing unit 2740 may be capable of performing steps or operations according to embodiments of the present invention when configured accordingly.

In some embodiments, processing unit 2740 may comprise a control unit 2742 and a dedicated arithmetic logic unit (ALU) 2744 to perform arithmetic and logic operations. In some embodiments, user computing entity 2730 may comprise a graphics processing unit (GPU) 2746 for specialized parallel processing tasks, and/or an artificial intelligence (AI) module or accelerator 2748, also specialized for applications including artificial neural networks and machine learning. In some embodiments, processing unit 2740 may be coupled with GPU 2746 and/or AI accelerator 2748 to distribute and coordinate digital engineering related tasks.

In some embodiments, computing entity 2730 may include a user interface, comprising an input interface 2750 and an output interface 2752, each coupled to processing unit 2740. User input interface 2750 may comprise any of a number of devices or interfaces allowing computing entity 2730 to receive data, such as a keypad (hard or soft), a touch display, a mic/speaker for voice/speech/conversation, a camera for motion or posture interfaces, and appropriate sensors for spatial computing interfaces. User output interface 2752 may comprise any of a number of devices or interfaces allowing computing entity 2730 to provide information to a user, such as through the touch display, or a speaker for audio outputs. In some embodiments, output interface 2752 may connect computing entity 2730 to an external loudspeaker or projector, for audio and/or visual output. In some embodiments, user interfaces 2750 and 2752 integrate multimodal data in an interface that caters to human users. Some examples of human interfaces include a dashboard-style interface, a workflow-based interface, conversational interfaces, and spatial-computing interfaces. As shown in FIG. 5, computing entity 2730 may also support bot/algorithmic interfaces such as code interfaces, text-based API interfaces, and the like.

User computing entity 2730 can also include volatile and/or non-volatile storage or memory 2760, which can be embedded and/or may be removable. For example, the non-volatile or non-transitory memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile (or non-transitory) storage or memory 2760 may store an operating system 2762, application software 2764, data 2766, databases, database instances, database management systems, data, applications, programs, program modules, scripts, source code, object code, byte code, compiled code, interpreted code, machine code, executable instructions, and/or the like to implement functions of user computing entity 2730. As indicated, this may include a user application that is resident on the entity or accessible through a browser or other user interface for communicating with management computing entity 2710 and/or various other computing entities.

In some embodiments, user computing entity 2730 may include one or more components or functionalities that are the same or similar to those of management computing entity 2710, as described in greater detail above. As will be recognized, these architectures and descriptions are provided for exemplary purposes only and are not limited to the various embodiments.

In some embodiments, computing entities 2710 and/or 2730 may communicate to external devices like other computing devices and/or access points to receive information such as software or firmware, or to send information from the memory of the computing entity to external systems or devices such as servers, computers, smartphones, and the like.

In some embodiments, two or more computing entities such as 2710 and/or 2730 may establish connections using a network such as 2720 utilizing any of the networking protocols listed previously. In some embodiments, the computing entities may use network interfaces such as 2712 and 2734 to communicate with each other, such as by communicating data, content, information, and/or similar terms used herein interchangeably that can be transmitted, received, operated on, processed, displayed, stored, and/or the like.

### Additional Hardware & Software Implementation Details

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The terms “processor”, “computer,” “data processing apparatus”, and the like encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, code, program code, and the like) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto optical disks, or optical disks. However, a computer need not have such devices. Devices suitable for storing computer program instructions and information/data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a backend component, e.g., as an information/data server, or that includes a middleware component, e.g., an application server, or that includes a frontend component, e.g., a client computer having a graphical user interface or a web browser through which a user can interact with an implementation of the subject matter described herein, or any combination of one or more such back end, middleware, or front end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship with each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any embodiment or of what may be claimed, but rather as descriptions of features specific to particular embodiments. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments of the present invention, the entire system can be implemented and offered to the end-users and operators over the Internet, in a so-called cloud implementation. No local installation of software or hardware would be needed, and the end-users and operators would be allowed access to the systems of the present invention directly over the Internet, using either a web browser or similar software on a client, which client could be a desktop, laptop, mobile device, and so on. This eliminates any need for custom software installation on the client side and increases the flexibility of delivery of the service (software-as-a-service), and increases user satisfaction and case of use. Various business models, revenue models, and delivery mechanisms for the present invention are envisioned, and are all to be considered within the scope of the present invention.

In general, the method executed to implement the embodiments of the invention, may be implemented as part of an operating system or a specific application, component, program, object, module, or sequence of instructions referred to as “program code,” “computer program(s)”, “computer code(s),” and the like. The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually affect the distribution. Examples of computer-readable media include but are not limited to recordable type media such as volatile and non-volatile (or non-transitory) memory devices, floppy and other removable disks, hard disk drives, optical disks, which include Compact Disk Read-Only Memory (CD ROMS), Digital Versatile Disks (DVDs), etc., as well as digital and analog communication media.

### CONCLUSIONS

One of ordinary skill in the art knows that the use cases, structures, schematics, flow diagrams, and steps may be performed in any order or sub-combination, while the inventive concept of the present invention remains without departing from the broader scope of the invention. Every embodiment may be unique, and step(s) of method(s) may be either shortened or lengthened, overlapped with other activities, postponed, delayed, and/or continued after a time gap, such that every active user and running application program is accommodated by the server(s) to practice the methods of the present invention.

For simplicity of explanation, the embodiments of the methods of this disclosure are depicted and described as a series of acts or steps. However, acts or steps in accordance with this disclosure can occur in various orders and/or concurrently, and with other acts or steps not presented and described herein. Furthermore, not all illustrated acts or steps may be required to implement the methods in accordance with the disclosed subject matter. In addition, those skilled in the art will understand and appreciate that the methods could alternatively be represented as a series of interrelated states via a state diagram or events or their equivalent.

As used herein, the singular forms “a,” “an,” and “the” include plural references unless the context clearly indicates otherwise. Thus, for example, reference to “a cable” includes a single cable as well as a bundle of two or more different cables, and the like.

The terms “comprise,” “comprising,” “includes,” “including,” “have,” “having,” and the like, used in the specification and claims are meant to be open-ended and not restrictive, meaning “including but not limited to.”

In the foregoing description, numerous specific details are set forth, such as specific structures, dimensions, processes parameters, etc., to provide a thorough understanding of the present invention. The particular features, structures, materials, or characteristics may be combined in any suitable manner in one or more embodiments. The words “example”, “exemplary”, “illustrative” and the like, are used herein to mean serving as an example, instance, or illustration. Any aspect or design described herein as “example” or its equivalents is not necessarily to be construed as preferred or advantageous over other aspects or designs. Rather, use of the words “example” or equivalents is intended to present concepts in a concrete fashion.

As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A, X includes B, or X includes both A and B, then “X includes A or B” is satisfied under any of the foregoing instances.

Reference throughout this specification to “an embodiment,” “certain embodiments,” or “one embodiment” means that a particular feature, structure, or characteristic described in connection with the embodiment is included in at least one embodiment. Thus, the appearances of the phrase “an embodiment,” “certain embodiments,” or “one embodiment” throughout this specification are not necessarily all referring to the same embodiment.

As used herein, the term “about” in connection with a measured quantity, refers to the normal variations in that measured quantity, as expected by one of ordinary skill in the art in making the measurement and exercising a level of care commensurate with the objective of measurement and the precision of the measuring equipment. For example, in some exemplary embodiments, the term “about” may include the recited number±10%, such that “about 10” would include from 9 to 11. In other exemplary embodiments, the term “about” may include the recited number±X %, where X is considered the normal variation in said measurement by one of ordinary skill in the art.

Features which are described in the context of separate embodiments may also be provided in combination in a single embodiment. Conversely, various features which are, for brevity, described in the context of a single embodiment, may also be provided separately or in any suitable sub-combination. The applicant hereby gives notice that new claims may be formulated to such features and/or combinations of such features during the prosecution of the present application or of any further application derived therefrom. Features of the transitory physical storage medium described may be incorporated into/used in a corresponding method, digital documentation system and/or system, and vice versa.

Although the present invention has been described with reference to specific exemplary embodiments, it will be evident that the various modifications and changes can be made to these embodiments without departing from the broader scope of the invention. Accordingly, the specification and drawings are to be regarded in an illustrative sense rather than in a restrictive sense. It will also be apparent to the skilled artisan that the embodiments described above are specific examples of a single broader invention which may have greater scope than any of the singular descriptions taught. There may be many alterations made in the descriptions without departing from the scope of the present invention, as defined by the claims.

What is claimed is:

1. A non-transitory physical storage medium storing program code, the program code executable by a hardware processor to cause the hardware processor to execute a computer-implemented process for generating a digital document, the program code comprising code to:
receive a static document file comprising human-readable data;
parse the static document file into a plurality of subunits;
generate a sharable document splice of the static document file, wherein the sharable document splice comprises access to a subset of the plurality of subunits, wherein the access is provided through an Application Programming Interface (API) or Software Development Kit (SDK) endpoint for each subunit in the subset, and wherein a given API or SDK endpoint of a given subunit comprises an identifier to the document splice and an identifier for the given subunit;
execute a digital thread script to generate the digital document from the sharable document splice and an input digital model representation, wherein the digital thread script calls upon the API or SDK endpoints in the sharable document splice, wherein the digital document comprises a digital artifact extracted from the input digital model representation, and wherein the digital document is configured through the digital thread script to reflect an update to the digital artifact in response to changes in the input digital model representation; and
add execution metadata to the digital document, for the execution of the digital thread script, wherein the execution metadata identifies the digital thread script.

2. The non-transitory physical storage medium of claim 1, wherein the digital thread script to generate the digital document comprises code to:
update a given subunit of the sharable document splice, based on the digital artifact from the input digital model representation.

3. The non-transitory physical storage medium of claim 2, wherein the digital document comprises a hyperlink that links the digital thread execution metadata to a data field in the given subunit updated by the execution of the digital thread script.

4. The non-transitory physical storage medium of claim 2, wherein the digital thread script to update the sharable document splice further comprises code to:
generate the digital artifact from the input digital model representation;
send a prompt to a large language model (LLM)-based Artificial Intelligence (AI) module, wherein the prompt is generated based on the given subunit and the digital artifact; and
receive, from the LLM-based AI module, as an update to the given subunit in the sharable document splice, a document part generated by the LLM-based AI module in response to the prompt.

5. The non-transitory physical storage medium of claim 4, wherein the digital thread script to update the sharable document splice further comprises code to:
receive a user feedback on the generated document part;
update the generated document part based on the user feedback; and
store a tuple of the given subunit, the digital artifact, and the updated document part as training data for the LLM-based AI module.

6. The non-transitory physical storage medium of claim 1, wherein the program code to generate a sharable document splice further comprising code to:
generate at least one external, commonly-accessible document splice function that enables external access to a given subunit in the subset through the given subunit's API or SDK endpoint,
wherein the at least one external, commonly-accessible document splice function is written in a scripting language, and
wherein the at least one external, commonly-accessible document splice function provides a unified programming interface to sharable document splices.

7. The non-transitory physical storage medium of claim 1, wherein the static digital document is machine-readable, wherein the digital document is human-readable, and wherein the human-readable data comprise at least one of textual data, tabular data, graphical data, image data, and hypertext data.

8. The non-transitory physical storage medium of claim 1, wherein the execution metadata identifies the input digital model representation, and comprises a timestamp of the execution of the digital thread script.

9. The non-transitory physical storage medium of claim 1, wherein the execution metadata comprises versioning information for the input digital model representation.

10. The non-transitory physical storage medium of claim 1,
wherein the digital thread script is a first digital thread script,
wherein the static document file is a second digital thread script,
wherein at least one of the plurality of subunits is a code block, and
wherein the digital document comprises the code block and metadata of the input digital model representation.

11. The non-transitory physical storage medium of claim 1, wherein the digital thread script to generate the DE document from the sharable document splice comprises code to:
determine, for each given subunit in the subset of the plurality of subunits, whether an information security tag that indicates a level of access to the given subunit is met or exceeded by a user; and
add the given subunit's API or SDK endpoint to the digital document in response to determining that the information security tag is met or exceeded.

12. The non-transitory physical storage medium of claim 11, wherein the program code to generate the digital document from the sharable document splice further comprises code to:
provide a prompt to a user for accessing the given subunit in response to determining that the information security tag is not met or exceeded.

13. The non-transitory physical storage medium of claim 1, wherein the static document file is a document template.

14. The non-transitory physical storage medium of claim 1, wherein each of the plurality of subunits is selected from the group consisting of a title, a table of contents, an index, a chapter, a subsection, a paragraph, a sentence, a word, a sheet, a page, a table, a chart, a graph, an image, a hypertext link, and sub-parts thereof.

15. The non-transitory physical storage medium of claim 1, further comprising program code to:
update the digital document based on another sharable document splice or another digital document.

16. A computer-implemented method for generating a digital document, comprising:
receiving a static document file comprising human-readable data;
parsing the static document file into a plurality of subunits;
generating a sharable document splice of the static document file, wherein the sharable document splice comprises access to a subset of the plurality of subunits, wherein the access is provided through an Application Programming Interface (API) or Software Development Kit (SDK) endpoint for each subunit in the subset, and wherein a given API or SDK endpoint of a given subunit comprises an identifier to the document splice and an identifier for the given subunit;
executing a digital thread script to generate the digital document from the sharable document splice and an input digital model representation, wherein the digital thread script calls upon the API or SDK endpoints in the sharable document splice, wherein the digital document comprises a digital artifact extracted from the input digital model representation, and wherein the digital document is configured through the digital thread script to reflect an update to the digital artifact in response to changes in the input digital model representation; and
adding execution metadata to the digital document, for the execution of the digital thread script, wherein the execution metadata identifies the digital thread script.

17. The computer-implemented method of claim 16, wherein the digital thread script to generate the digital document comprises code to:
update the sharable document splice, based on the digital artifact from the input digital model representation.

18. The computer-implemented method of claim 16, wherein the generating a sharable document splice further comprises:
generating at least one external, commonly-accessible document splice function that enables external access to a given subunit in the subset through the given subunit's API or SDK endpoint,
wherein the at least one external, commonly-accessible document splice function is written in a scripting language, and
wherein the at least one external, commonly-accessible document splice function provides a unified programming interface to sharable document splices.

19. The computer-implemented method of claim 16, wherein the execution metadata identifies the input digital model representation, and comprises a timestamp of the execution of the digital thread script.

20. The computer-implemented method of claim 16, wherein the digital thread script to generate the digital document from the sharable document splice comprises code to:
determine, for each given subunit in the subset of the plurality of subunits, whether an information security tag that indicates a level of access to the given subunit is met or exceeded by a user; and
add the given subunit's API or SDK endpoints to the digital document in response to determining that the information security tag is met or exceeded.
